(19) United States
(12) Patent Application Publication
(10) Pub. No.: US 2010/0265355 A1
(43) Pub. Date: Oct. 21, 2010

(54) PHASE CORRECTION PLATE, IMAGING SYSTEM AND APPARATUS, MOBILE PHONE, IN-VEHICLE DEVICE, MONITOR CAMERA, ENDOSCOPIC APPARATUS, DIGITAL CAMERA, DIGITAL VIDEO CAMERA, AND LENS UNIT

(76) Inventors: Kenichi SATO, Saitama-shi (JP); Sumihiro Nishihata, Saitama-shi (JP); Yasunobu Kishine, Saitama-shi (JP)

Correspondence Address: BIRCH STEWART KOLASCH & BIRCH, PO BOX 747, FALLS CHURCH, VA, 22040-0747, US

(21) Appl. No.: 12/764,904

(22) Filed: Apr. 21, 2010

(30) Foreign Application Priority Data
Apr. 21, 2009 (JP) 103347/2009
Nov. 17, 2009 (JP) 262086/2009

(51) Int. Cl. H04N 5/228; G02B 27/28

(52) U.S. Cl. 348/222.1; 359/489; 348/E05.031

(57) ABSTRACT

A phase correction plate is mounted on an imaging lens. The phase correction plate is structured in such a manner that the phase difference of light that has passed a middle region of the phase correction plate is lower than the phase difference of light that has passed a peripheral region of the phase correction plate, and that in the peripheral region, the phase difference of light that has passed through the phase correction plate increases from the middle-region side of the peripheral region toward the periphery side of the peripheral region.

### BACKGROUND OF THE INVENTION

1. Field of the Invention

The present invention relates to a phase correction plate to be mounted on an imaging lens, an imaging system that performs restoration processing on image data representing a subject obtained through the imaging lens with the phase correction plate mounted thereon, and an imaging apparatus including the imaging system. Further, the present invention relates to a mobile phone, an in-vehicle device, a monitor camera, an endoscopic apparatus, a digital camera, and a digital video camera including the imaging systems, and a lens unit including the phase correction plate.

2. Description of the Related Art

Conventionally, mobile terminal devices, such as mobile phones with built-in cameras, were known. As imaging lenses for small cameras that are mounted on the mobile terminal devices, imaging lenses with focus adjustment mechanisms adopting focusing methods and imaging lenses without the focus adjustment mechanisms, which adopt fixed-focus methods, were known (please refer to Japanese Unexamined Patent Publication No. 2006-246492, Japanese Unexamined Patent Publication No. 2005-292443, and Japanese Unexamined Patent Publication No. 2004-258111).

Imaging apparatuses adopting the fixed-focus methods are designed in such a manner to have large in-focus ranges, in which images are in focus. The large in-focus ranges are set by increasing the depths of field while tolerating a drop in resolution and a drop in brightness (in other words, an increase in F-number) to some extent. Generally, in the fixed-focus methods, close-up photography (short distance photography) is excluded to determine the depths of field of imaging lenses, in other words, objects at short distances are excluded from subjects of photography.

In contrast, imaging apparatuses that adopt focusing methods are generally designed in such a manner to have high resolution and a wide range of subjects of photography that includes an object at a short distance. Further, the imaging apparatuses that adopt the focusing methods are designed to include bright lenses (lenses with small F-numbers). As the imaging apparatuses adopting the focusing methods, imaging apparatuses that have auto-focus mechanisms and macro switching mechanism are known.

Further, methods for obtaining images with increased depths of field are known. In the methods, subjects are imaged by using lens units having wave-front modulation surfaces (phase modulation surfaces), and restoration processing is performed on the images of the subjects to obtain images with increased depths of field (please refer to Japanese Unexamined Patent Publication No. 2009-008935 and PCT International Publication No. WO2009/106996).

Small cameras mounted on mobile phones and the like are used not only to capture landscape images and portraits but to read bar codes and letters or characters (letter text). Therefore, lenses having deeper depths of field that can cope with photography in a wide range including long distance photography to short distance photography are needed.

However, when an imaging lens adopting the focusing method is used to perform short distance photography (close-up photography) in a relatively dark room, a diaphragm is opened, and F-number is set lower (for example, F2.8, or the like). Therefore, the depth of field becomes extremely shallow. When a bar code or a letter text is imaged from a diagonal direction, only a part of the subject is in focus in some cases. Therefore, the posture (direction) of the imaging lens is adjusted in such a manner that the optical axis of the imaging lens is perpendicular to the surface of the bar code or the letter text to perform imaging. However, since the depth of field is shallow, a hand shake blur in the direction of the optical axis occurs, and images become out of focus in some cases.

Meanwhile, when the aperture of the imaging lens using the focusing method is reduced (F-number is increased) to increase the depth of field to prevent blurs in the direction of the optical axis of the imaging lens, it is necessary to lower the shutter speed by the decreased receiving light amount, which is reduced by reducing the aperture. Therefore, there are problems that a hand shake blur in the direction perpendicular to the optical axis becomes noticeable and that the resolution becomes lower.

Therefore, there is a need for increasing the depth of field of the imaging lens while the brightness (F-number) of the imaging lens with a large aperture and the resolution are maintained.

The problems as described are common not only to the imaging lenses mounted on mobile terminal devices, such as mobile phones, but to a wide range of imaging lenses for obtaining images of subjects.

Further, in endoscopes, which image the body cavities of patients, it is difficult to obtain a sufficient light amount. Therefore, when the aperture is reduced, imaging becomes difficult.

Further, in monitor cameras, lenses for in-vehicle devices, and lenses for video cameras, light amounts greatly change. When it is difficult to provide a variable aperture mechanism because of cost or structural constraints, imaging is difficult when the light amount is insufficient.

To increase the depth of field while maintaining the brightness (F-number) and the resolution, the method disclosed in Japanese Unexamined Patent Publication No. 2009-008935 may be adopted. In Japanese Unexamined Patent Publication No. 2009-008935, subjects are imaged by using an imaging lens having a wave-front modulation surface (phase modulation surface), and restoration processing is performed on the images of the subjects to obtain images with increased depths of field. However, in the method, the wave-front modulation surface (phase modulation surface) is monolithically (in one piece) formed on a lens surface that constitutes the lens unit. Therefore, it is difficult to measure the optical performance of the lens unit excluding the wave-front modulation surface (phase modulation surface). In production of lens units, examination for testing the performance of the lens units becomes difficult, and the cost for production of the lens units increases.

### SUMMARY OF THE INVENTION

In view of the foregoing circumstances, it is an object of the present invention to provide a phase correction plate that can easily increase the depth of field of an imaging lens while preventing a drop in the resolution and a drop in brightness (an increase in F-number) of the imaging lens. Further, it is another object of the present invention to provide an imaging system, an imaging apparatus, a mobile phone, an in-vehicle device, a monitor camera, an endoscopic apparatus (endoscope), a digital camera, a digital video camera, and a lens unit that include the phase correction plates.

A phase correction plate of the present invention is a phase correction plate to be mounted on (or inserted in) an imaging lens, wherein the maximum phase difference of light that has passed a middle region of the phase correction plate (a region around the center of the phase correction plate including the center) is lower than the maximum phase difference of light that has passed a peripheral region of the phase correction plate, and wherein in the peripheral region, the phase difference of light that has passed through the phase correction plate increases from the middle-region side of the peripheral region toward the periphery side of the peripheral region.

The phase correction plate may be structured in such a manner that the phase difference of light that has passed a middle region of the phase correction plate is lower than the phase difference of light that has passed a peripheral region of the phase correction plate and that the deformation amount of the wave front form of light that passes the peripheral region monotonically increases from a center-side position of light that passes the peripheral region, the center-side position being closest to the center of the phase correction plate, toward the periphery side.

A phase correction plate of the present invention is structured so that a change in the diameter of each spot formed at each position on an imaging plane by light that has passed through the imaging lens with the phase correction plate mounted thereon during defocusing (during changing a position in focus) is less than a change in the diameter of a spot formed, in such a manner to correspond to each of the positions on the imaging plane, by light that has passed through the imaging lens alone without the phase correction plate mounted thereon during defocusing.

The ratio of a change in the diameter of each spot formed at each position on the imaging plane through the imaging lens with the phase correction plate mounted thereon during defocusing to a change in the diameter of each spot formed, in such a manner to correspond to each of the positions on the imaging plane, by light that has passed through the imaging lens alone without the phase correction plate mounted thereon during defocusing may be less than or equal to 50%. It is desirable that the ratio is less than or equal to 20%, and optionally, less than or equal to 7%.

The phase correction plate may be a simple lens (singlet lens). Further, a surface of the simple lens may be flat. The flat surface of the simple lens may be a lens surface arranged on the incident-light side when the phase correction plate is mounted on the imaging lens to image a subject.

A surface of the simple lens that does not face the pupil of the imaging lens may be flat.

It is desirable that the phase difference of light that passes the middle region is less than ½ wavelength.

It is desirable that the phase difference of light that passes the peripheral region is greater than or equal to ½ wavelength.

The wavelength may be the wavelength of reference wavelength (base wavelength). When the subject of photography is a visible wavelength region, which is generally used, the wavelength of d line (587.6 nm) may be adopted. When an infrared optical system is used, and the subject of photography is an infrared-ray wavelength region, the wavelength of an infrared region (1200 nm) or the like may be adopted.

Further, the phase correction plate may have rotationally symmetric form. The expression “may have rotationally symmetric form” means that it is not necessary that the form is completely rotationally symmetric. The form of the phase correction plate may be approximately rotationally symmetric.

It is desirable that the phase correction plate satisfies the following formula:

5/100<A/(A+B)<100/100, where A is the area of the middle region, B is the area of the peripheral region, and A+B is the area of an effective region that is obtained by adding the area of the peripheral region to the area of the middle region.

The middle region may include only a paraxial area that includes an optical axis. Alternatively, the middle region may be an area, the area of which is 5% of the area of the effective region. Optionally, the middle region may be an area, the area of which is 10% of the area of the effective region. Further optionally, the middle region may be an area, the area of which is 50% of the area of the effective region. Alternatively, an area in which the phase difference from light that passes the optical axis is less than ½ wavelength may be defined as the middle region, and an area in which the phase difference from light that passes the optical axis is greater than or equal to ½ wavelength may be defined as the peripheral region.

Further, the amount of change in the diameter of the spot during defocusing may be, for example, the ratio of the minimum diameter of the spot to the maximum diameter of the spot during defocusing.

The phase correction plate may be structured in such a manner that the phase of light that has passed through the phase correction plate advances, with respect to the phase of light that passes a center-side position in the peripheral region of the phase correction plate, from the middle-region side of the phase correction plate toward the periphery side of the phase correction plate, the center-side position being closest to the center of the phase correction plate (the phase at least does not delay but monotonically advances). In other words, the phase of light advances from the center-side position in the peripheral region toward the periphery side. Alternatively, the phase correction plate may be structured in such a manner that the phase of light that has passed through the phase correction plate delays (the phase at least does not advance but monotonically delays).

The phase of light that has passed through the phase correction plate delays, compared with the phase of light that passes the same region when a phase correction plate is not provided. In other words, light that has passed through the phase correction plate always delays with respect to light that passes the same region (same position) when the phase correction plate is not provided in the region. When the wavelength of light is λ, the delay of phase may be greater than or equal to 1λ, and for example, 3.5λ, 20.3λ, or the like. The delay of the phase is defined not only by the range satisfying 0≦λ<1.

Further, the expression “phase difference of light that has passed a peripheral region of the phase correction plate” corresponds to “a difference between the maximum value and the minimum value of change in the phase of light that has passed the peripheral region of the phase correction plate, the change from the phase of light before the light passes through the phase correction plate to the phase of the light after the light passes through the phase correction plate”. Further, the expression “phase difference of light that has passed a peripheral region of the phase correction plate” corresponds to the “maximum value (maximum degree) of the deformation amount of wave front form of light that passes the peripheral region of the phase correction plate”.

Further, the expression “phase difference of light that has passed a middle region of the phase correction plate” corresponds to “a difference between the maximum value and the minimum value of change in the phase of light that has passed the middle region of the phase correction plate, the change from the phase before the light passes the middle region to the phase after the light passes the middle region”. Further, the expression “phase difference of light that has passed a middle region of the phase correction plate” corresponds to the “maximum value (maximum degree) of the deformation amount of wave front form of light that passes the middle region of the phase correction plate”.

As described above, the phase difference is a physical value that can be expressed by the magnitude of a value alone. Therefore, the phase difference is a value without a sign (plus/minus or the like).

Further, the phase difference caused by the phase correction plate may be defined as follows. As illustrated in FIGS. 27A through 27D, the phase form at the wave front of incident light, using the optical axis as an origin, is I(1) [please refer to FIG. 27A]. The phase form at the wave front of output light that has passed through the phase correction plate, using the optical axis as an origin, is I(2) [please refer to FIG. 27B]. In this case, I(2)−I(1) [please refer to FIGS. 27C and 27D] is defined as the phase difference.

In each of FIGS. 27A through 27D, the horizontal axis represents optical axis Z1, and the vertical axis represents direction H, which is perpendicular to the optical axis Z1. In the coordinate planes illustrated in FIGS. 27A through 27D, phase form and phase difference are illustrated. FIG. 27A illustrates phase form I(1), and FIG. 27B illustrates phase form I(2). FIG. 27C illustrates phase difference I(2)−I(1). FIG. 27D illustrates phase difference I(2)−I(1) with respect to phase form I(1).

It is desirable that the phase difference I(2)−I(1) is calculated along the vector in the propagation direction of light.

When the wave front form of the incident light is plane wave, the phase difference is the same as the phase form I(2).

Further, the deformation amount of wave front form of light that passes the peripheral region with respect to a center-side position of light that passes the peripheral region, the center-side position being closest to the center of the phase correction plate, may be obtained by comparing a first peripheral wave front form and a second peripheral wave front form with respect to the center-side position of light that passes the peripheral region closest to the center. The first peripheral wave front form is the wave front form of light before passing the peripheral region, and the second peripheral wave front form is the wave front form of light after passing the peripheral region.

In the imaging lens with the phase correction plate mounted thereon, a region of the phase correction plate that passes light that forms an image representing the subject is an effective region. The effective region includes the middle region and the peripheral region. In other words, the peripheral region is the effective region excluding the middle region.

As the imaging apparatus, an imaging apparatus having a focusing mechanism and an imaging apparatus of fixed-focus method may be adopted.

It is desirable that the phase correction plate is arranged in the vicinity of the pupil of the imaging lens. If the phase correction plate is arranged in such a manner, a similar advantageous effect is achieved in a wide angle (angle of view) optical system.

It is desirable that the phase correction plate contains a material that satisfies Abbe number γd>45, and optionally a material satisfying Abbe number γd>50. Further, it is desirable that a material having anomalous dispersion properties is used for the phase correction plate. Accordingly, it is possible to prevent generation of chromatic aberration in a phase correction plate when the number of lenses (a lens) is small.

A lens unit of the present invention may include the phase correction plate and at least one lens.

The phase correction plate may be a complex body including a phase correction portion and a base portion deposited one on the other in the direction of an optical axis. Further, the phase correction portion and the base portion may be formed by members that have different optical properties from each other. The phase correction portion gives a phase difference to light that passes through the phase correction plate, but the base portion does not give any phase difference to the light that passes through the phase correction plate.

The phase difference may be a shift (displacement or the like) of a plane wave that has passed through the phase correction plate from the plane of the plane wave (or a shift of a spherical wave that has passed through the phase correction plate from the spherical surface of the spherical wave). For example, when the phase correction plate is a parallel flat-surface plate without power, the plane wave that “has perpendicularly entered the parallel flat surface plate” does not shift, in other words, a phase difference is not caused. However, when the phase correction plate has a portion that is not parallel, or a bump (or an unsmooth portion), the plane wave that has passed through the phase correction plate shifts, in other words, a phase difference is caused.

For example, when the phase correction plate is a spherical-surface plate without power, the spherical wave that “has entered the spherical-surface plate perpendicularly” does not shift, in other words, a phase difference is not caused. However, when the phase correction plate has a portion that has uneven thickness, or a bump (or an unsmooth portion), the spherical wave that has passed through the phase correction plate shifts, in other words, a phase difference is caused.

The phase correction plate may be formed in such a manner that the phase of light that has passed through the phase correction plate advances from the middle-region side of the phase correction plate toward the periphery side of the phase correction plate with respect to a center-side position of light that passes the peripheral region of the phase correction plate, the center-side position being closest to the center of the phase correction plate. In such a case, the depth (the depth of field) of an image formed by light that has passed through the imaging lens with the phase correction plate mounted thereon increases (expands) toward the front side (subject side) of an imaging position.

The phase correction plate may be formed in such a manner that the phase of light that has passed through the phase correction plate delays from the middle-region side of the phase correction plate toward the periphery side of the phase correction plate with respect to a center-side position of light that passes the peripheral region of the phase correction plate, the center-side position being closest to the center of the phase correction plate. In such a case, the depth (the depth of field) of an image formed by light that has passed through the imaging lens with the phase correction plate mounted thereon increases (expands) toward the back side (the side of the imaging plane from which light that has entered and penetrated the imaging plane is output) of the imaging position.

A phase correction plate according to another aspect of the present invention is a phase correction plate to be mounted on an imaging lens, which forms an image representing a subject. The phase correction plate is structured in such a manner that the maximum deformation amount of wave front form of light that has passed a middle region of the phase correction plate is lower than the maximum deformation amount of wave front form of light that has passed a peripheral region of the phase correction plate and that a deformation amount of wave front form of light that passes the peripheral region monotonically increases from a center-side position of light that passes the peripheral region, the center-side position being closest to the center of the phase correction plate, toward the periphery side.

Further, the phase correction plate may be structured in such a manner that a change in the diameter (size) of each spot formed at each position on an imaging plane by light that has passed through the imaging lens with the phase correction plate mounted thereon during defocusing is less than a change in the diameter (size) of a spot formed, in such a manner to correspond to each of the positions on the imaging plane, by light that has passed through the imaging lens alone without the phase correction plate during defocusing.

The phase correction plate may be a simple lens. Further, a surface of the simple lens may be flat. The flat surface may be a lens surface arranged on the light-incident side when the phase correction plate is mounted on an imaging lens to image a subject.

It is desirable that the maximum deformation amount of the wave front form of light that passes the middle region is less than ½ wavelength.

It is desirable that the maximum deformation amount of the wave front form of light that passes the peripheral region is greater than or equal to ½ wavelength. The wavelength is the wavelength of reference wavelength (base wavelength). When the object of photography is a visible wavelength region, which is generally used, the wavelength of d line (587.6 nm) may be adopted. When an infrared optical system is used, and the object of photography is an infrared-ray wavelength region, the wavelength of an infrared region (1200 nm) or the like may be adopted.

It is desirable that the phase correction plate satisfies the following formula:

5/100<A/(A+B)<100/100. In the formula, A is the area of the middle region, B is the area of the peripheral region, and A+B is the area of an effective region that is obtained by adding the area of the peripheral region to the area of the middle region.

With reference to FIG. 3, which will be described later, middle region U1 is a region mainly forming the core of an image to form the image. Peripheral region U2 is a region that acts to increase the focal depth. The middle region U1 and the peripheral region U2 are appropriately changed based on the specification of the range of depth required for the lens and the range δ2 of phase difference in the peripheral region U2.

Specifically, when the value of δ2 max is small, the depth increase effect is weak. Therefore, it is necessary to maintain a wide (large) peripheral region U2. In contrast, when the value of δ2 max is large, it is possible to increase the depth, but image flare increases. Therefore, it is necessary to set a large middle region U1, which forms the core of the image.

The amount of change in the size of the condensed light spot during defocusing may be, for example, the ratio between the minimum value and the maximum value of the size of the condensed light spot during defocusing.

Further, the deformation amount of wave front form of light that passes the peripheral region with respect to a center-side position of light that passes the peripheral region, the center-side position being closest to the center of the phase correction plate, may be obtained by comparing a first peripheral wave front form and a second wave front form with respect to the center-side position of light that passes the peripheral region, which is closest to the center. The first peripheral wave front form is the wave front form of light before passing the peripheral region, and the second peripheral wave front form is the wave front form of light after passing the peripheral region.

In the imaging lens with the phase correction plate mounted thereon, a region of the phase correction plate that passes light forming an image representing a subject is an effective region. The effective region includes the middle region and the peripheral region. In other words, the peripheral region is the effective region excluding the middle region.

As the imaging lens, an imaging lens having a focusing mechanism and an imaging lens of fixed-focus method may be adopted.

It is desirable that the phase correction plate is arranged in the vicinity of the pupil of the imaging lens. If the phase correction plate is arranged in such a manner, a similar advantageous effect is achieved in a wide angle (angle of view) optical system.

It is desirable that the phase correction plate contains a material satisfying Abbe number γd>45, and optionally a material satisfying Abbe number γd>50. Further, it is desirable that a material having anomalous dispersion properties is used for the phase correction plate. Accordingly, it is possible to prevent generation of chromatic aberration in a phase correction plate when the number of lenses (a lens) is small.

A lens unit of the present invention includes the phase correction plate according to the other aspect of the present invention and at least one lens.

An imaging system of the present system is an imaging system comprising:

an imaging means that obtains an optical image of a subject projected through an imaging lens with one of the phase correction plate according the first aspect of the present invention and the phase correction plate according to the other aspect of the present invention mounted thereon; and

a signal processing means that performs restoration processing on image data representing the subject, which was obtained by the imaging means.

An imaging apparatus of the present invention includes the imaging system.

A mobile phone of the present invention includes the imaging system.

An in-vehicle device of the present invention includes the imaging system.

A monitor camera of the present invention includes the imaging system.

An endoscopic apparatus of the present invention includes the imaging system.

A digital camera of the present invention includes the imaging system.

A digital video camera of the present invention includes the imaging system.

In the imaging system, the imaging means and the signal processing means may be integrated with each other. Alternatively, the imaging means and the signal processing may be arranged separately.

As the “restoration processing” applied to the imaging system, image restoration processing introduced in paragraphs [0002] through [0016] of Japanese Unexamined Patent Publication No. 2000-123168, or the like may be adopted. Further, the restoration processing may be performed by applying the technique disclosed in “Kernel Wiener Filter”, Y. Washizawa and Y. Yamashita, Workshop on Information-Based Induction Sciences (IBIS2003), 2003, or the like.

According to the phase correction plate of the present invention, the maximum phase difference of light that has passed a middle region of the phase correction plate is lower than the maximum phase difference of light that has passed a peripheral region of the phase correction plate. Further, in the peripheral region, the phase difference of light that has passed through the phase correction plate increases from the middle-region side of the peripheral region toward the periphery side of the peripheral region. Therefore, it is possible to increase the depth of field while suppressing a drop in resolution and a drop in brightness. In other words, when the phase correction plate is mounted on an imaging lens to image a subject, and restoration processing is performed on the image of the subject, it is possible to obtain an image, the depth of field of which is increased without reducing the aperture (aperture of the diaphragm) of the imaging lens (in other words, without increasing the F-number).

The phase correction plate of the present invention may be structured in such a manner that phase difference of light that has passed a middle region of the phase correction plate is lower than phase difference of light that has passed a peripheral region of the phase correction plate and that a deformation amount of wave front form of light that passes the peripheral region monotonically increases from a center-side position of light that passes the peripheral region, the center-side position being closest to the center of the phase correction plate, toward the periphery side. When the phase correction plate is structured in such a manner, it is also possible to increase the depth of field while suppressing a drop in resolution and a drop in brightness. In other words, when the phase correction plate is mounted on an imaging lens to image a subject, and restoration processing is performed on the image of the subject, it is possible to obtain an image, the depth of field of which is increased without reducing the aperture (aperture of the diaphragm) of the imaging lens (in other words, without increasing the F-number).

The phase correction plate according to another aspect of the present invention may be structured in such a manner that the maximum deformation amount of the wave front form of light that has passed a middle region of the phase correction plate is lower than the maximum deformation amount of the wave front form of light that has passed a peripheral region of the phase correction plate and that a deformation amount of wave front form of light that passes the peripheral region monotonically increases from a center-side position of light that passes the peripheral region, the center-side position being closest to the center of the phase correction plate, toward the periphery side. When the phase correction plate is structured in such a manner, it is also possible to increase the depth of field while suppressing a drop in resolution and a drop in brightness. In other words, when the phase correction plate is mounted on an imaging lens to image a subject, and restoration processing is performed on the image of the subject, it is possible to obtain an image, the depth of field of which is increased without reducing the aperture (aperture of the diaphragm) of the imaging lens (in other words, without increasing the F-number).

More specifically, in both of the phase correction plate according to the first aspect of the present invention and the phase correction plate according to the other aspect of the present invention, F-numbers do not change substantially when the phase correction plates are mounted on imaging lenses. Therefore, for example, when short-distance photography (close-up photography) is performed in a dark room, even if the F-number of a lens system including the imaging lens and the phase correction plate mounted on the imaging lens is set lower (for example, F2 or the like), it is possible to obtain an image with a deep depth of field by performing restoration processing on the obtained image. Accordingly, when a bar code or letter text is imaged, even if the subject is imaged from a diagonal direction, or a hand shake occurs in the direction of the optical axis, it is possible to prevent the image from being blurred (out of focus), because it is possible to increase the depth of field. Further, since the brightness (F-number) of the optical system does not change substantially when the phase correction plate is mounted on the imaging lens, as described above, it is not necessary to set a slow shutter speed. Therefore, a hand shake blur in the direction perpendicular to the optical axis does not increase.

Further, in ordinary photography, it is possible to satisfy a need to image both of a subject positioned close to the imaging lens and a subject positioned in the infinity at the same time.

In both of the phase correction plate according to the first aspect of the present invention and the phase correction plate according to the other aspect of the present invention, it is possible to obtain an image on which restoration processing for obtaining an image having an increased depth of field can be performed. The image on which the restoration processing can be performed is obtained by imaging a subject by using an imaging lens (for example, a conventional imaging lens) that has a predetermined performance, and on which the phase correction plate is mounted. Therefore, it is possible to easily measure the optical performance of the imaging lens alone, excluding the performance of the phase correction plate, in other words, the phase correction plate on which a wave front modulation surface (phase modulation surface) is formed. Further, it is possible to easily test the performance of a lens in production of an imaging lens with the phase correction plate mounted thereon.

Further, when the phase correction plate is arranged in the vicinity of the pupil of the imaging lens, it is possible to remarkably increase the depth of field, while suppressing a drop in resolution and a drop in brightness.

The advantageous effects as described above may be achieved in both of a case of mounting the phase correction plate on an imaging lens having a focusing mechanism and a case of mounting the phase correction plate on an imaging lens of fixed focus. Further, especially when the phase correction plate is mounted on a bright lens (a lens having a small F-number), and short-distance photography (close-up photography) is performed, a remarkably advantageous effect is realized.

### BRIEF DESCRIPTION OF THE DRAWINGS

FIG. 1 is a cross-sectional diagram illustrating a state in which a phase correction plate according to an embodiment of the present invention is mounted on an imaging lens;

FIG. 2A is a diagram illustrating a phase correction plate viewed from the direction of an optical axis;

FIG. 2B is a cross-sectional diagram illustrating the phase correction plate from a direction perpendicular to the optical axis;

FIG. 3 is a diagram illustrating deformation of the wave front form of light that has passed through the phase correction plate;

FIG. 4A is a diagram illustrating a change in the size of each condensed light spot during defocusing, each condensed light spot being formed at each position on an imaging plane through the imaging lens with the phase correction plate mounted thereon;

FIG. 4B is a diagram illustrating a change in the size of each condensed light spot during defocusing, each condensed light spot being formed at each position on an imaging plane through the imaging lens alone;

FIG. 5 is a diagram illustrating changes in the sizes of condensed light spots during defocusing, the condensed light spots being formed by light that has passed through the imaging lens alone without the phase correction plate mounted thereon or through the imaging lens with the phase correction plate mounted thereon;

FIG. 6A is a schematic cross-sectional diagram illustrating the structure of an imaging lens with a phase correction plate mounted thereon in Example A1;

FIG. 6B is a diagram illustrating the spherical aberration of the imaging lens with the phase correction plate mounted thereon in Example A1;

FIG. 6C is a diagram illustrating a change of each condensed light spot during defocusing, each condensed light spot being formed at each position on an imaging plane;

FIG. 6D is a diagram illustrating a change in MTF (modulation transfer function) characteristics of the imaging lens with the phase correction plate mounted thereon in Example A1;

FIG. 6E is a diagram illustrating a change in MTF characteristics during defocusing for 70 lines/mm;

FIG. 6F is a diagram illustrating a change in MTF characteristics during defocusing for 140 lines/mm;

FIG. 7A is a schematic cross-sectional diagram illustrating the structure of an imaging lens with a phase correction plate mounted thereon in Example A2;

FIG. 7B is a diagram illustrating the spherical aberration of the imaging lens with the phase correction plate mounted thereon in Example A2;

FIG. 7C is a diagram illustrating a change of each condensed light spot during defocusing, each condensed light spot being formed at each position on an imaging plane;

FIG. 7D is a diagram illustrating a change in MTF characteristics of the imaging lens with the phase correction plate mounted thereon in Example A2;

FIG. 7E is a diagram illustrating a change in MTF characteristics during defocusing for 70 lines/mm;

FIG. 7F is a diagram illustrating a change in MTF characteristics during defocusing for 140 lines/mm;

FIG. 8A is a schematic cross-sectional diagram illustrating the structure of an imaging lens with a phase correction plate mounted thereon in Example A3;

FIG. 8B is a diagram illustrating the spherical aberration of the imaging lens with the phase correction plate mounted thereon in Example A3;

FIG. 8C is a diagram illustrating a change of each condensed light spot during defocusing, each condensed light spot being formed at each position on an imaging plane;

FIG. 8D is a diagram illustrating a change in MTF characteristics of the imaging lens with the phase correction plate mounted thereon in Example A3;

FIG. 8E is a diagram illustrating a change in MTF characteristics during defocusing for 70 lines/mm;

FIG. 8F is a diagram illustrating a change in MTF characteristics during defocusing for 140 lines/mm;

FIG. 9A is a schematic cross-sectional diagram illustrating the structure of an imaging lens with a phase correction plate mounted thereon in Example A4;

FIG. 9B is a diagram illustrating the spherical aberration of the imaging lens with the phase correction plate mounted thereon in Example A4;

FIG. 9C is a diagram illustrating a change of each condensed light spot during defocusing, each condensed light spot being formed at each position on an imaging plane;

FIG. 9D is a diagram illustrating a change in MTF characteristics of the imaging lens with the phase correction plate mounted thereon in Example A4;

FIG. 9E is a diagram illustrating a change in MTF characteristics during defocusing for 70 lines/mm;

FIG. 9F is a diagram illustrating a change in MTF characteristics during defocusing for 140 lines/mm;

FIG. 10A is a schematic cross-sectional diagram illustrating the structure of an imaging lens with a phase correction plate mounted thereon in Example B1;

FIG. 10B is a diagram illustrating the spherical aberration of the imaging lens with the phase correction plate mounted thereon in Example B1;

FIG. 10C is a diagram illustrating a change of each condensed light spot during defocusing, each condensed light spot being formed at each position on an imaging plane;

FIG. 10D is a diagram illustrating a change in MTF characteristics of the imaging lens with the phase correction plate mounted thereon in Example B1;

FIG. 10E is a diagram illustrating a change in MTF characteristics during defocusing for 70 lines/mm;

FIG. 10F is a diagram illustrating a change in MTF characteristics during defocusing for 140 lines/mm;

FIG. 11A is a schematic cross-sectional diagram illustrating the structure of an imaging lens with a phase correction plate mounted thereon in Example B2;

FIG. 11B is a diagram illustrating the spherical aberration of the imaging lens with the phase correction plate mounted thereon in Example B2;

FIG. 11C is a diagram illustrating a change of each condensed light spot during defocusing, each condensed light spot being formed at each position on an imaging plane;

FIG. 11D is a diagram illustrating a change in MTF characteristics of the imaging lens with the phase correction plate mounted thereon in Example B2;

FIG. 11E is a diagram illustrating a change in MTF characteristics during defocusing for 70 lines/mm;

FIG. 11F is a diagram illustrating a change in MTF characteristics during defocusing for 140 lines/mm;

FIG. 12A is a schematic cross-sectional diagram illustrating the structure of an imaging lens with a phase correction plate mounted thereon in Example C1;

FIG. 12B is a diagram illustrating the spherical aberration of the imaging lens with the phase correction plate mounted thereon in Example C1;

FIG. 12C is a diagram illustrating a change of each condensed light spot during defocusing, each condensed light spot being formed at each position on an imaging plane;

FIG. 12D is a diagram illustrating a change in MTF characteristics of the imaging lens with the phase correction plate mounted thereon in Example C1;

FIG. 12E is a diagram illustrating a change in MTF characteristics during defocusing for 70 lines/mm;

FIG. 12F is a diagram illustrating a change in MTF characteristics during defocusing for 140 lines/mm;

FIG. 13A is a schematic cross-sectional diagram illustrating the structure of an imaging lens with a phase correction plate mounted thereon in Example C2;

FIG. 13B is a diagram illustrating the spherical aberration of the imaging lens with the phase correction plate mounted thereon in Example C2;

FIG. 13C is a diagram illustrating a change of each condensed light spot during defocusing, each condensed light spot being formed at each position on an imaging plane;

FIG. 13D is a diagram illustrating a change in MTF characteristics of the imaging lens with the phase correction plate mounted thereon in Example C2;

FIG. 13E is a diagram illustrating a change in MTF characteristics during defocusing for 70 lines/mm;

FIG. 13F is a diagram illustrating a change in MTF characteristics during defocusing for 140 lines/mm;

FIG. 14A is a schematic cross-sectional diagram illustrating the structure of an imaging lens with a phase correction plate mounted thereon in Example C3;

FIG. 14B is a diagram illustrating the spherical aberration of the imaging lens with the phase correction plate mounted thereon in Example C3;

FIG. 14C is a diagram illustrating a change of each condensed light spot during defocusing, each condensed light spot being formed at each position on an imaging plane;

FIG. 14D is a diagram illustrating a change in MTF characteristics of the imaging lens with the phase correction plate mounted thereon in Example C3;

FIG. 14E is a diagram illustrating a change in MTF characteristics during defocusing for 70 lines/mm;

FIG. 14F is a diagram illustrating a change in MTF characteristics during defocusing for 140 lines/mm;

FIG. 15A is a schematic cross-sectional diagram illustrating the structure of an imaging lens with a phase correction plate mounted thereon in Example D;

FIG. 15A1 is a cross-sectional diagram illustrating the structure of a complex aspheric surface of the imaging lens alone in Example D;

FIG. 15B is a diagram illustrating the spherical aberration of the imaging lens with the phase correction plate mounted thereon in Example D;

FIG. 15C is a diagram illustrating a change of each condensed light spot during defocusing, each condensed light spot being formed at each position on an imaging plane;

FIG. 15D is a diagram illustrating a change in MTF characteristics of the imaging lens with the phase correction plate mounted thereon in Example D;

FIG. 15E is a diagram illustrating a change in MTF characteristics during defocusing for 70 lines/mm;

FIG. 15F is a diagram illustrating a change in MTF characteristics during defocusing for 140 lines/mm;

FIG. 16A is a schematic cross-sectional diagram illustrating the structure of an imaging lens alone in Comparative Example A0;

FIG. 16B is a diagram illustrating the spherical aberration of the imaging lens alone in Comparative Example A0;

FIG. 16C is a diagram illustrating a change of each condensed light spot during defocusing, each condensed light spot being formed at each position on an imaging plane;

FIG. 16D is a diagram illustrating a change in MTF characteristics of the imaging lens alone in Comparative Example A0;

FIG. 16E is a diagram illustrating a change in MTF characteristics during defocusing for 70 lines/mm;

FIG. 16F is a diagram illustrating a change in MTF characteristics during defocusing for 140 lines/mm;

FIG. 17 is a diagram illustrating the form of a lens surface of the phase correction plate in Example A1;

FIG. 18 is a diagram illustrating the form of a lens surface of the phase correction plate in Example A2;

FIG. 19 is a diagram illustrating the form of a lens surface of the phase correction plate in Example A3;

FIG. 20 is a diagram illustrating the form of a lens surface of the phase correction plate in Example A4;

FIG. 21 is a diagram illustrating the form of a lens surface of the phase correction plate in Example B1;

FIG. 22 is a diagram illustrating the form of a lens surface of the phase correction plate in Example B2;

FIG. 23 is a diagram illustrating the form of a lens surface of the phase correction plate in Example C1;

FIG. 24 is a diagram illustrating the form of a lens surface of the phase correction plate in Example C2;

FIG. 25 is a diagram illustrating the form of a lens surface of the phase correction plate in Example C3;

FIG. 26 is a diagram illustrating the form of a lens surface of the phase correction plate in Example D;

FIG. 27A is a diagram illustrating phase form I(1);

FIG. 27B is a diagram illustrating phase form I(2);

FIG. 27C is a diagram illustrating phase difference I(2)−I(1); and

FIG. 27D is a diagram illustrating phase difference I(2)−I(1) with respect to phase form I(1).

### DESCRIPTION OF THE PREFERRED EMBODIMENTS

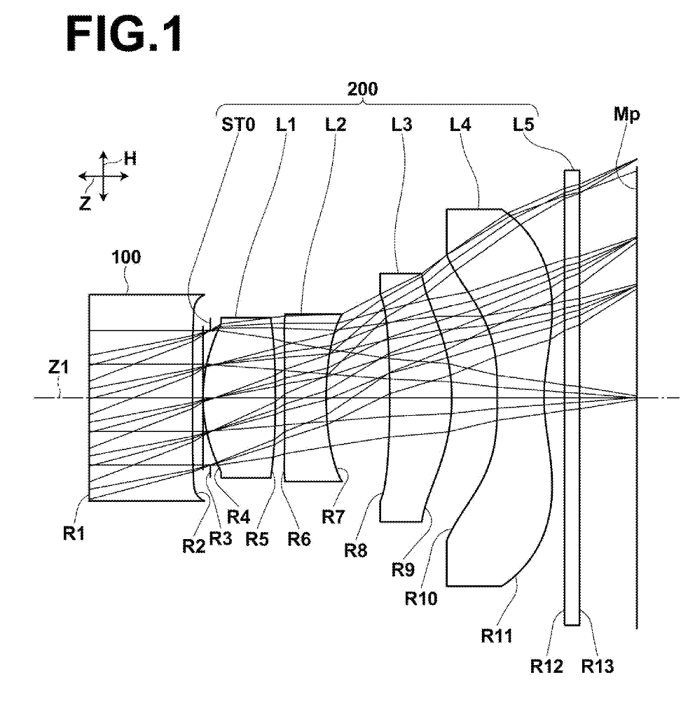

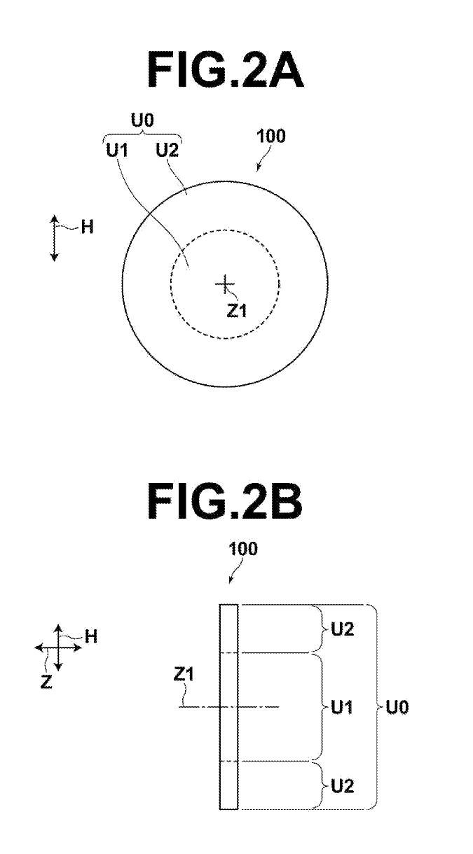

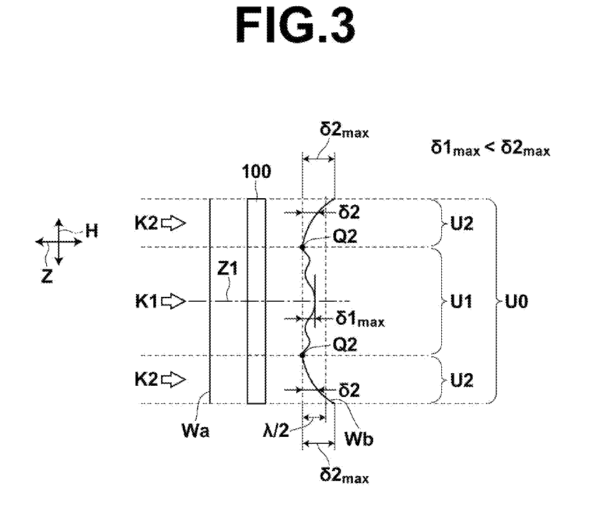

Hereinafter, embodiments of the present invention will be described with reference to drawings. FIG. 1 is a cross-sectional diagram illustrating a state in which a phase correction plate according to an embodiment of the present invention is mounted on an imaging lens. FIG. 2A is a diagram illustrating the phase correction plate viewed from the direction of an optical axis. FIG. 2B is a cross-sectional diagram illustrating the phase correction plate from a direction perpendicular to the optical axis. FIG. 3 is a diagram illustrating deformation of the wave front form of light that has pass through the phase correction plate.

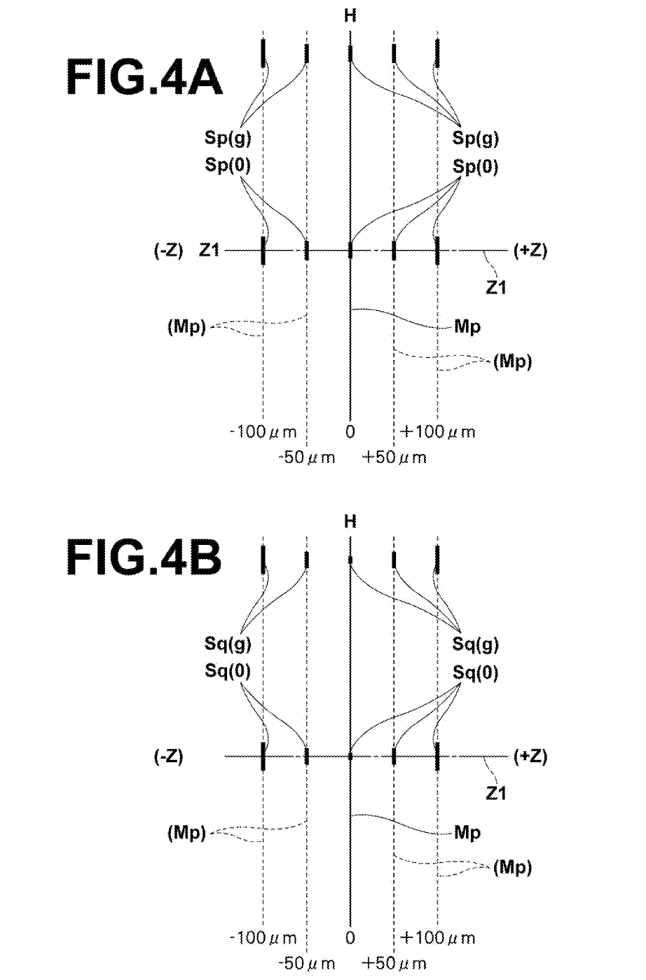

FIG. 4A is a diagram illustrating a change in the diameter of each spot during defocusing, each spot being formed at each position on an imaging plane by light that has passed through an imaging lens with a phase correction plate mounted thereon. In the coordinates of FIG. 4A, horizontal axis Z1 represents an optical axis, and vertical axis H represents a direction perpendicular to the optical axis. FIG. 4B is a diagram illustrating a change in the diameter of each spot during defocusing, each spot being formed at each position on an imaging plane by light that has passed through an imaging lens alone (without the phase correction plate mounted thereon).

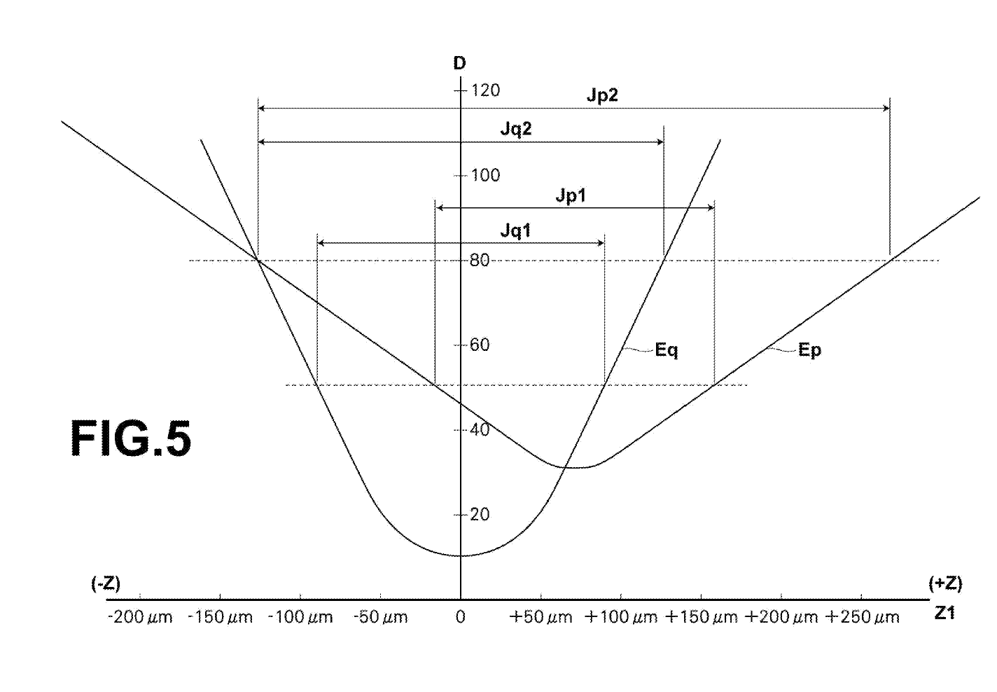

FIG. 5 is a diagram illustrating curve Ep and curve Eq in comparison with each other. In the coordinates of FIG. 5, vertical axis D represents the diameters of spots, and horizontal axis Z1 represents the optical axis, and defocus positions of an imaging plane are illustrated. The curve Ep shows a change in the spot diameter (diameter) of a condensed light spot formed by light that has passed through an imaging lens 200 with a phase correction plate 100 mounted thereon during defocusing. The curve Eq shows a change in the diameter of a condensed light spot formed by light that has passed through the imaging lens 200 alone without the phase correction plate 100 mounted thereon during defocusing.

In FIGS. 1, 2A, 2B and 3, only the lenses are illustrated, and frames for supporting the lenses, structures for mounting the phase correction plates on imaging lenses, and the like are omitted. As the mechanism for mounting the phase correction plate on an imaging lens, a mechanism similar to the method for mounting an ordinary filter (for example, an ND filter or the like) on a lens cylinder may be adopted. For example, the phase correction plate may be mounted by a screw, or the like.

In the present embodiment, a case of attaching the phase correction plate to the light incident side of an imaging lens will be described. However, it is not necessary that the phase correction plate is attached or mounted in such a manner. The present invention may be applied to a case of attaching the phase correction plate to the light output side of the imaging lens. Further, the phase correction plate may be applied to both of an imaging lens of a fixed-focus method and an imaging lens adopting a focusing method, which can adjust the focus to a specific distance of photography.

The phase correction plate 100 attached to the light incident side of the conventional imaging lens 200, as illustrated, prevents a drop in the performance (for example, resolution and brightness) of the imaging lens 200, and increases the depth of field. The phase correction plate 100 is easily attachable to the imaging lens 200 and easily detachable therefrom.

### <Basic Structure of Imaging Lens>

As illustrated in FIG. 1, the imaging lens 200 includes aperture diaphragm ST0, lens L1, lens L2, lens L3, lens L4, and cover glass L5 in this order along optical axis Z1 from an object side (subject side). As illustrated in FIG. 1, an image representing a subject is formed on imaging plane Mp by light that has passed through the imaging lens 200 to which the phase correction plate 100 has been attached. For example, a light receiving surface of an imaging device is arranged at the imaging plane Mp.

As the cover glass L5, a low-pass filter, an infrared-ray cut filter, or the like may be provided.

The phase correction plate 100 attached to the light incident side of the imaging lens 200 is positioned in the vicinity of the pupil of the imaging lens 200.

### <Basic Structure of Phase Correction Plate>

Effective region portion U0 is set in the phase correction plate 100 (please refer to FIGS. 2A and 2B). When the phase correction plate 100 is attached to the light incident side of the imaging lens 200, light that passes through the phase correction plate 100 and the imaging lens 200 and that forms an image of the subject on the imaging plane passes the effective region portion U0 of the phase correction plate 100.

The effective region portion U0 includes middle region portion U1, which is positioned in the middle of the effective region portion U0, and peripheral region portion U2, which is positioned on the periphery side of the effective region portion U0. In other words, the peripheral region portion U2 is the effective region portion U0 excluding the middle region portion U1.

As illustrated in FIG. 3, the phase correction plate 100 is formed in such a manner that maximum deformation amount δ1max for the middle region portion U1 is less than maximum deformation amount δ2max for the peripheral region portion U2 (δ1max<δ2max). The maximum deformation amount δ1max is the maximum amount of deformation of the wave front form of light beam K1 that has passed the middle region portion U1, in other words, the maximum amount of deformation from the wave front form of light before the light passes the middle region portion U1 to the wave front form of the light after the light passes the middle region portion U1. The maximum deformation amount δ2max is the maximum amount of deformation of the wave front form of light beam K2 that has passed the peripheral region portion U2, in other words, the maximum amount of deformation from the wave front form of light before the light passes the peripheral region portion U2 to the wave front form of the light after the light passes the peripheral region portion U2.

As illustrated in FIG. 3, wave front form Wa of beams before passing the effective region portion U0 of the phase correction plate 100 is a plane (flat surface). Wave front form Wb of the beams after passing the effective region portion U0 is wavy.

Further, the middle region portion (also referred to as a middle region, or a central region) of the phase correction plate 100 may be defined as follows.

As illustrated in FIG. 3, when the position of an inflection point immediately before the maximum shift amount in form (difference in phase) between the wave front form Wa of light that enters the phase correction plate 100 and the wave front form Wb of light that passes through the phase correction plate 100 and is output from the phase correction plate 100 exceeds λ/2 (λ is wavelength) is position Q2, the middle region portion U1 of the phase correction plate 100 may be defined as a region having a radius that is determined by the position Q2 with respect to the optical axis Z1.

In other words, the middle region portion U1 may be a region of the phase correction plate 100 that is included in a cylinder formed with respect to the optical axis Z1, the circular end of the cylinder having a radius determined by the position Q2 of the inflection point.

The term “immediately” is used based on the premise that the range of search for an inflection point or the like is expanded from the optical axis Z1 toward the periphery. In other words, the term “immediately” is used based on the premise that the closer to the optical axis Z1 a position is, the earlier the position is found.

When the middle region portion U1 is set as described above, the maximum deformation of the wave front form of light that passes the middle region portion U1 becomes the same as the maximum deformation amount δ1max, which is the maximum amount of deformation of the wave front form of light that has passed the middle region portion U1, the deformation from the wave front form of light before the light passes the middle region portion U1 to the wave front form of the light after the light passes the middle region portion U1. The middle region portion U1 does not include a region in which the deformation amount of light that passes the middle region portion U1 exceeds λ/2.

Alternatively, in the form of the phase difference caused by the phase correction plate 100, a middle region and a peripheral region may be defined as follows. The radius of the middle region is the height of an inflection point from the optical axis Z1, the inflection point being closest to the optical axis in the phase form of a region that includes the optical axis Z1, and in which the degree of phase difference exceeds λ/2. Meanwhile, the peripheral region is an effective region on the outside of the inflection point.

The maximum deformation amount δ2max of the wave front form of light that passes the peripheral region portion U2, the deformation amount from the wave front form of light before the light passes the peripheral region portion U2 to the wave front form of the light after the light passes the peripheral region portion U2, is greater than the maximum deformation amount δ1max.

The wave front of light (beams) is a surface connecting portions having the same phase. Here, the maximum deformation amount δ1max, which is the maximum deformation amount of the wave front form of light (beams), the deformation from the wave front form of light before the light passes the middle region to the wave front form of the light after the light passes through the middle region, is determined by the phase of the light (beams). A surface connecting portions having the same phase is an equal phase surface, and the form of the equal phase surface corresponds to the wave front form.

The phase difference may correspond to a difference between the maximum value and the minimum value of a change in the phase of axial light when the axial light having uniform phase enters the middle region and is output from the middle region, the change from the phase of light before the light passes the middle region to the phase of the light after the light passes the middle region.

Further, the phase correction plate 100 is structured in such a manner that the deformation amount of the wave front form of beam K2 that passes the peripheral region portion U2 monotonically increases from a center-side position Q2 of the beam K2 that passes the peripheral region portion U2 toward the periphery side. Specifically, the deformation amount δ2 of the wave front form of the beam K2 monotonically increases from the center-side position Q2 of the beam K2 toward the periphery side, the deformation amount from the wave front form of the beam K2 before the beam K2 passes the peripheral region portion U2 to the wave front form of the beam K2 after the beam K2 passes the peripheral region portion U2.

Further, the phase correction plate 100 is structured in such a manner that a change in the diameter (a blur amount of a pixel representing an image of the subject) of each spot formed at each position on an imaging plane by light that has passed through the imaging lens with the phase correction plate 100 mounted thereon during defocusing is less than a change in the diameter of a spot formed, in such a manner to correspond to each of the positions on the imaging plane, by light that has passed through the imaging lens 200 alone (without the phase correction plate 100 mounted thereon) during defocusing.

The spot diameter during defocusing may be defined by the diameter of an image representing a spot formed on a flat surface parallel to an imaging plane when the flat surface is moved, in parallel to the imaging plane, from the imaging plane by a predetermined amount along the optical axis of the imaging lens 200.

Further, the amount of change in the spot diameter during defocusing may be obtained, for example, as ratio ε(ε=Ds2/Ds1). The ratio ε is the ratio of the diameter (Ds2) of an image representing spot Sp2 to the diameter (Ds1) of an image representing spot Sp1, which is formed on the imaging plane. The spot Sp2 corresponds to the spot Sp1, and the spot Sp2 is formed on a flat surface that is moved in parallel to the imaging plane from the position of the imaging plane along the optical axis of the imaging lens 200 by a predetermined amount.

Further, the imaging lens 200 with the phase correction plate 100 mounted thereon is referred to as a lens unit.

The diameter of each spot formed at each position on the imaging plane by light that has passed through the lens unit, which is the imaging lens 200 with the phase correction plate 100 mounted thereon, changes during defocusing. As illustrated in FIG. 4A, when imaging plane Mp at a reference position (the area of the spot is the smallest, and the defocus amount is 0), which is perpendicular to the optical axis Z1, is moved in parallel (defocus) along the optical axis Z1 to each position of −100 μm, −50 μm, +50 μm, +100 μm, the area of spot Sp(o) on the optical axis Z1 changes from the minimum value of 960 square micrometers (diameter is approximately 35 μm) to the maximum value of 2400 square micrometers (diameter is approximately 55 μm). Specifically, the maximum value of the area of the spot Sp(o) during defocusing is 2.5 times as large as the minimum value of the area. Therefore, the value of a change amount in the area of a spot on the optical axis, the spot being formed at each position on an imaging plane by light that has passed through the imaging lens 200 with the phase correction plate 100 mounted thereon, is 2.5 (a change amount=the maximum value of the area of a spot/the minimum value of the area of a spot).

As described above, the size of the spot may be, for example, the area of a spot, or the diameter of the spot.

For spot Sp(g), which is formed on the imaging plane Mp other than the optical axis, the value of change in the area of the spot Sp(g) during defocusing (the imaging plane Mp is moved along the optical axis Z1 to each position of −100 μm, −50 μm, ±0 μm, +50 μm, +100 μm) is also approximately 2.5, which is similar to the case of spot Sp(o).

For each spot formed at any position on the imaging plane Mp, the value of change in the area of the spot during defocusing (the imaging plane Mp is moved along the optical axis Z1 to each position of −100 μm, −50 μm, ±0 μm, +50 μm, +100 μm) is also approximately 2.5.

In contrast, a change amount of each spot (the area of the spot) imaged at each position on the imaging plane by light that has passed through the imaging lens 200 alone without the phase correction plate 100 mounted thereon changes during defocusing, as illustrated in FIG. 4B. Specifically, when imaging plane Mp at a reference position (the area of the spot is the smallest, and the defocus amount is 0) is moved in parallel (defocus) along the optical axis Z1 to each position of −100 μm, −50 μm, +50 μm, +100 μm, the area of spot Sq(o) on the optical axis Z1 changes from the minimum value of 79 square micrometers (diameter is approximately 10 μm) to the maximum value of 2800 square micrometers (diameter is approximately 60 μm). Specifically, the maximum value of the area of the spot Sq(o) during defocusing is 35 times as large as the minimum value of the area. Therefore, the value of a change amount in the area of a spot on the optical axis, the spot being formed at each position on an imaging plane by light that has passed through the imaging lens 200 alone, is 35 (a change amount=the maximum value of the area of a spot/the minimum value of the area of a spot).

For each spot formed at any position on the imaging plane Mp, the value of change in the area of the spot during defocusing (the imaging plane Mp is moved along the optical axis Z1 to each position of −100 μm, −50 μm, ±0 μm, +50 μm, +100 μm) is also approximately 35.

As described above, the change amount in the area of the condensed light spot formed by light that has passed through the imaging lens 200 with the phase correction plate 100 mounted thereon during defocusing is approximately 0.07 times (2.5/35) as large as a change amount in the area of the condensed light spot formed by light that has passed through the imaging lens 200 alone.

The ratio of a change in the area of each condensed light spot formed at each position on the imaging plane through the imaging lens with the phase correction plate during defocusing to a change in the area of each condensed light spot formed, in such a manner to correspond to each of the positions on the imaging plane, by light that has passed through the imaging lens alone without the phase correction plate mounted thereon during defocusing may be less than or equal to 50%. It is desirable that the ratio is less than or equal to 20%, and optionally, less than or equal to 7%.

Next, curve Ep and curve Eq illustrated in FIG. 5 will be compared with each other. The curve Ep shows a change in the spot diameter (diameter) of a condensed light spot formed by light that has passed through an imaging lens 200 with a phase correction plate 100 mounted thereon during defocusing. The curve Eq shows a change in the diameter of a condensed light spot formed by light that has passed through the imaging lens 200 alone without the phase correction plate 100 mounted thereon during defocusing. In the descriptions of FIG. 5, the diameter of the spot is used as the spot diameter. However, it is not necessary that the spot diameter is adopted. Similar descriptions may be applied to the case of adopting the area of the spot or the like instead of the spot diameter.

As the curve Eq in FIG. 5 shows, the size of the condensed light spot formed by light that has passed through the imaging lens 200 alone is the smallest at the reference position of the imaging plane Mp (the spot diameter is the smallest at the reference position, and the defocus amount is 0 at the reference position). However, as the curve Ep in FIG. 5 shows, when the phase correction plate 10 is mounted on the imaging lens 200, a defocus position at which the spot diameter of a condensed light spot formed by light that has passed through the imaging lens 200 with the phase correction plate 100 mounted thereon is the smallest is away from the reference position (the position with the defocus amount of 0) of the imaging plane Mp approximately by +70 μm.

Further, the change of the condensed light spot formed by light that has passed through the imaging lens 200 with the phase correction plate 100 mounted thereon (please refer to curve Ep) is more gradual than the change of the condensed light spot formed by light that has passed through the imaging lens 200 alone (please refer to curve Eq).

When it is supposed that a spot (image) is in focus when the diameter of the spot is less than or equal to 50 μm, in the curve Ep, the width of defocusing range Jp1 in which the spot diameter is less than or equal to 50 μm, in other words, the width of the defocusing range Jp1 corresponding to the depth of field is approximately 220 μm. Meanwhile, in the curve Eq, the width of defocusing range Jq1 in which the spot diameter is less than or equal to 50 μm, in other words, the width of the defocusing range Jq1 corresponding to the depth of field is approximately 220 μm. Therefore, in the curve Ep and the curve Eq, the defocusing ranges in which the spot diameters are less than or equal to 50 μm are approximately the same.

When the spot diameter for judging that the spot (image) is in focus is set greater than 50 μm, the defocusing range of the imaging lens 200 with the phase correction plate 100 mounted thereon (please refer to curve Ep) is wider than the defocusing range of the imaging lens 200 without the phase correction plate 100 (please refer to curve Eq). In other words, the depth of field of the imaging lens 200 with the phase correction plate 100 mounted thereon is deeper than the depth of field of the imaging lens 200 without the phase correction plate 100.

More specifically, when bar codes and letter text are photographed, high resolution is not necessary. Therefore, even when the image is defocused in such a manner that the spot diameter is, for example, 70 μm or 80 μm, it is regarded that the image is in focus. When the range in focus is set in such a manner, it is possible to judge that the phase correction plate 100 mounted on the imaging lens 200 could increase the depth of field.

In FIG. 5, when a range in which the spot diameter is less than or equal to 80 μm is allowable as the in-focus range (the range corresponding to the depth of field), width Jq2 of the defocusing range, corresponding to the depth of field, when a subject is photographed through the imaging lens 200 alone without the phase correction plate 100 mounted thereon is approximately 250 μm. In contrast, width Jp2 of the defocusing range, corresponding to the depth of field, when a subject is photographed through the imaging lens 200 with the phase correction plate 100 mounted thereon is approximately 400 μm. Therefore, when the phase correction plate 100 is mounted on the imaging lens 200, the range of distance in which a subject is regarded as being in focus (the depth of field) greatly increases.

The brightness (F-number) when photography is performed through the imaging lens 200 alone and the brightness (F-number) when photography is performed through the imaging lens 200 with the phase correction plate 100 mounted thereon are substantially the same. Therefore, the shutter speed for photography may be set to a similar speed.

As described above, when the phase correction plate 100 is mounted on the imaging lens 200, it is possible to increase the depth of field while preventing a drop in the resolution and a drop in the brightness. Particularly, when short distance photography (close-up photography) is performed in a relatively dark place, such as a room (inside a building) to image bar codes, letter text or the like, a diaphragm is opened. In such a case, inclination of the letter text (a draft or an original copy) with respect to the optical axis of the imaging lens 200 and a hand shake in the direction of the optical axis of the imaging lens 200 may blur the image of the subject formed on the imaging plane. However, the present invention can remarkably prevent blurring of the image.

### SPECIFIC EXAMPLES

Numerical data and the like on Examples A1 through A4, Examples B1 and B2, Examples C1 through C3, and Example D, in which the phase correction plates of the present invention are mounted on imaging lenses, will be summarized. Further, numerical data and the like on an imaging lens alone (Comparative Example A0) will be described. In Comparative Example A0, the phase correction plate is removed from the imaging lens with the phase correction plate mounted thereon according to Examples A1 through A4.

Tables 1 through 23, which will be described in the rest of the specification, are provided at the end of the specification.

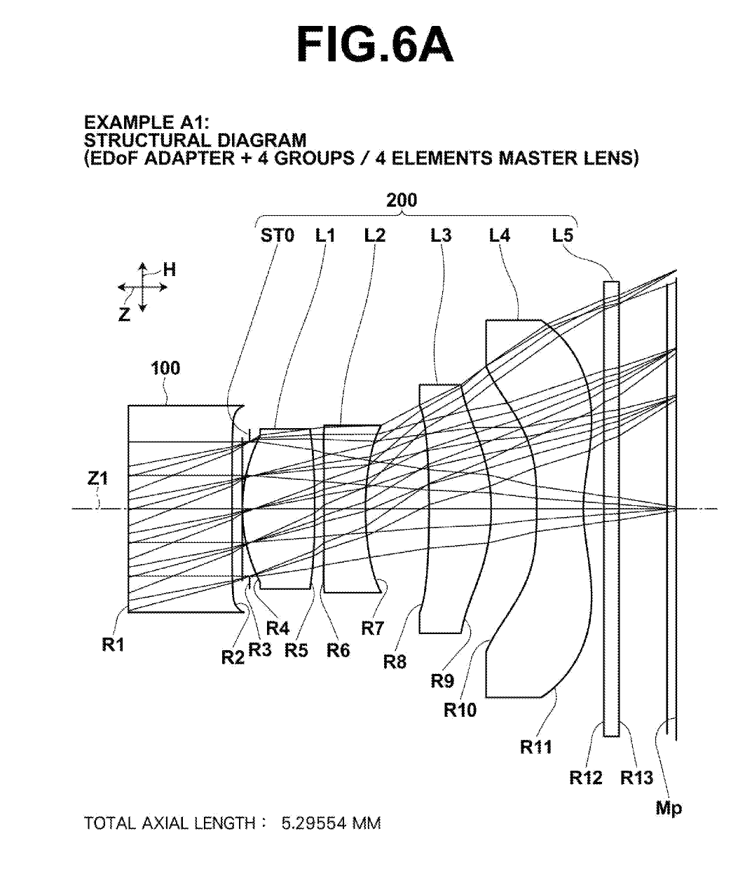

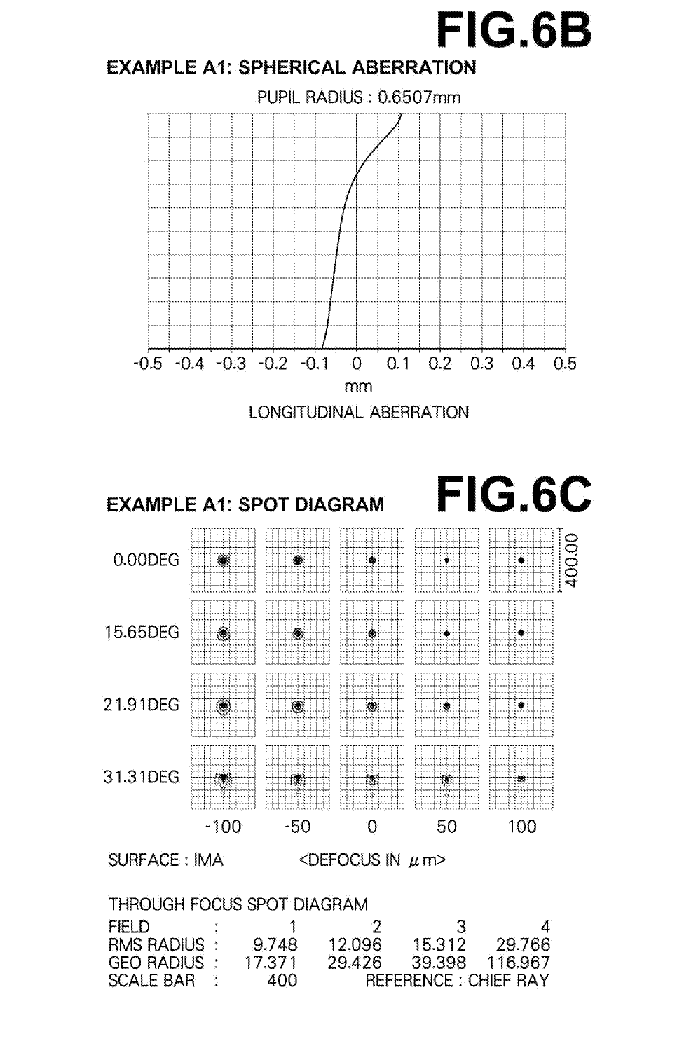

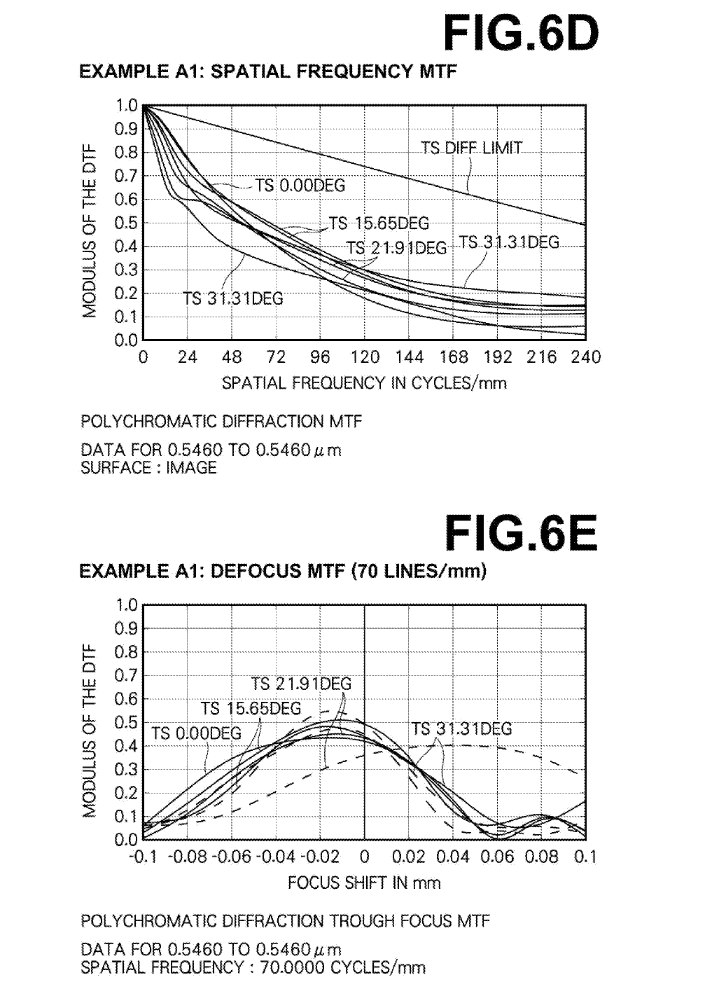

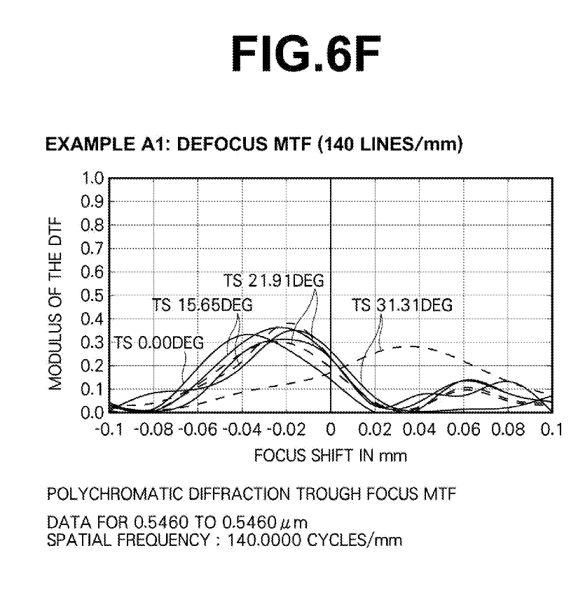

FIGS. 6A, 6B, 6C, 6D, 6E and 6F, and Tables 1A, 1B and 1C, which will be described later, show data related to an imaging lens with a phase correction plate mounted thereon according to Example A1.

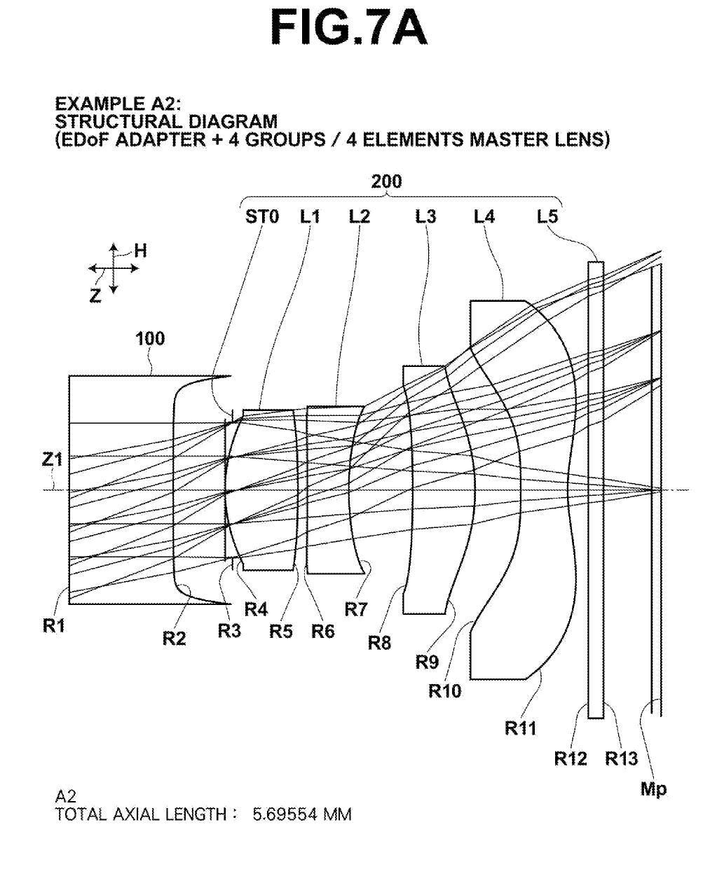

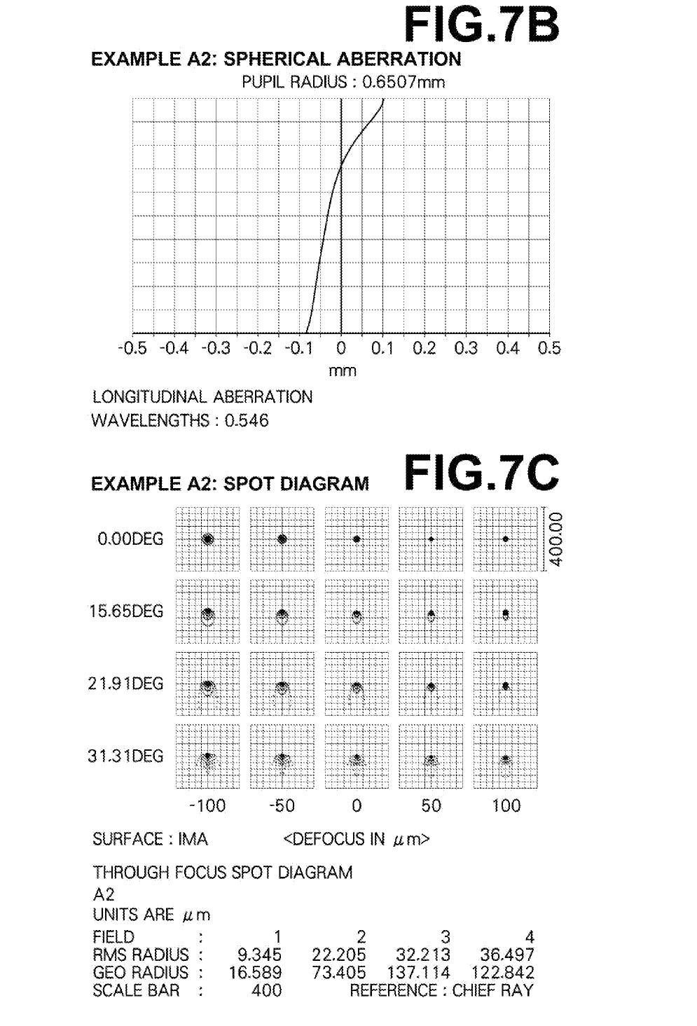

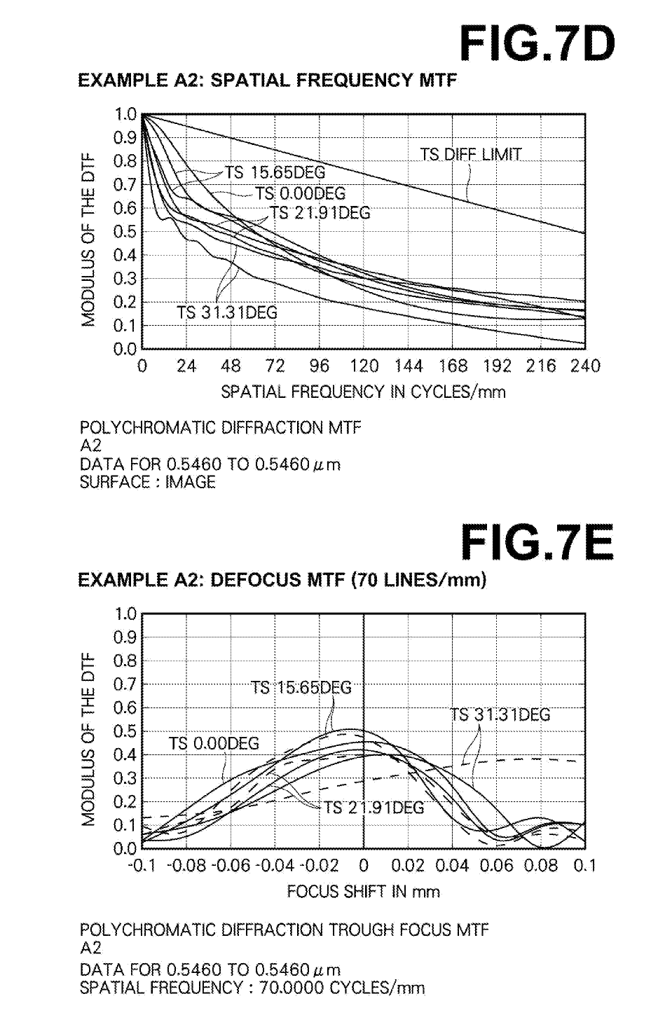

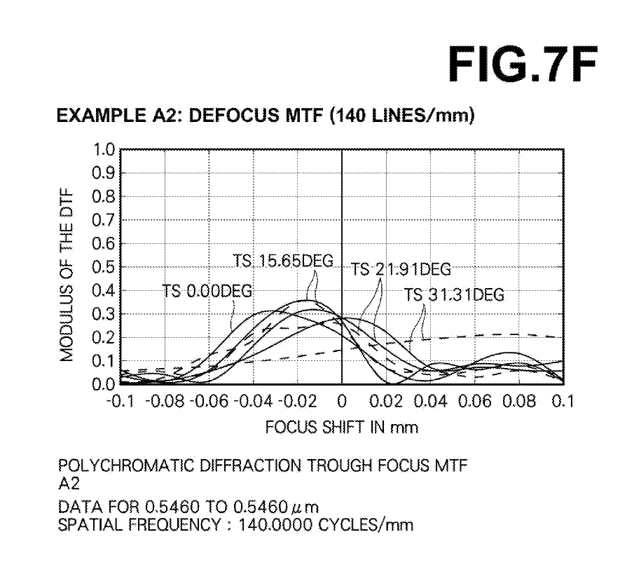

FIGS. 7A through 7F, and Tables 2A through 2C, which will be described later, show data related to an imaging lens with a phase correction plate mounted thereon according to Example A2.

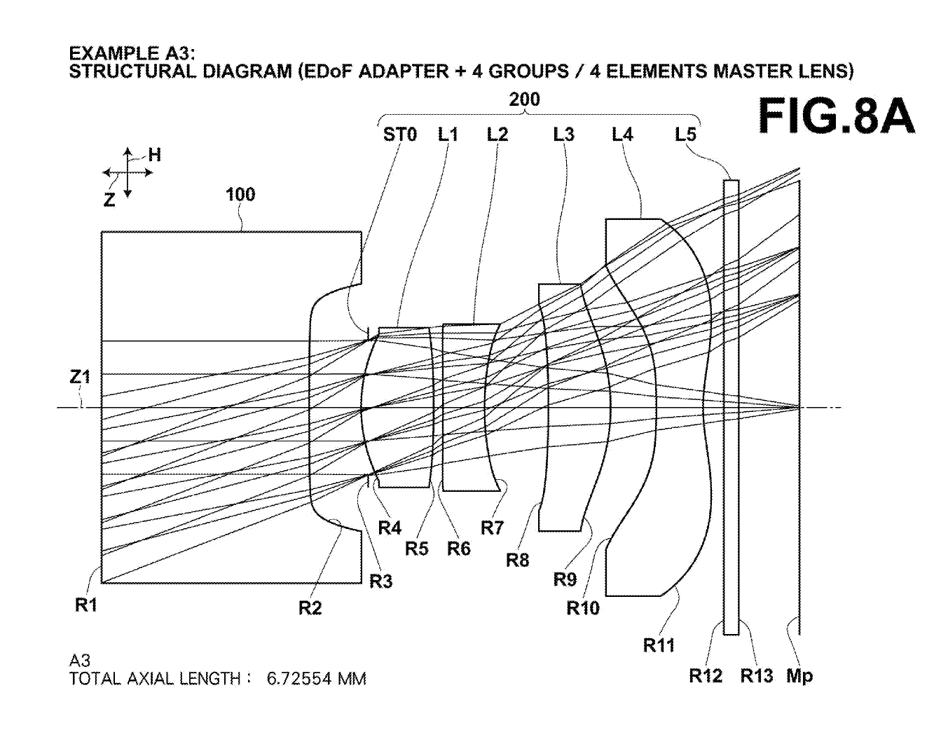

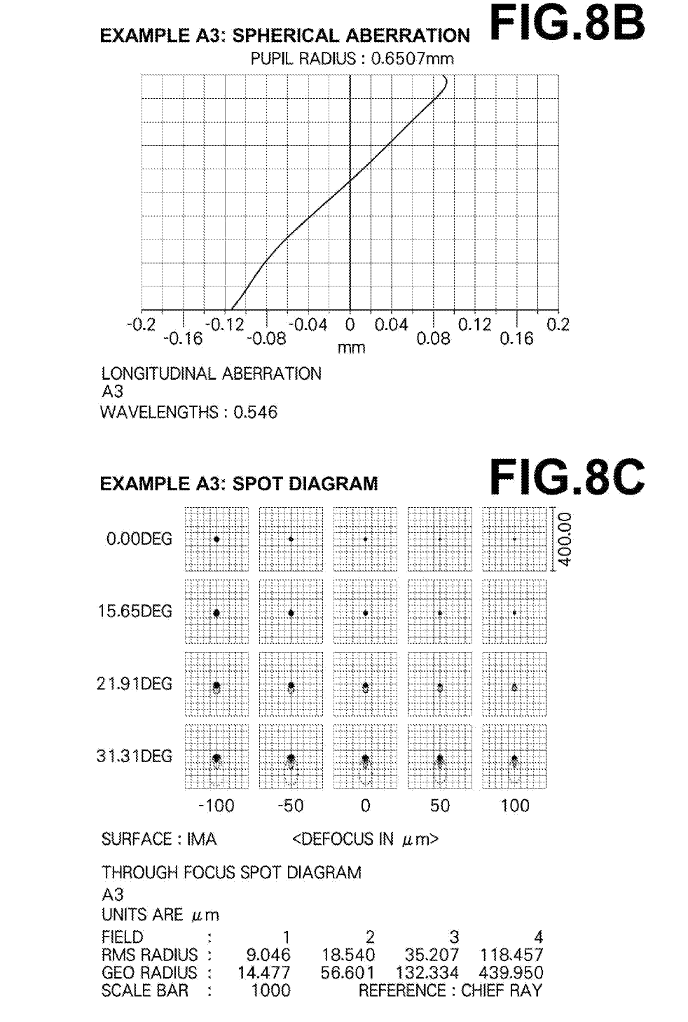

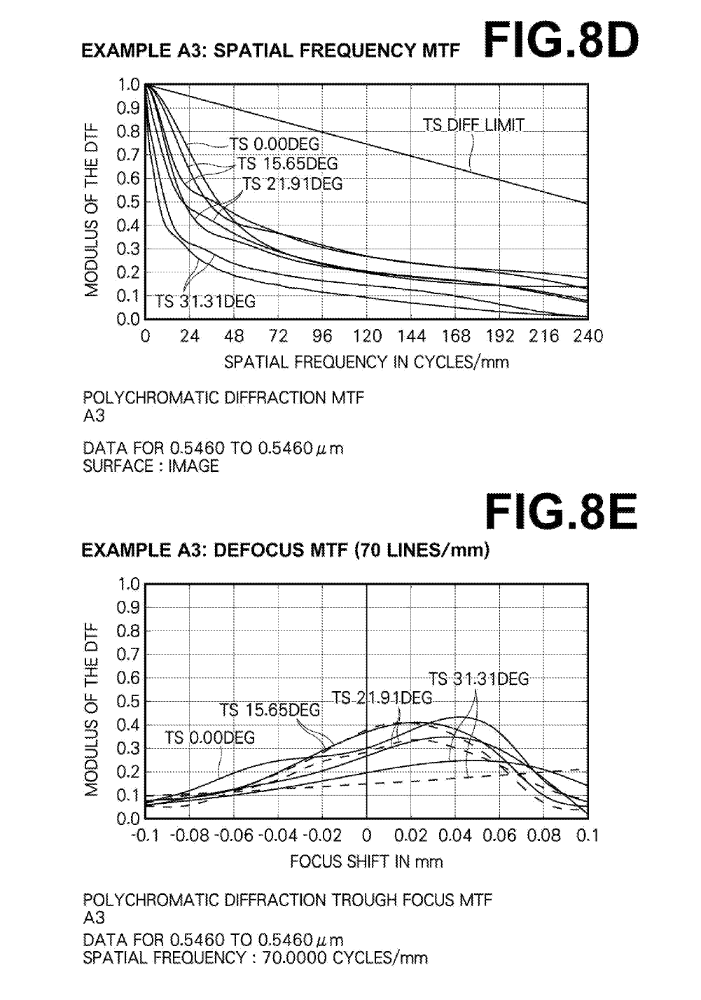

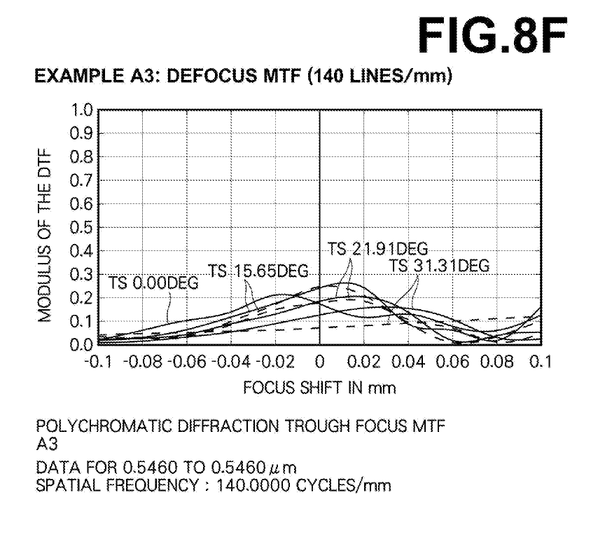

FIGS. 8A through 8F, and Tables 3A through 3C, which will be described later, show data related to an imaging lens with a phase correction plate mounted thereon according to Example A3.

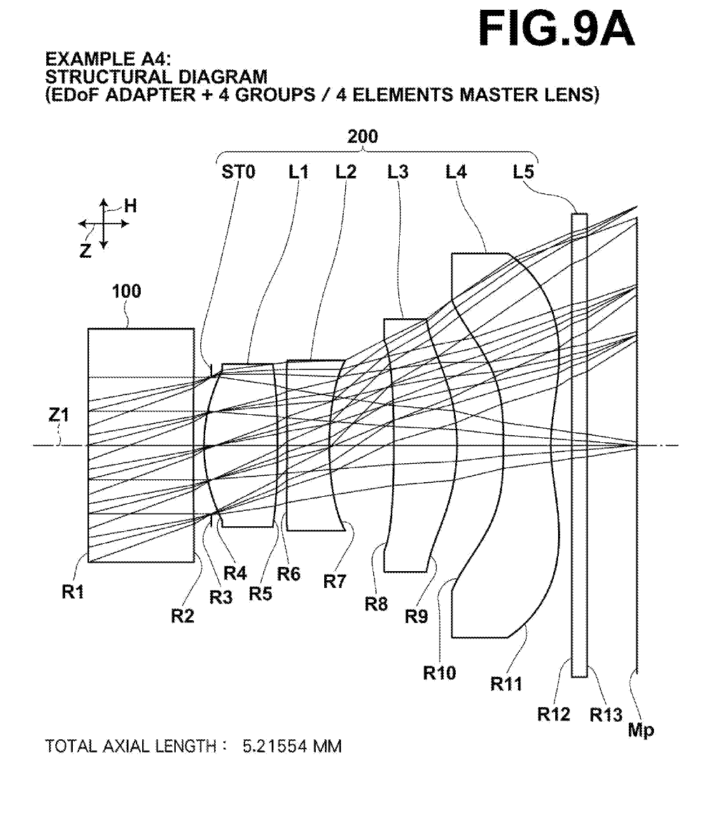

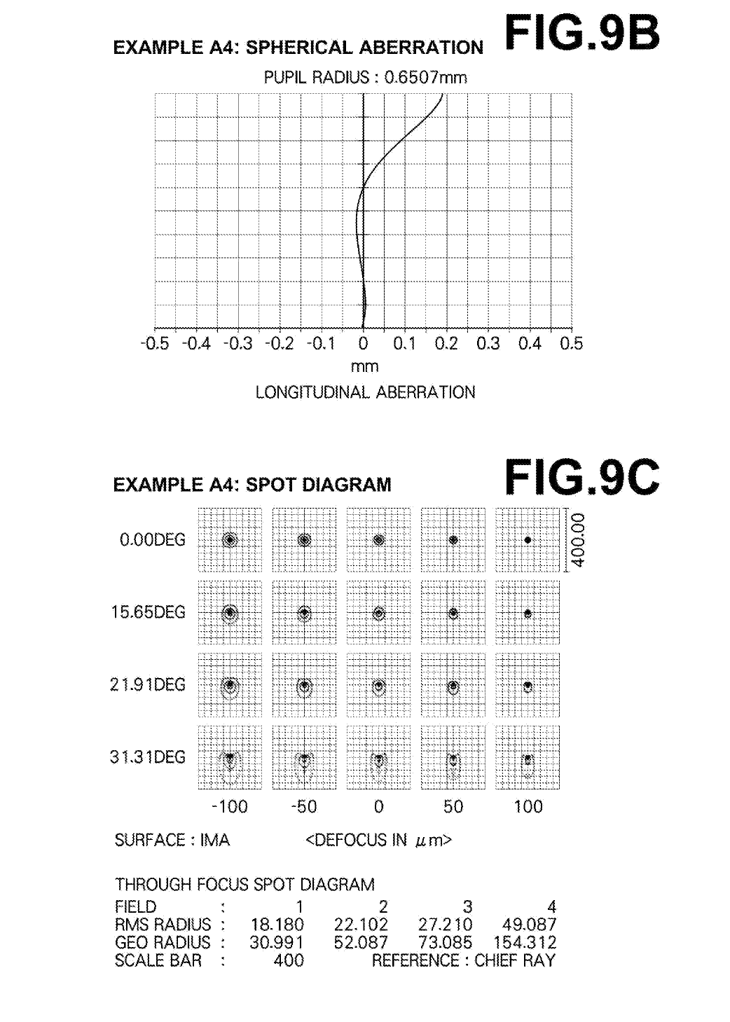

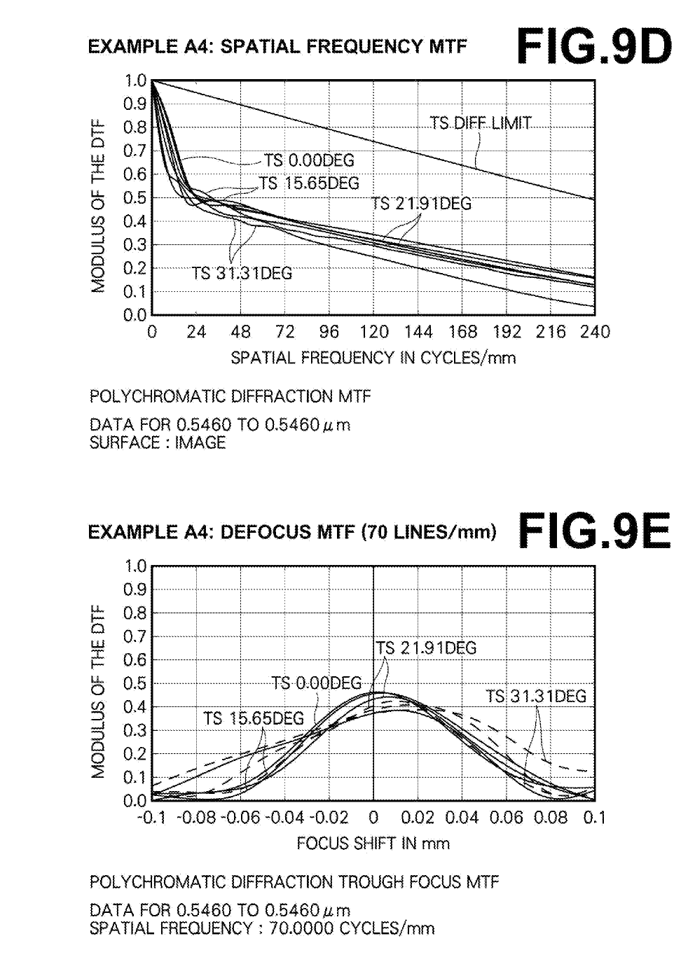

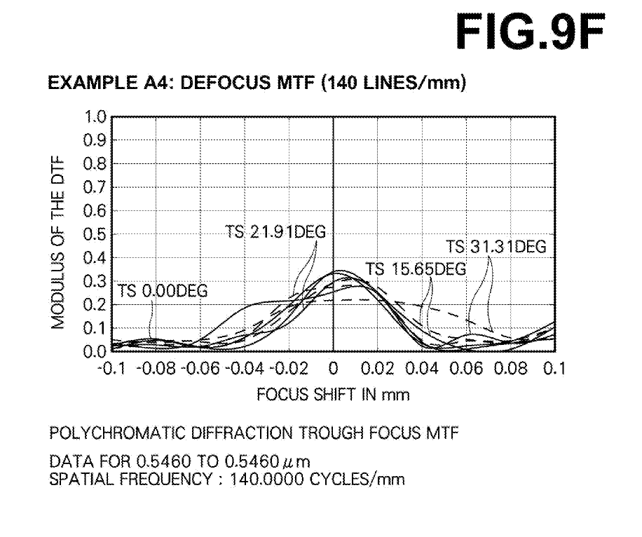

FIGS. 9A through 9F, and Tables 4A through 4C, which will be described later, show data related to an imaging lens with a phase correction plate mounted thereon according to Example A4.

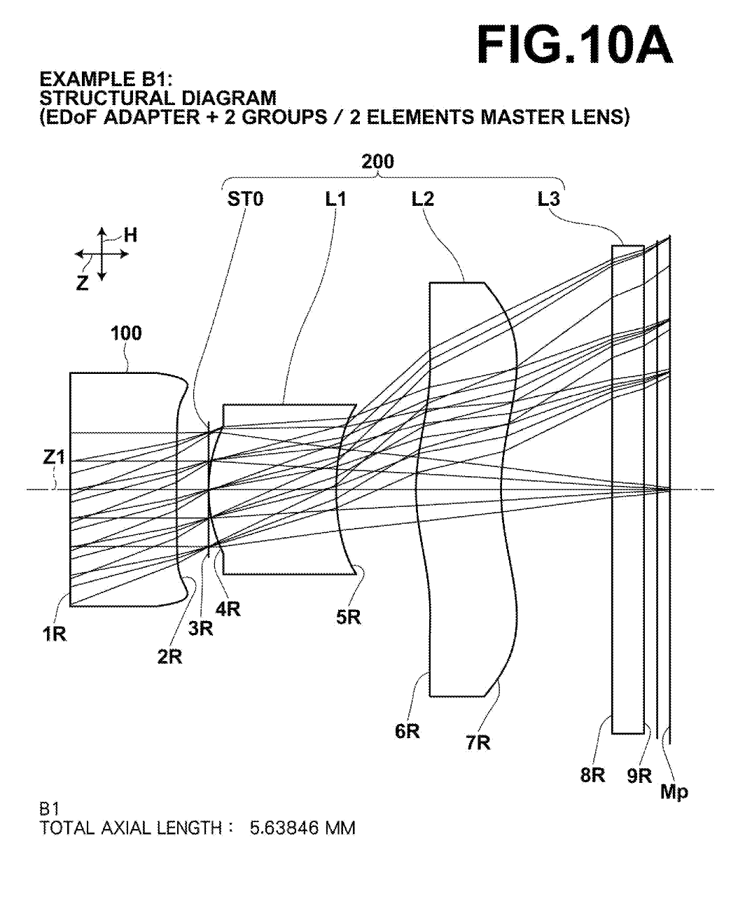

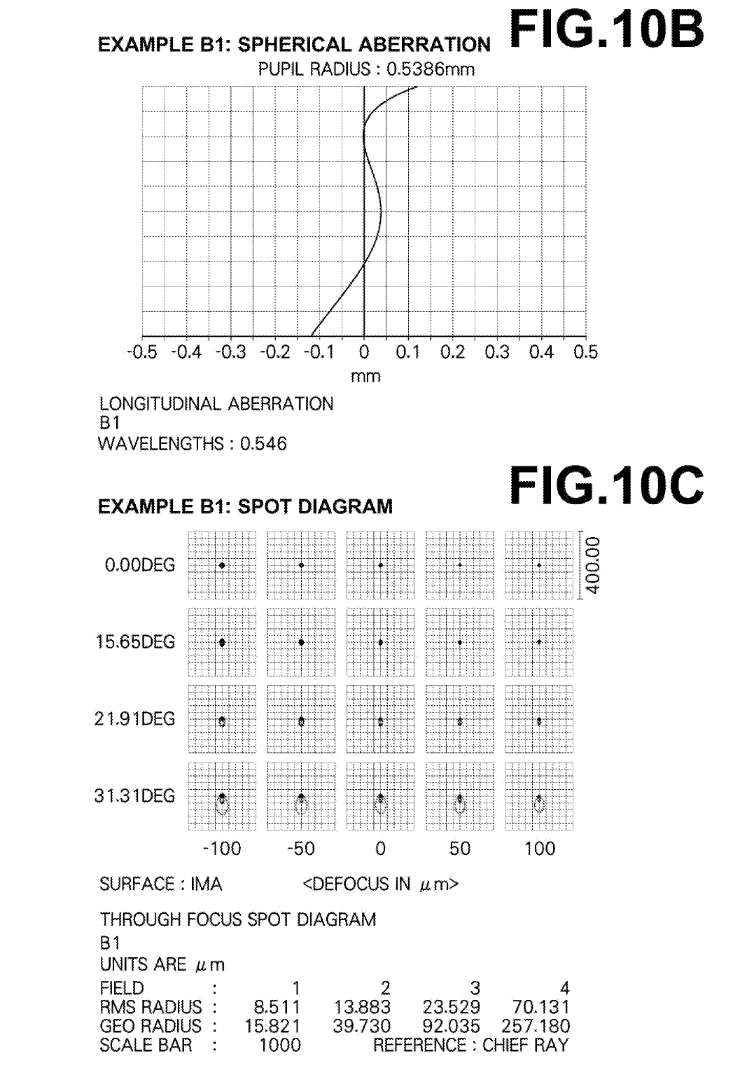

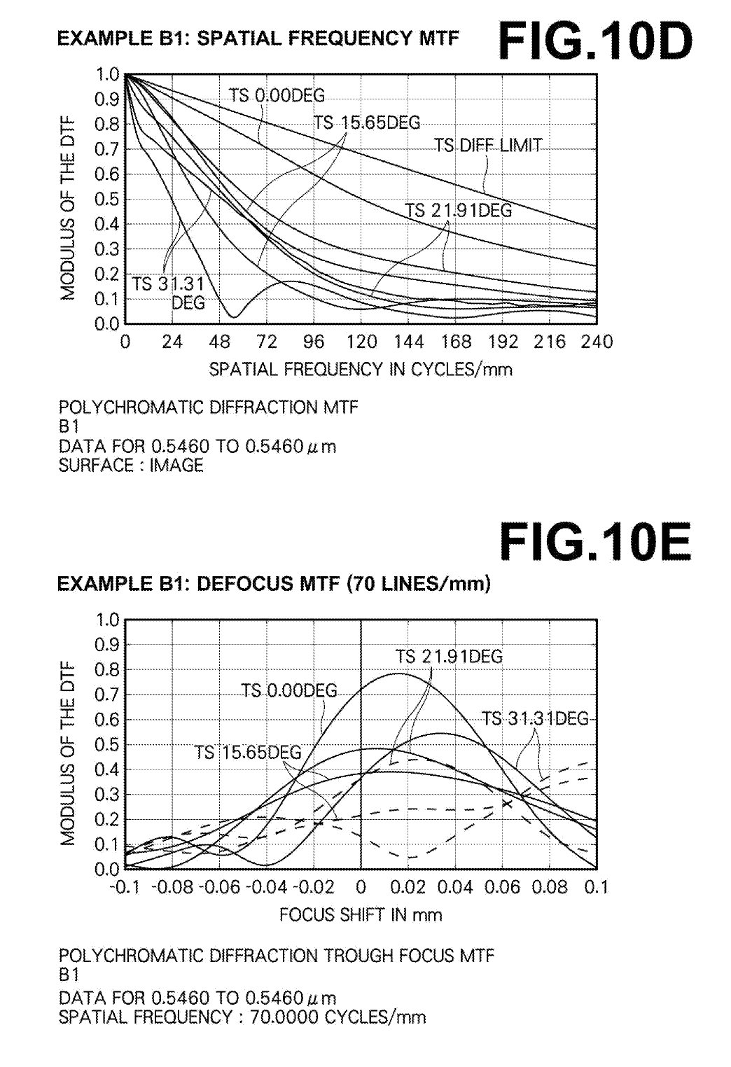

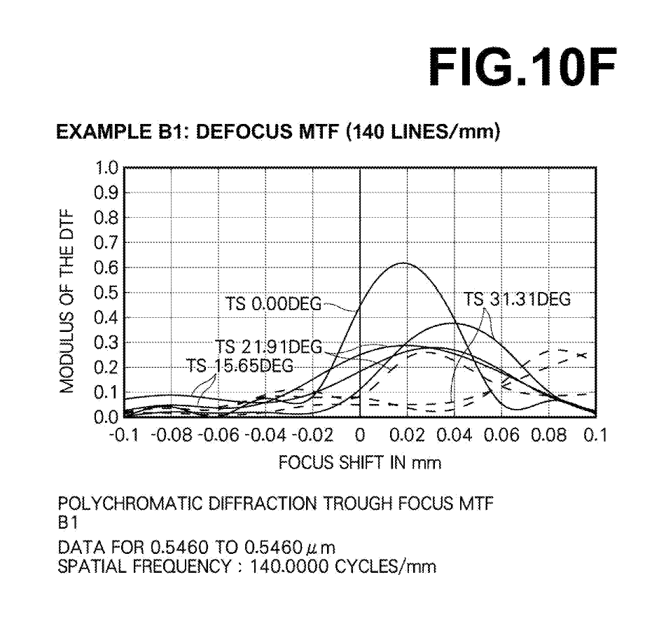

FIGS. 10A through 10F, and Tables 5A through 5C, which will be described later, show data related to an imaging lens with a phase correction plate mounted thereon according to Example B1.

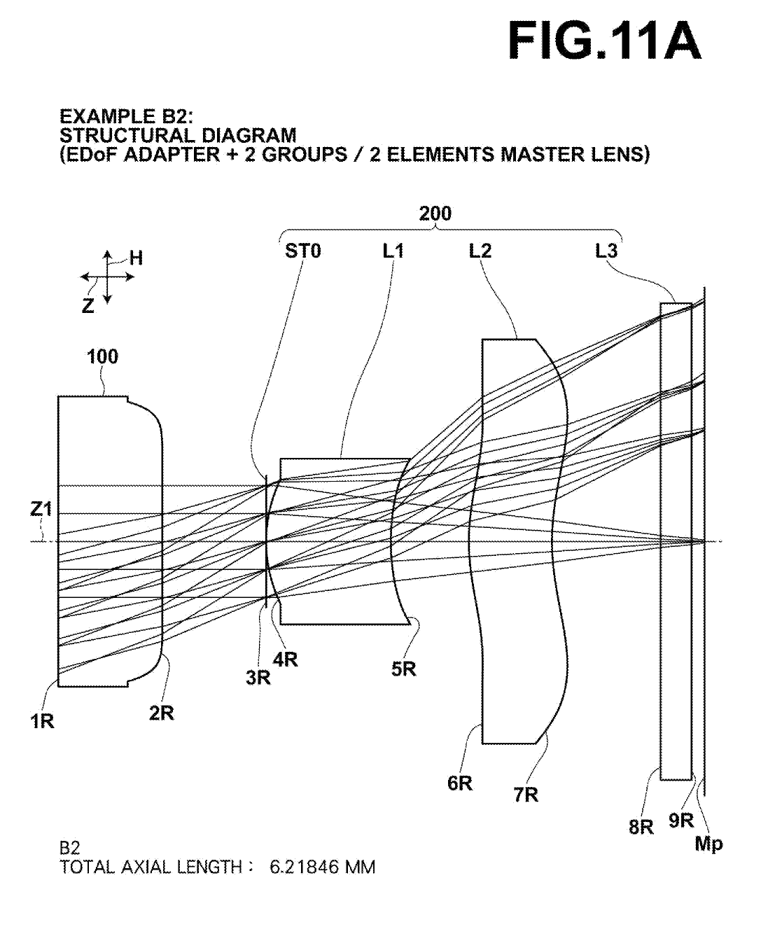

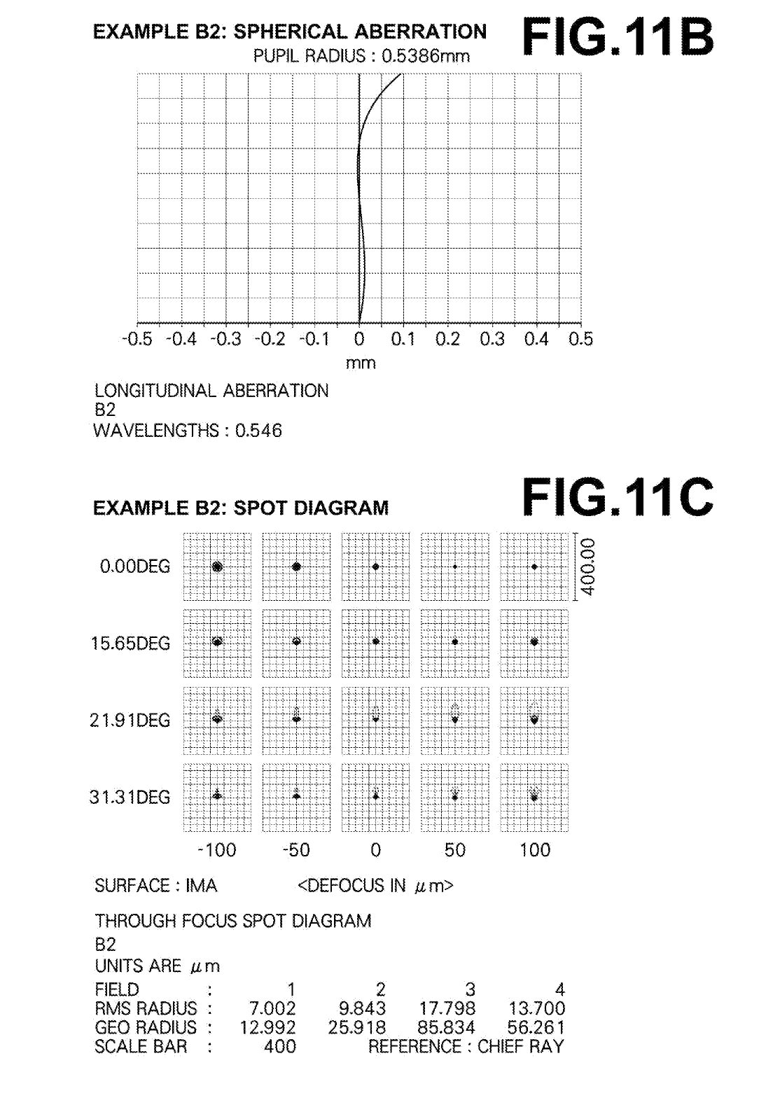

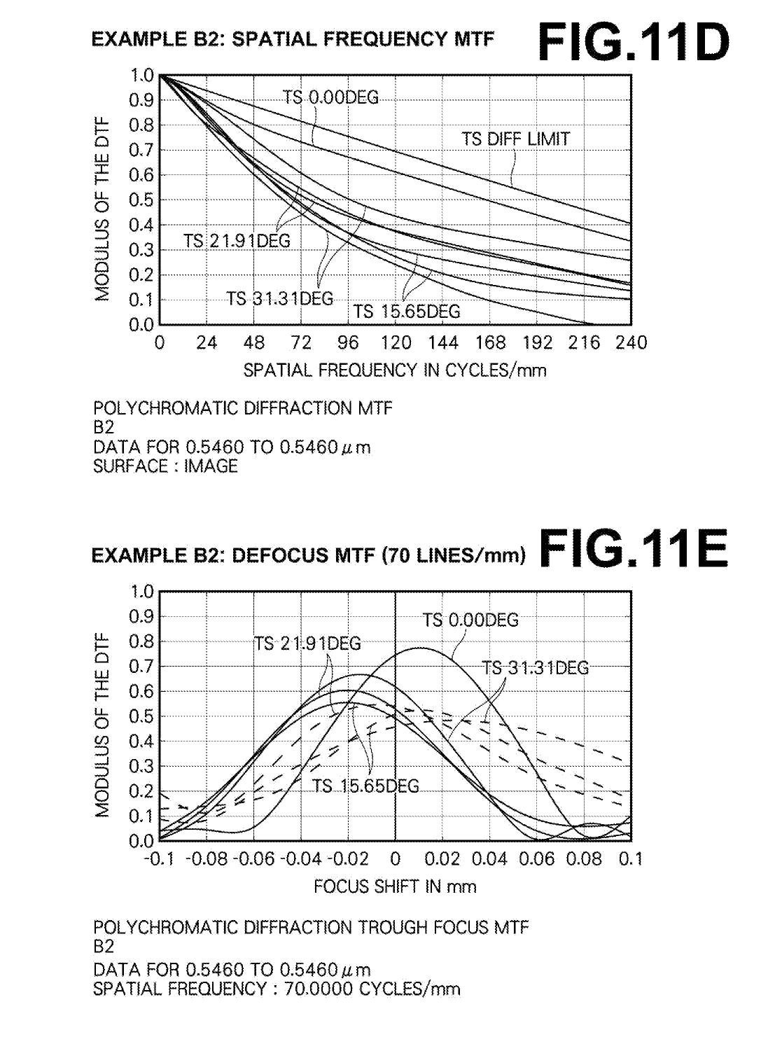

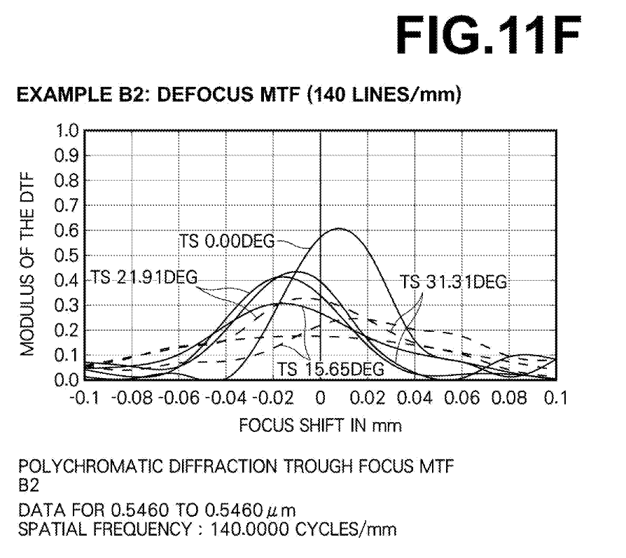

FIGS. 11A through 11F, and Tables 6A through 6C, which will be described later, show data related to an imaging lens with a phase correction plate mounted thereon according to Example B2.

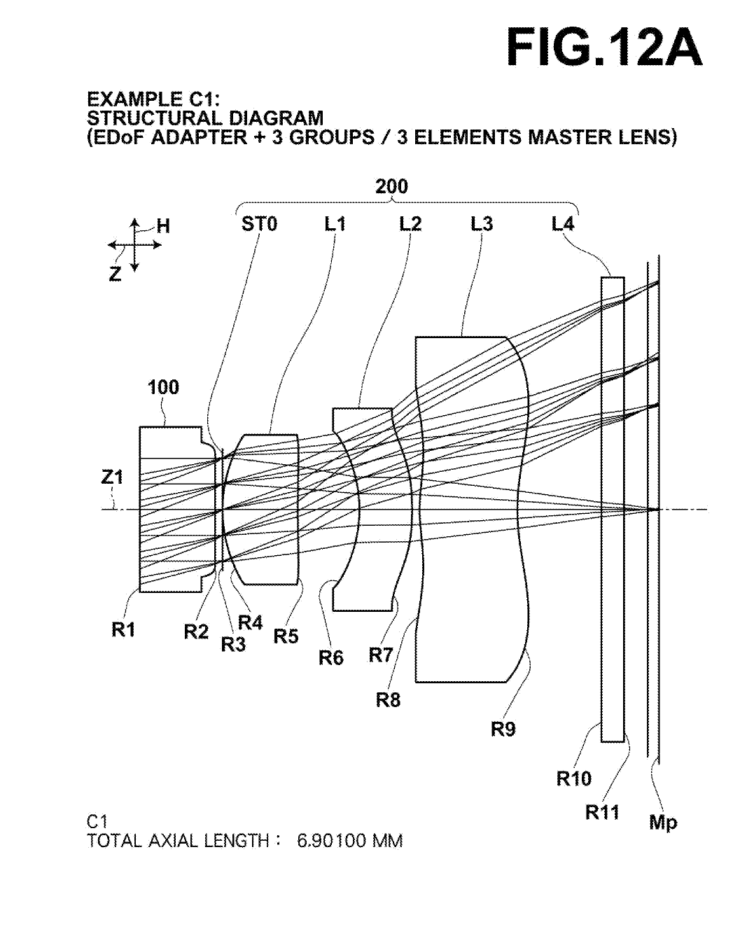

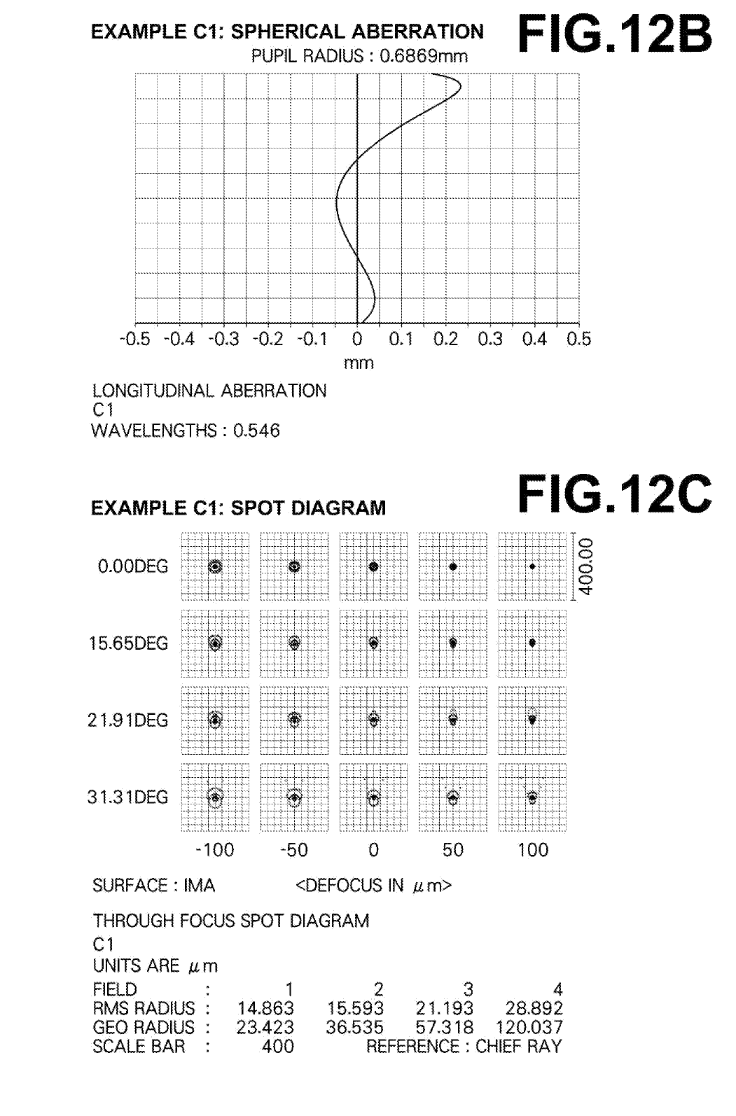

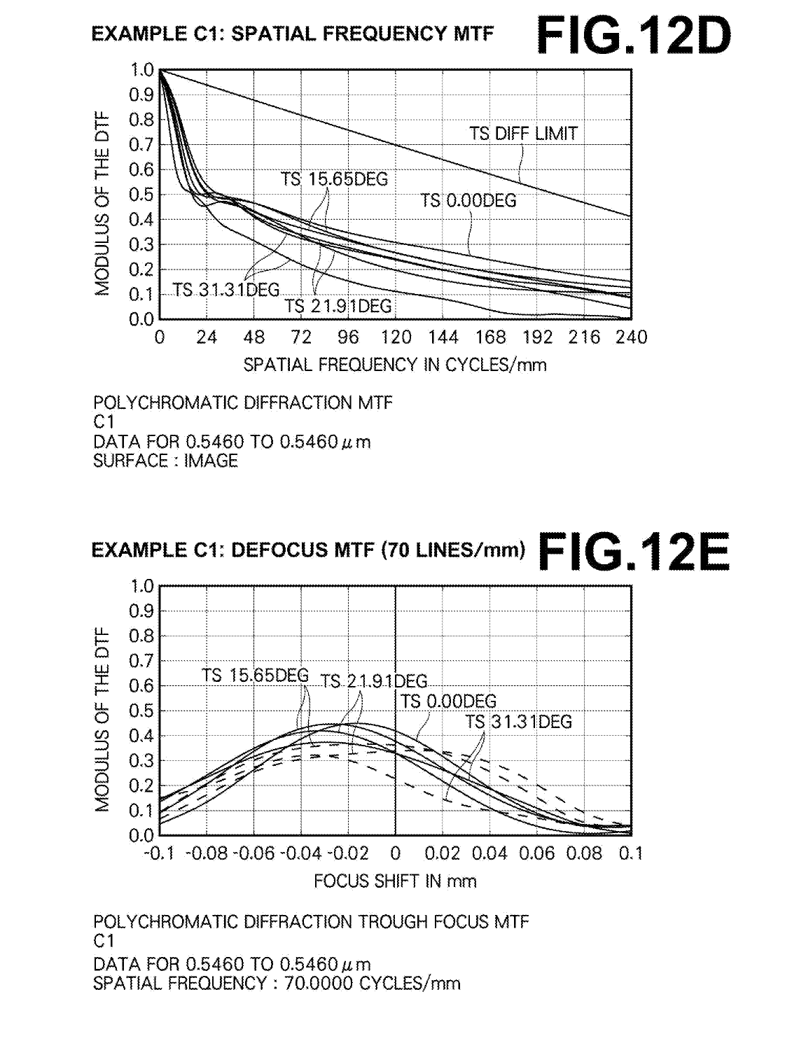

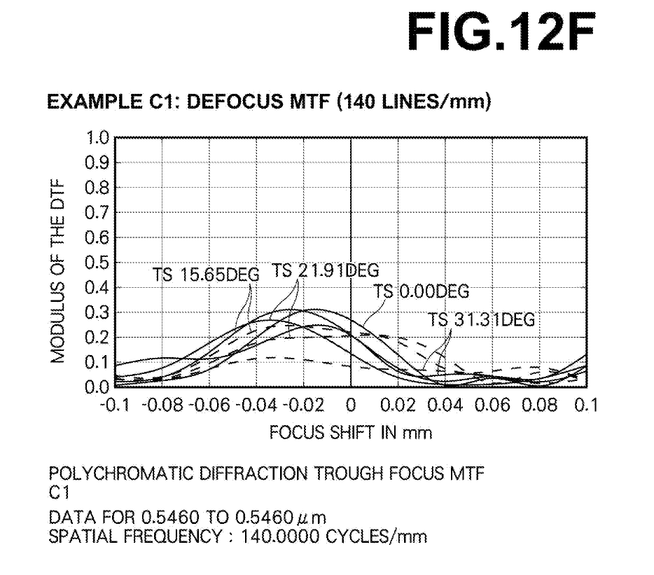

FIGS. 12A through 12F, and Tables 7A through 7C, which will be described later, show data related to an imaging lens with a phase correction plate mounted thereon according to Example C1.

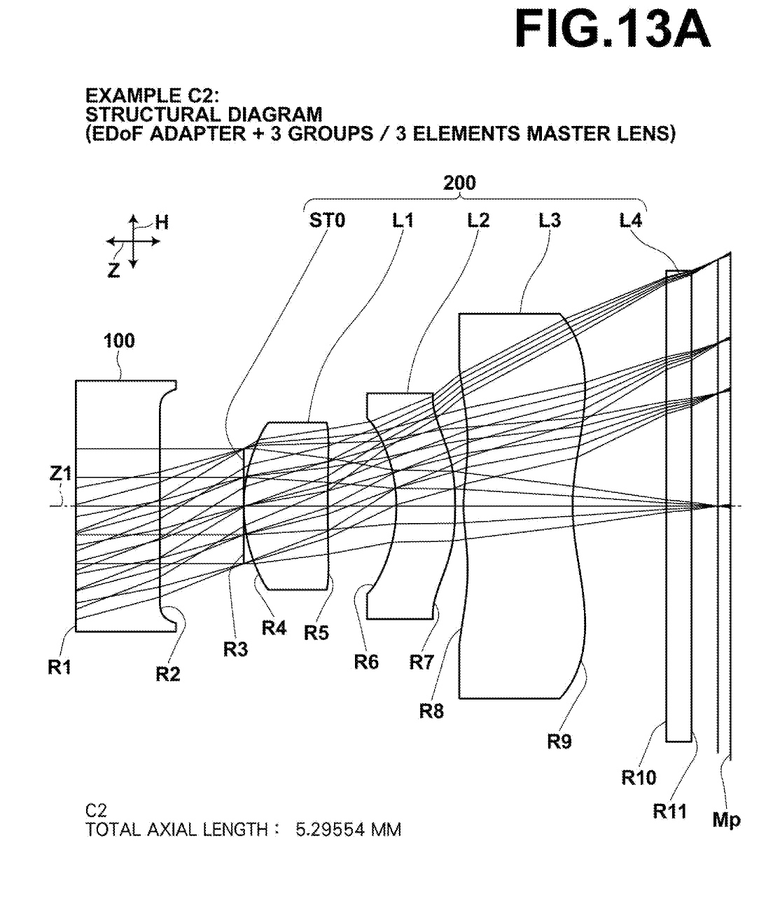

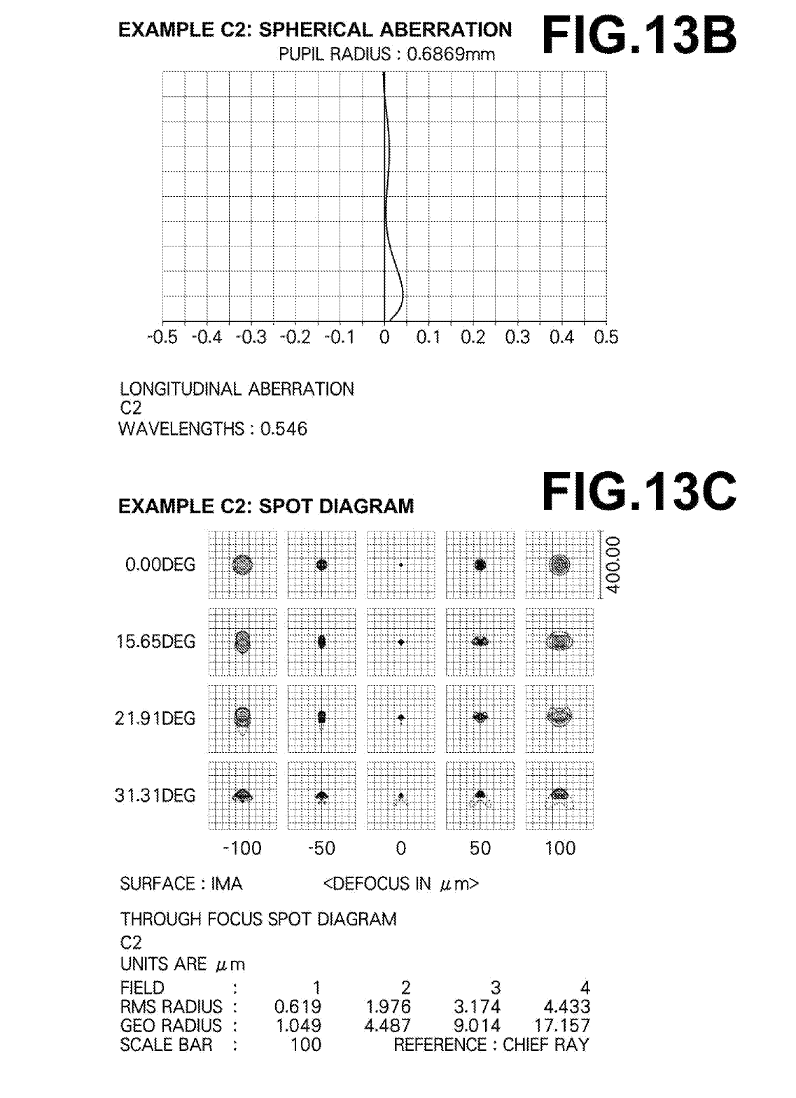

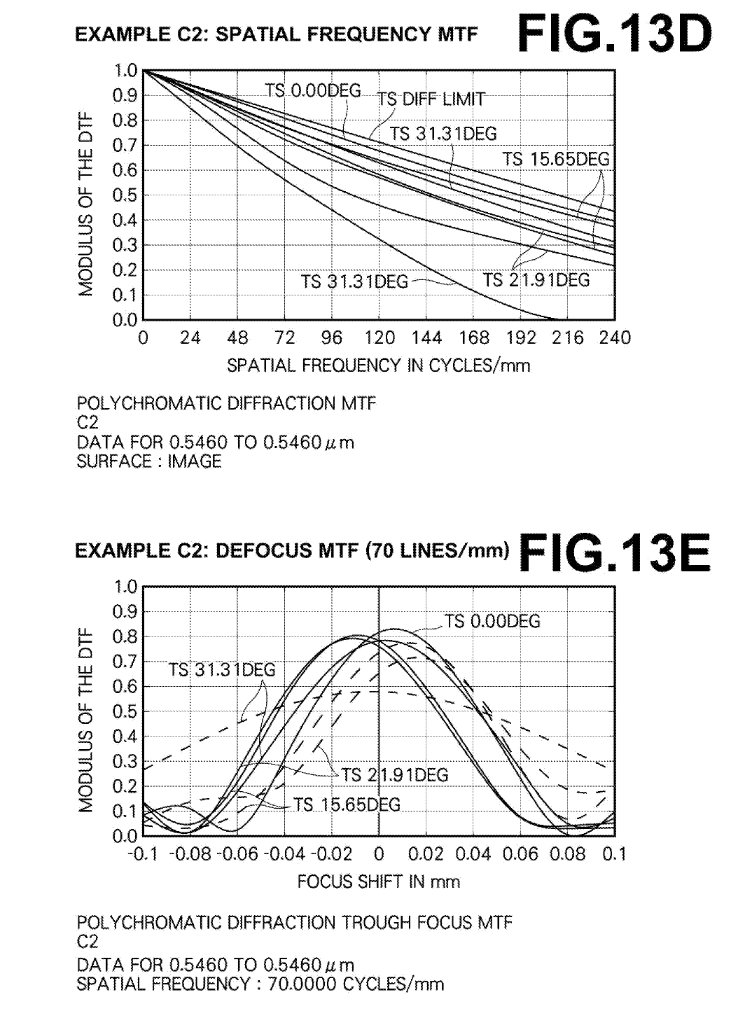

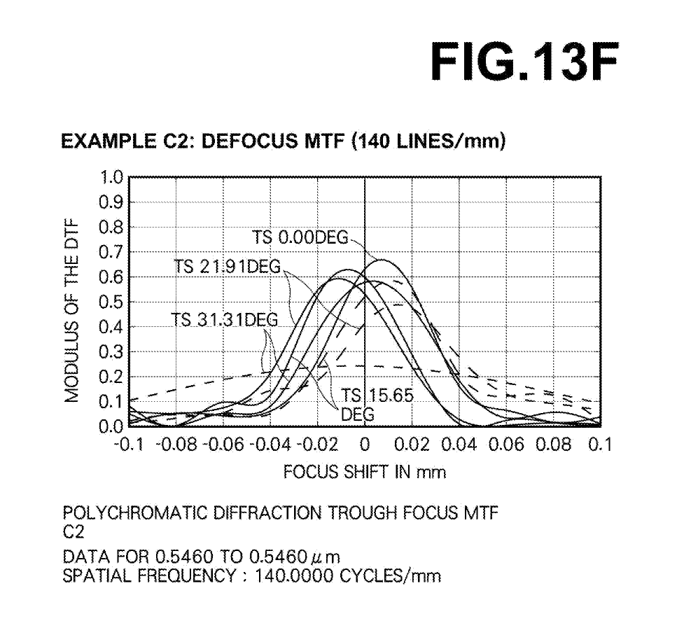

FIGS. 13A through 13F, and Tables 8A through 8C, which will be described later, show data related to an imaging lens with a phase correction plate mounted thereon according to Example C2.

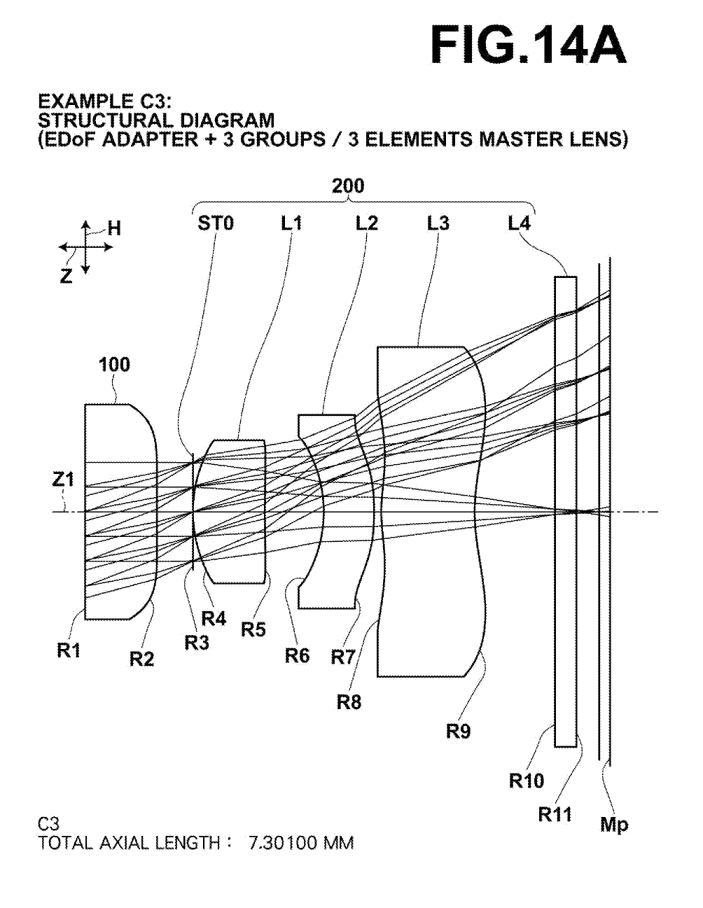

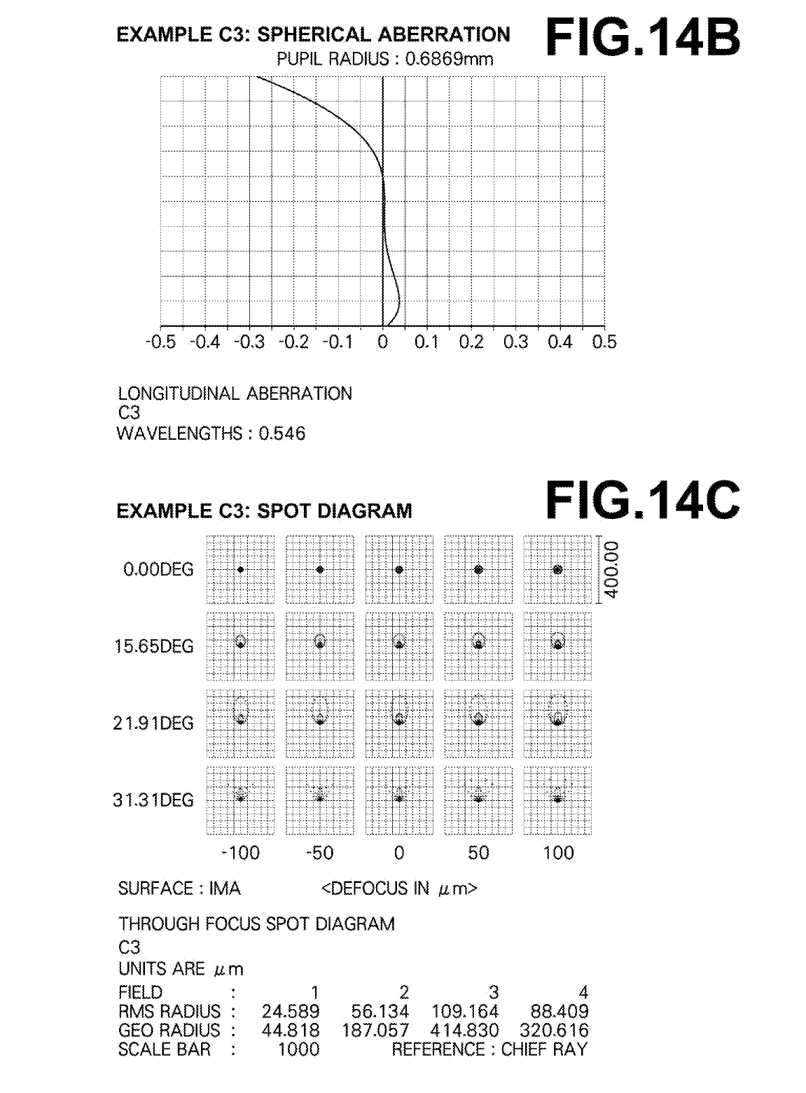

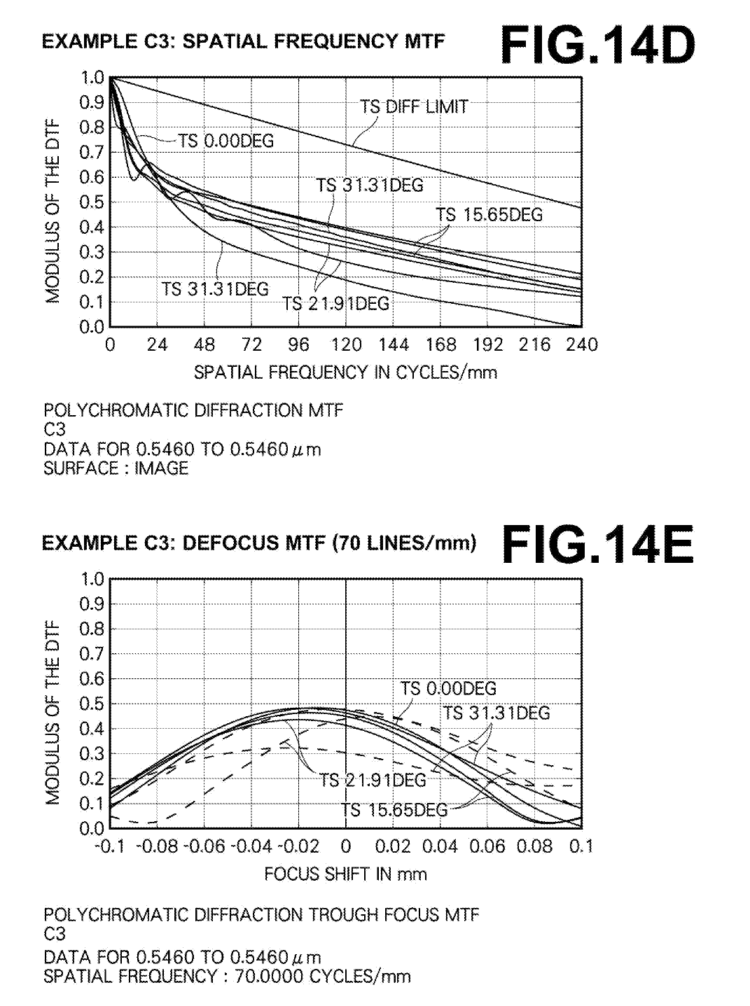

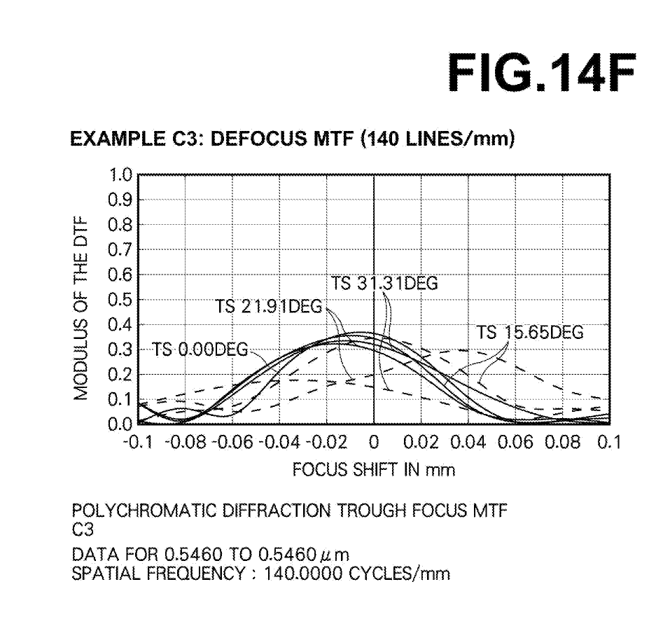

FIGS. 14A through 14F, and Tables 9A through 9C, which will be described later, show data related to an imaging lens with a phase correction plate mounted thereon according to Example C3.

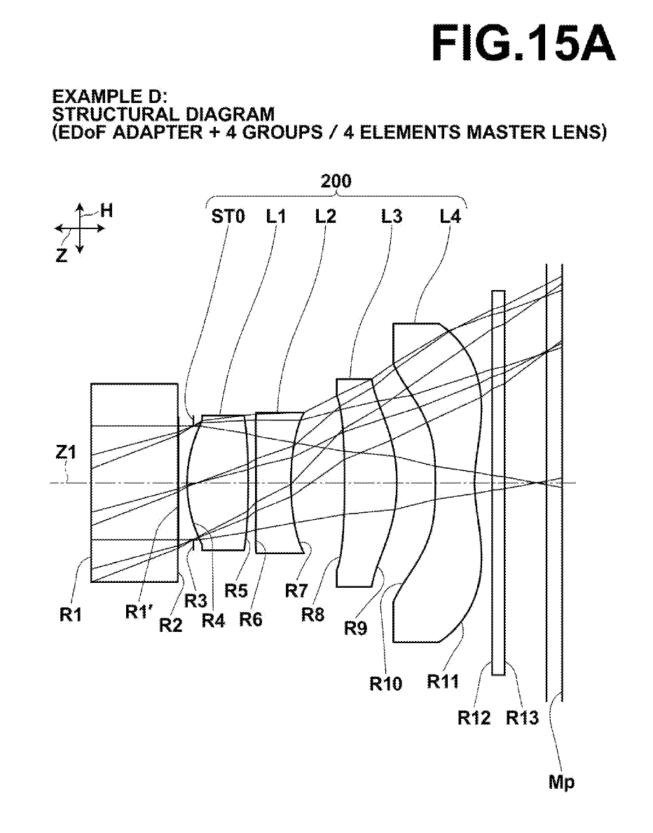

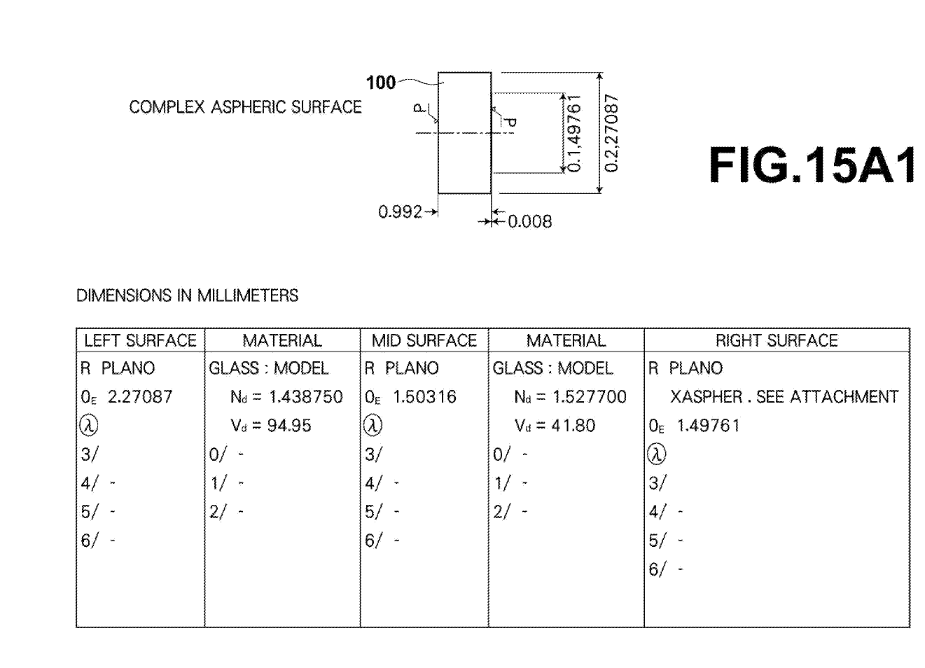

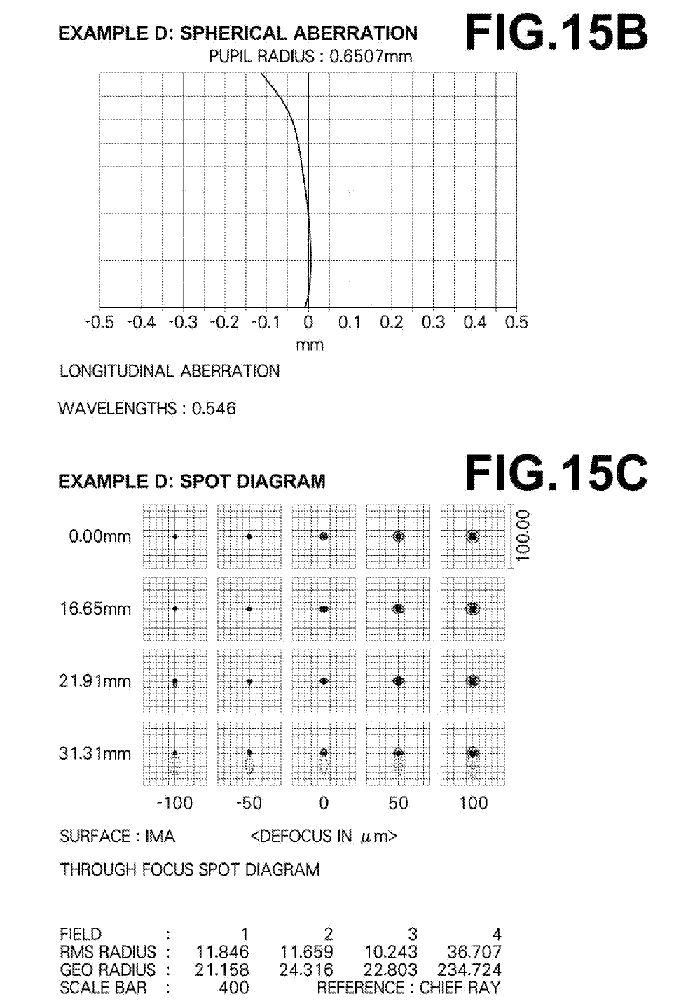

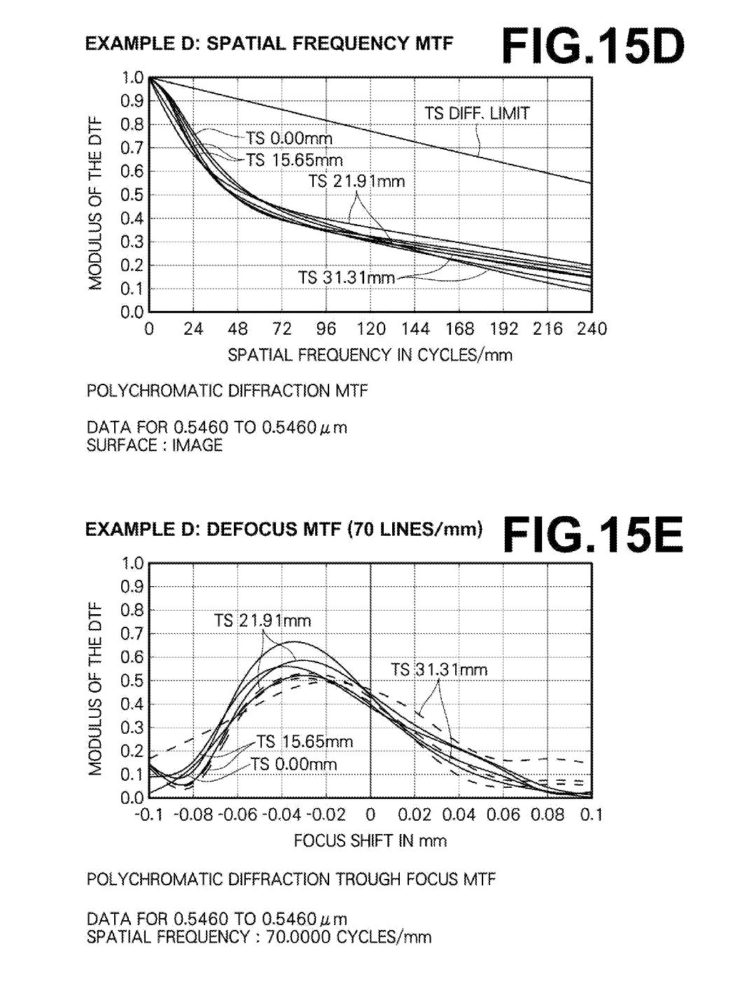

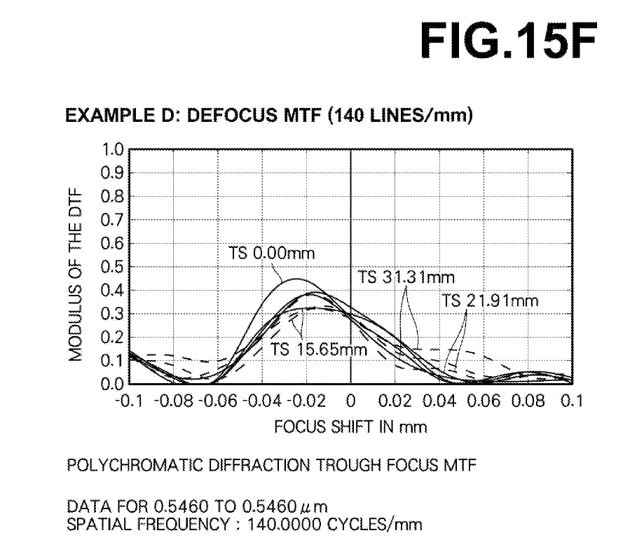

FIGS. 15A, 15A1, 15B, 15C, 15D, 15E and 15F, and Tables 10A through 10C, which will be described later, show data related to an imaging lens with a phase correction plate mounted thereon according to Example D.

The phase correction plate of Example D is a complex body including a phase correction portion and a base portion deposited one on the other in the direction of an optical axis. The phase correction portion and the base portion are formed by members that have different optical properties from each other.

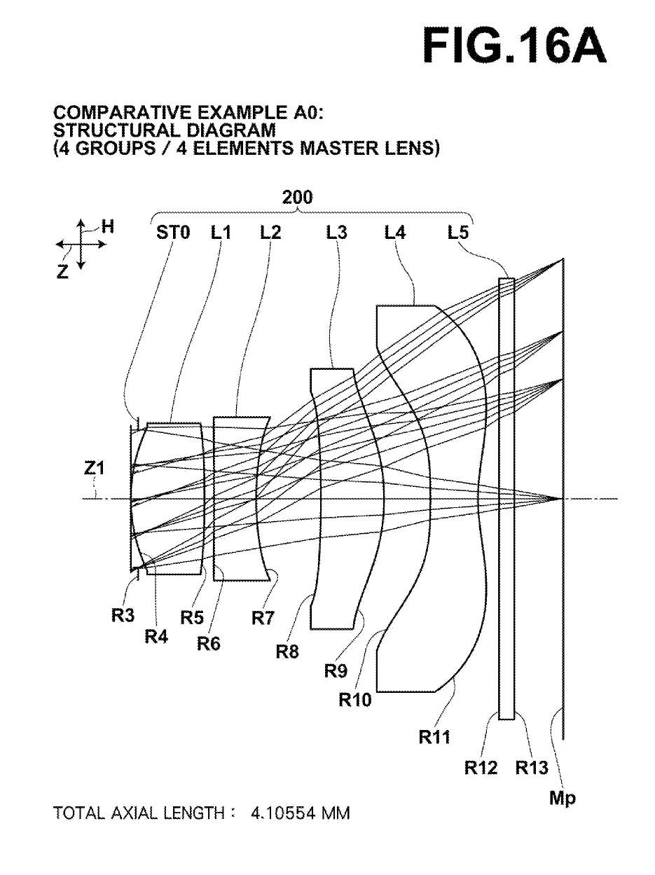

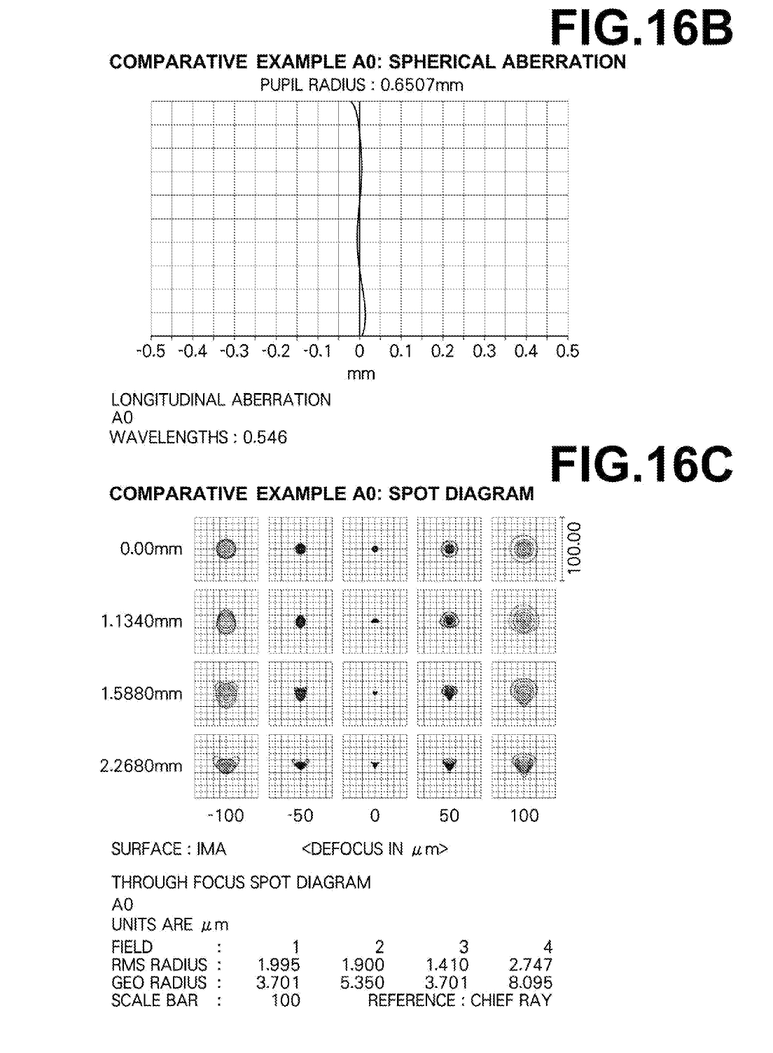

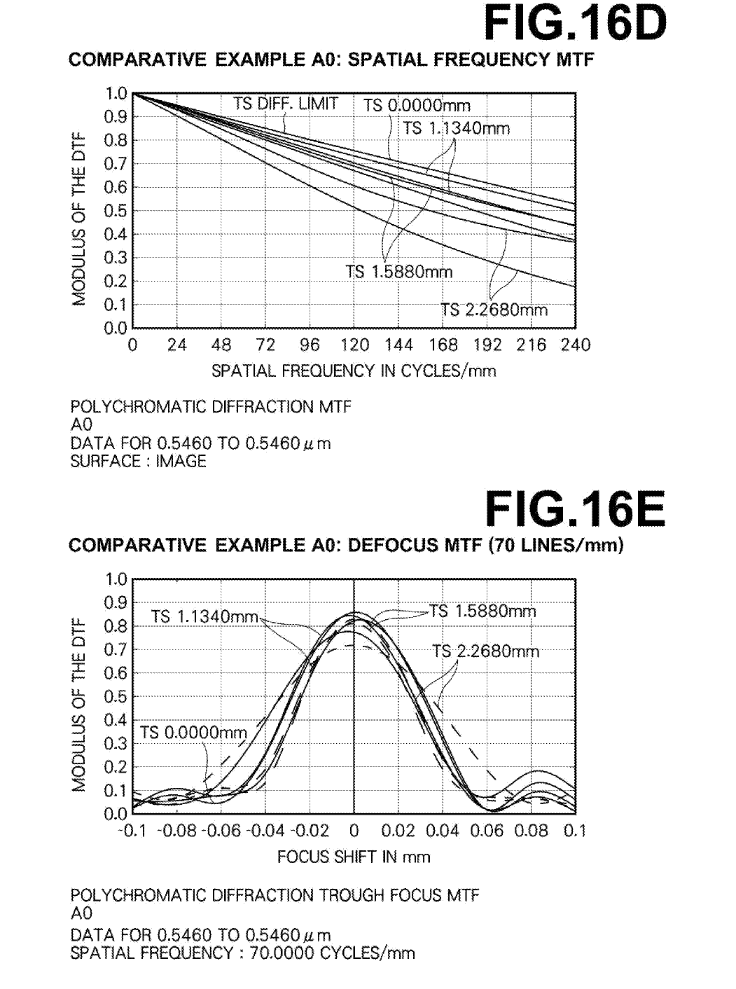

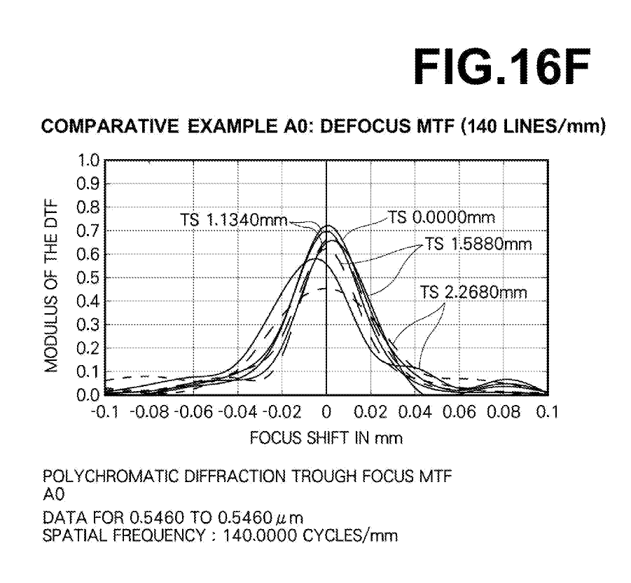

FIGS. 16A through 16F, and Tables 11A through 11C, which will be described later, show data related to an imaging lens (an imaging lens alone without a phase correction plate mounted thereon) according to Comparative Example A0. In Comparative Example A0, the phase correction plate is removed from the imaging lens with the phase correction plate mounted thereon according to Examples A1 through A4.

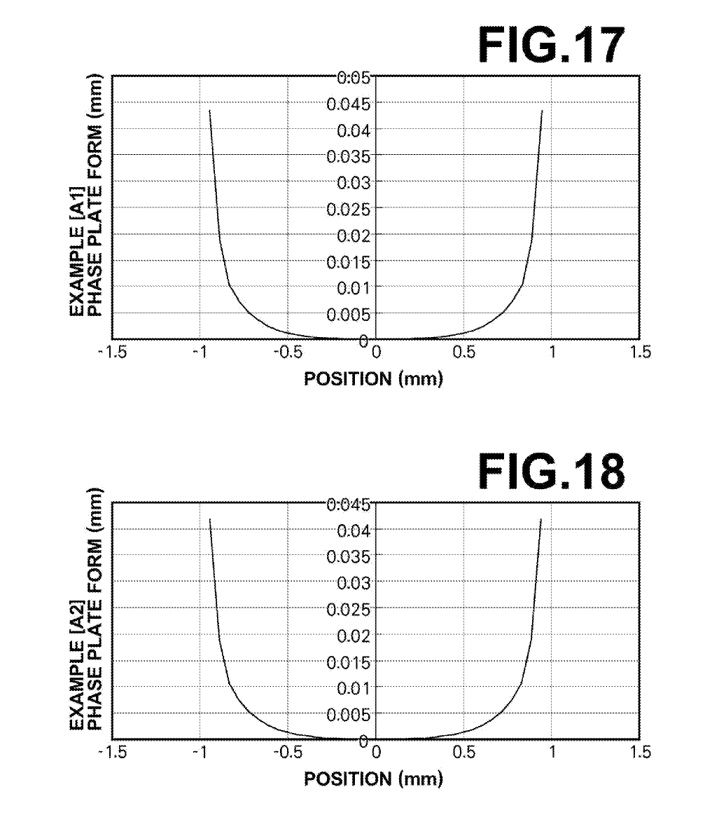

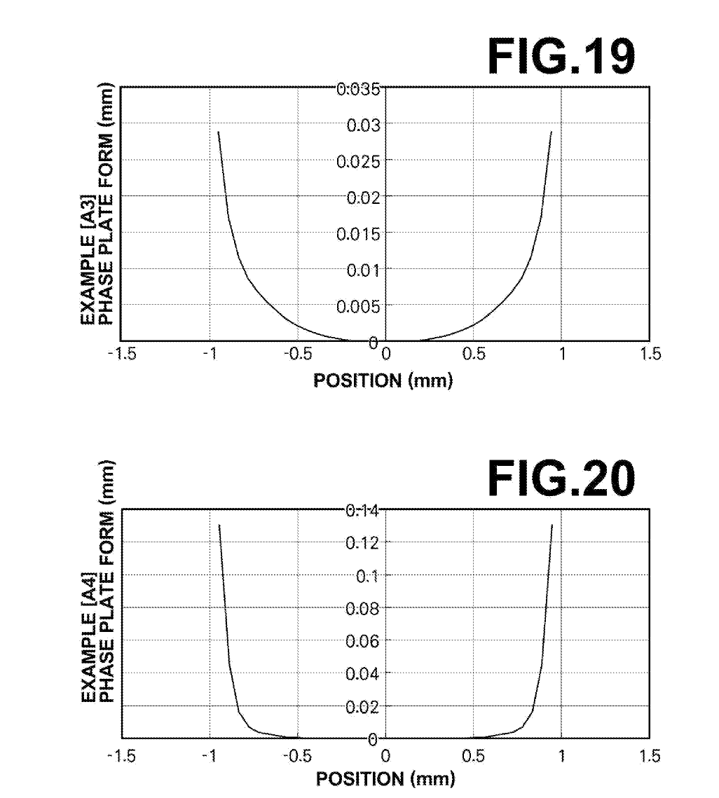

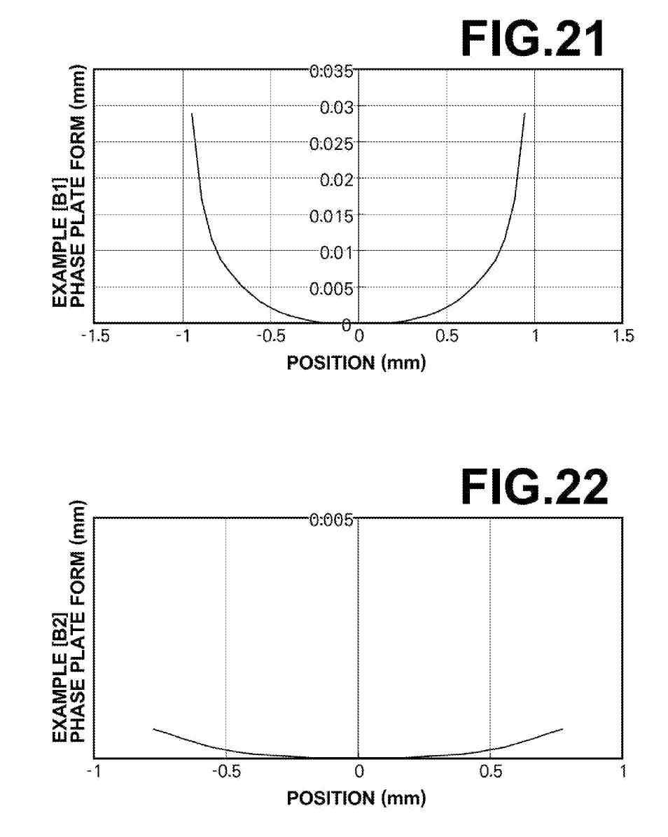

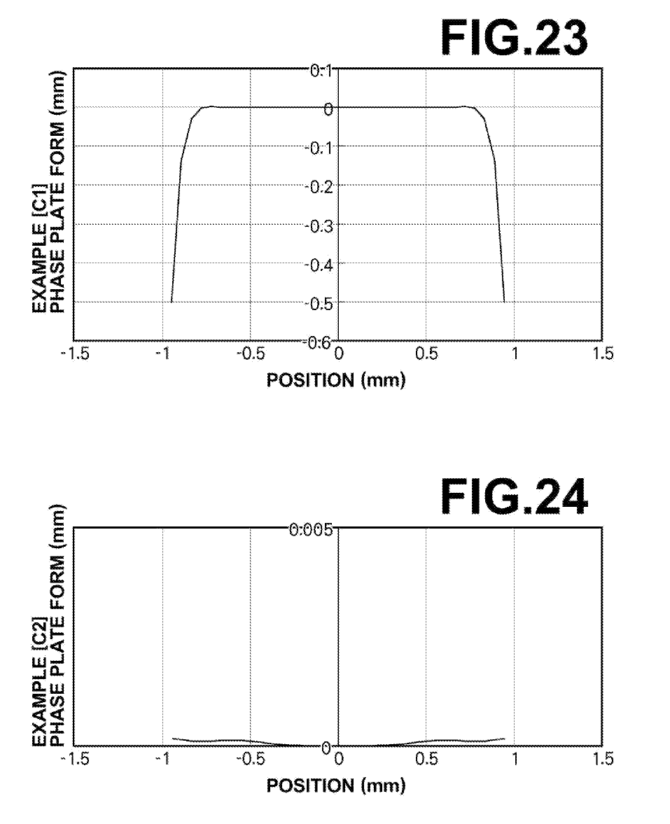

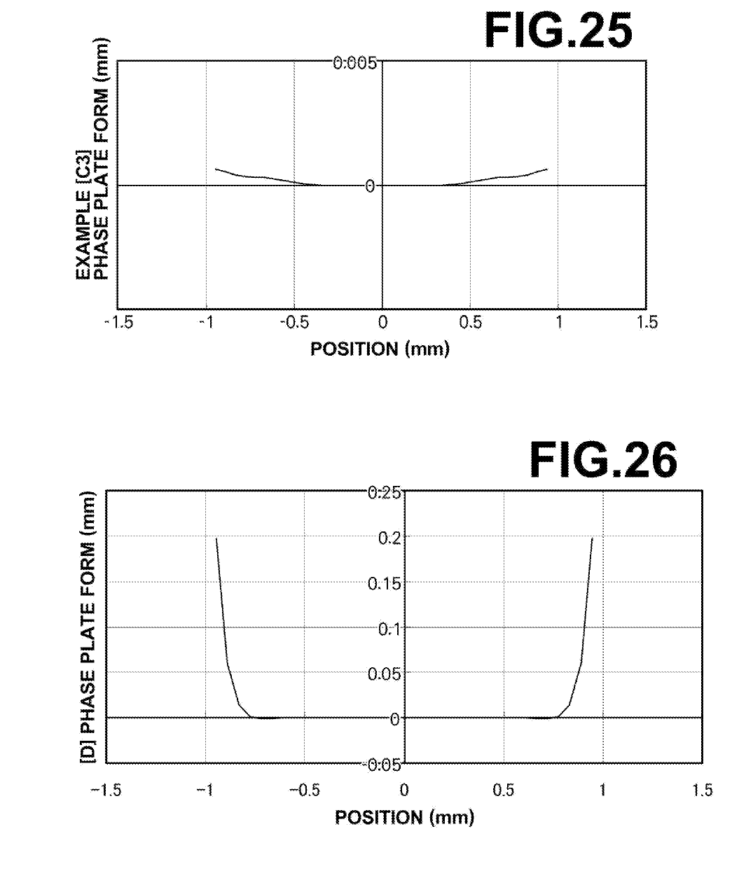

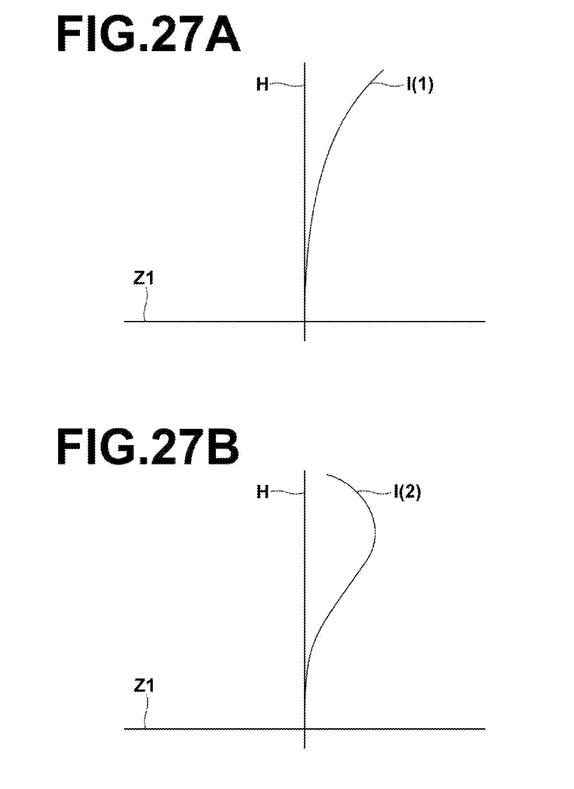

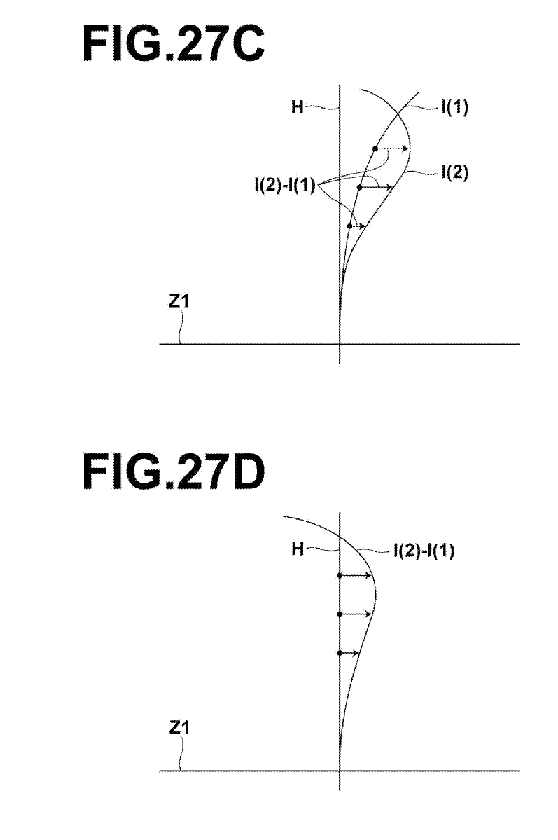

FIGS. 17 through 26 are diagrams illustrating the form (aspheric form) of image-side lens surfaces of the phase correction plates used in Examples A1 through A4, B1, B2, C1 through C3 and D, respectively. In FIGS. 17 through 26, the vertical axis represents positions in the direction of the optical axis Z1, and the horizontal axis represents positions in direction H, which is perpendicular to the optical axis Z1.

Table 12 summarizes data related to imaging lenses with the phase correction plates mounted thereon according to Examples A1 through A4, B1, B2, C1 through C3 and D, and imaging lenses alone without the phase correction plates mounted thereon according to Comparative Examples A0, B0, and C0. In Comparative Example B0, the phase correction plate is removed from the imaging lens with the phase correction plate mounted thereon according to Example B1. In Comparative Example C0, the phase correction plate is removed from the imaging lens with the phase correction plate mounted thereon according to Example C1.

Table 13 shows the aspheric surface coefficients of image-side lens surfaces of the phase correction plates used in Examples A1 through A4, B1, B2, C1 through C3, and D. The aspheric surface coefficients of image-side lens surfaces of the phase correction plates, shown in Table 13, may be read from Tables 1B, 2B, 3B, 4B, 5B, 6B, 7B, 8B, 9B and 10B, respectively.

Tables 14 through 23 show coordinate values representing positions on the image-side lens surfaces of the phase correction plates used in Examples A1 through A4, B1, B2, C1 through C3 and D, respectively. Each position on the lens surfaces are represented by a coordinate of the horizontal axis representing a position in the direction of the optical axis Z1 and by a coordinate of the vertical axis representing a position in direction H, which is perpendicular to the optical axis Z1.

FIGS. 6A, 7A, 8A, 9A, 10A, 11A, 12A, 13A, 14A, 15A, and 16A are schematic cross-sectional diagrams illustrating the structure of the imaging lenses with the phase correction plates mounted thereon of Examples A1 through A4, B1, B2, C1 through C3 and D and the imaging lens of Comparative Example A0, respectively. In FIGS. 6A, 7A, 8A, 9A, 10A, 11A, 12A, 13A, 14A, 15A, and 16A, the same signs as those of FIG. 1 are used for elements corresponding to those illustrated in FIG. 1. In each of FIGS. 6A, 7A, 8A, 9A, 10A, 11A, 12A, 13A, 14A, 15A, and 16A, paths (loci) of light that enters the imaging plane at four different incident angles (image height), which will be described later, are illustrated.

In FIGS. 6A, 7A, 8A, 9A, 10A, 11A, 12A, 13A, 14A, 15A, and 16A, signs R1, R2, . . . indicate the following composition elements. R1 is an object-side lens surface of the phase correction plate, and R2 is an image-side lens surface of the phase correction plate. R3 is the position of aperture diaphragm ST0. R4 is an object-side lens surface of first lens L1, and R5 is an image-side lens surface of the first lens L1. R6 is an object-side lens surface of second lens L2, and R7 is an image-side lens surface of the second lens L2. R8 is an object-side lens surface of third lens L3, and R9 is an image-side lens surface of the third lens L3. R10 is an object-side lens surface of fourth lens L4, and R11 is an image-side lens surface of the fourth lens L4. R12 is an object-side lens surface of fifth lens L5, which is a cover glass (Cov), and R13 is an image-side lens surface of the fifth lens L5. R14 is the imaging plane Mp.

In the imaging lens with the phase correction plate mounted thereon of Example D, illustrated in FIG. 15A, R1′ is a junction plane of the phase correction plate, at which different members are deposited one on the other.

In lens data shown in Tables 1A, 2A, 3A, 4A, 5A, 6A, 7A, 8A, 9A, 10A and 11A, the surface numbers (i-th (i=1, (1′), 2, 3, . . . ) of optical elements, such as lenses, sequentially increase from the object side toward the image side. The lens data include the surface number (i=3) of the aperture diaphragm ST0, the surface number of an object-side surface of the cover glass (Cov), which is a parallel flat plate, the surface number of an image-side surface of the cover glass (Cov), the surface number of the imaging plane (Mp), and the like. Further, OBJ represents a subject.

In each of Tables 1A, 2A, 3A, 4A, 5A, 6A, 7A, 8A, 9A, 10A and 11A, Ri represents the paraxial radius of curvature of the i-th surface. Di represents a distance between the i-th surface and the (i+1)th surface on the optical axis Z1. Further, Ri in the lens data corresponds to Ri in FIG. 1, which represents the lens surface.

Further, in Tables 1A, 2A, 3A, 4A, 5A, 6A, 7A, 8A, 9A, 10A and 11A, Ndj represents the refractive index of the j-th optical element with respect to d line (wavelength is 587.6 nm). The value of j sequentially increases from the object side toward the image side. Further, γdj represents the Abbe number of the j-th optical element with respect to d line.

Further, in the imaging lenses with the phase correction plates mounted thereon of Examples A1 through A4, B1, B2, C1 through C3 and D and the imaging lens of Comparative Example A0, the design reference wavelengths are 546.1 nm.

In Tables 1A, 2A, 3A, 4A, 5A, 6A, 7A, 8A, 9A, 10A and 11A, φ represents a diameter.

The paraxial radius of curvature, the distance between the surfaces and the diameter are represented by millimeter (mm). Further, the paraxial radius of curvature is referred to be positive when the surface projects toward the object side. The paraxial radius of curvature is referred to be negative when the surface projects toward the image side.

Here, each aspheric surface is represented by the following formula representing an aspheric surface:

$$Z = \frac{{ch}^{2}}{1 + \sqrt{1 - ( 1 + K ) {c}^{2} {h}^{2}}} + {α}_{3} {h}^{3} + {α}_{4} {h}^{4} + {α}_{5} {h}^{5} + {α}_{6} {h}^{6} + {α}_{7} {h}^{7} + {α}_{8} {h}^{8} + {α}_{9} {h}^{9} + {α}_{10} {h}^{10} + {α}_{11} {h}^{11} + {α}_{12} {h}^{12} + {α}_{13} {h}^{13} + {α}_{14} {h}^{14} + {α}_{15} {h}^{15} + {α}_{16} {h}^{16} , \qquad [ Formula 1 ]$$

where hⁿ=(\sqrt{x²+y²}ⁿ), and c is curvature, and K is conic constant.

Tables 1B through 11B show values of coefficients K, α₃, α₄, α₅, . . . in the formula representing each aspheric surface Ri.

Tables 1C, 2C, 3C, 4C, 5C, 6C, 7C, 8C, 9C, 10C and 11C show specification with the following values:

design reference wavelength, focal length, F-number (Fno), and incident angle of light that enters the imaging plane, the light having four kinds of image height illustrated in each of FIGS. 6A, 7A, . . . 16A, 6C, 7C, . . . 16C, 6D, 7D, . . . 16D, 6E, 7E, . . . 16E, 6F, 7F, . . . 16F.

FIGS. 6B, 7B, . . . 16B illustrate spherical aberrations of the imaging lenses with the phase correction plates mounted thereon of Examples A1 through A4, B1, B2, C1 through C3 and D and the imaging lens of Comparative Example A0, respectively.

FIGS. 6C, 7C, . . . 16C illustrate a change of each spot imaged at each position on the imaging plane by light that has passed through the imaging lens with the phase correction plate mounted thereon of Examples A1 through A4, B1, B2, C1 through C3 and D and the imaging lens of Comparative Example A0, respectively, during defocusing (each spot is formed by light that enters the imaging plane at four different incident angles (image heights) as described above). As the defocus amount, the form of the spot (condensed light spot) imaged on the imaging plane when the imaging plane is moved in parallel along the optical axis Z1 to each position of −100 μm, −50 μm, ±0 μm, +50 μm, +100 μm is illustrated.

FIGS. 6D, 7D, . . . 16D illustrate MTF characteristics of images formed on the imaging plane by light that enters the imaging plane at the four different incident angles (image heights), as described above. FIGS. 6D, 7D, . . . 16D illustrate MTF characteristics of images formed by light that has passed through the imaging lens with the phase correction plate mounted thereon of Examples A1 through A4, B1, B2, C1 through C3 and D and the imaging lens of Comparative Example A0, respectively.

FIGS. 6E, 7E, . . . 16E illustrate MTF characteristics of images formed on the imaging plane by light that enters the imaging plane at the four different incident angles (image heights), as described above. FIGS. 6E, 7E, . . . 16E illustrate changes in MTF characteristics of images formed by light that has passed through the imaging lens with the phase correction plate mounted thereon of Examples A1 through A4, B1, B2, C1 through C3 and D and the imaging lens of Comparative Example A0, respectively, during defocusing for 70 lines/mm.

FIGS. 6F, 7F, . . . 16F illustrate MTF characteristics of images formed on the imaging plane by light that enters the imaging plane at the four different incident angles (image heights), as described above. FIGS. 6F, 7F, . . . 16F illustrate changes in MTF characteristics of images formed by light that has passed through the imaging lens with the phase correction plate mounted thereon of Examples A1 through A4, B1, B2, C1 through C3 and D and the imaging lens of Comparative Example A0, respectively, during defocusing for 140 lines/mm.

When the imaging lens with the phase correction plate mounted thereon of Example A1 and the imaging lens of Comparative Example A0, in which the phase correction plate is removed from the imaging lens with the phase correction plate mounted thereon of Example A1, are compared with each other, the performance differs from each other as follows.

With respect to the MTF characteristics for 140 lines/mm during defocusing, the peak value of MTF for the imaging lens with the phase correction plate mounted thereon of Example A1 greatly decreases compared with the peak value of MTF for the imaging lens of Comparative Example A0. Further, substantially no defocusing range in which the imaging lens with the phase correction plate mounted thereon of Example A1 can achieve higher performance than the imaging lens without the phase correction plate mounted thereon of Comparative Example A0 is generated.

Further, with respect to the MTF characteristics for 70 lines/mm, the peak value of MTF for the imaging lens with the phase correction plate mounted thereon of Example A1 greatly decreases compared with the peak value of MTF for the imaging lens of Comparative Example A0 in a manner similar to the case of 140 lines/mm. However, the value of MTF of the imaging lens with the phase correction plate mounted thereon of Example A1 gradually decreases during defocusing, while the value of MTF of the imaging lens without the phase correction plated mounted thereon of Comparative Example A0 sharply decreases during defocusing

Therefore, in a defocus range that is not in the vicinity of a defocus range showing a peak MTF peak value, the performance (lens performance) of the imaging lens with the phase correction plate mounted thereon of Example A1 exceeds the performance (lens performance) of the imaging lens without the phase correction plate mounted thereon of Comparative Example A0 (the value of MTF is higher).

Specifically, when the value of MTF is not a peak value that indicates in-focus state, the imaging lens with the phase correction plate mounted thereon of Example A1 can achieve higher resolution than the imaging lens without the phase correction plate mounted thereon of Comparative Example A0.

Therefore, when low resolution is acceptable to the purpose of use of a lens, the imaging lens with the phase correction plate mounted thereon of Example A1 can obtain desirable resolution in a wider defocus range, compared with the imaging lens without the phase correction plate mounted thereon of Comparative Example A0. Specifically, when an imaging lens may be used at low resolution, if a phase correction plate is mounted on a conventional imaging lens, the depth of field of the imaging lens can be increased without sacrificing the brightness of the imaging lens and resolution.

With respect to the MTF characteristics of the imaging lens with the phase correction plate mounted thereon for 70 lines/mm, MTF characteristic curves during defocusing are illustrated for images that are formed on the imaging plane by light that enters the imaging plane at four different incident angles. When a defocus position at which the MTF characteristic curve shows the maximum value and a defocus position at which the MTF characteristic curve shows the minimum value are the same for four kinds of MTF characteristic curves, the depth of field of the imaging lens can be greatly increased without sacrificing the resolution and the brightness of the imaging lens.

Further, when a distance between a defocus position at which the MTF characteristic curve shows the maximum value and a defocus position at which the MTF characteristic curve shows the minimum value is longer, in other words, when the MTF values gradually decrease during defocusing, the depth of field of the imaging lens can be even more greatly increased without sacrificing the resolution and the brightness of the imaging lens.

Further, an imaging system including an imaging unit for forming an optical image of a subject projected through an imaging lens with the phase correction plate mounted thereon and a signal processing means may be provided. The signal processing means performs restoration processing on image data representing the subject, which is obtained by the imaging unit.

Further, the present invention is not limited to the embodiments of the present invention and the examples as described above. Various modifications may be made without departing from the scope of the present invention.

TABLE 1A
EXAMPLE A1: LENS DATA

| SURFACE | | | | | |
|---|---|---|---|---|---|
| NUMBER | Ri | Di | Ndj | νd j | φ |
| OBJ | Infinity | Infinity | | | |
| 1 | Infinity | 1.000000 | 1.438750 | 94.95 | 2.271 |
| 2 | Infinity | 0.170000 | | | 1.493 |
| 3(STO) | Infinity | −0.070000 | | | 1.301 |
| 4 | 1.496937 | 0.699316 | 1.533914 | 59.00 | 1.429 |
| 5 | −11.058800 | 0.090334 | | | 1.549 |
| 6 | −3410.537000 | 0.400974 | 1.605957 | 26.90 | 1.582 |
| 7 | 2.944400 | 0.614091 | | | 1.620 |
| 8 | −14.563680 | 0.600311 | 1.533914 | 59.00 | 2.009 |
| 9 | −2.248293 | 0.439934 | | | 2.405 |
| 10 | −7936.115000 | 0.451007 | 1.533914 | 59.00 | 2.765 |
| 11 | 1.499692 | 0.200000 | | | 3.650 |
| 12(Cov) | Infinity | 0.145000 | 1.516330 | 64.14 | 4.400 |
| 13(Cov) | Infinity | 0.554574 | | | 4.400 |
| 14(Mp) | Infinity | | | | 4.468 |

REFRACTIVE INDEX AND ABBE NUMBER OF GLASS MATERIAL WITH RESPECT TO d-LINE

TABLE 1B
EXAMPLE A1: ASPHERIC SURFACE COEFFICIENT

| | |
|---|---|
| ASPHERIC | |
| SURFACE | SURFACE NUMBER |

| COEFFICIENT | 2 | 4 | 5 | 6 |
|---|---|---|---|---|
| K | 0 | −0.519140 | −100.000000 | −50.045820 |
| α3 | | −1.647619E−02 | 9.045281E−04 | −1.584768E−02 |
| α4 | 5.570368E−02 | 9.306103E−02 | −7.247797E−02 | 1.480497E−02 |
| α5 | | −1.463554E−01 | 5.011248E−02 | −8.051709E−02 |
| α6 | −3.702961E−01 | −1.189368E−01 | −7.513890E−02 | 2.642048E−01 |
| α7 | | 4.932119E−01 | 8.711940E−02 | −4.778490E−01 |
| α8 | 1.284178E+00 | −4.411616E−01 | −4.044638E−01 | −1.755639E−01 |
| α9 | | 1.384831E−01 | 6.077719E−01 | 1.290701E+00 |
| α10 | −1.970307E+00 | 1.559769E−01 | −3.280371E−01 | −7.594194E−01 |
| α11 | | −6.430340E−02 | 6.560197E−03 | |
| α12 | 1.376747E+00 | −2.295471E−01 | 1.086920E−01 | |
| α13 | | −3.678251E−01 | 2.230539E−01 | |
| α14 | −5.516867E−01 | −3.494506E−01 | 2.612986E−01 | |
| α15 | | 1.047597E−01 | 4.849794E−02 | |
| α16 | 2.896874E−01 | 1.407367E+00 | −7.288709E−01 | |

| ASPHERIC | | | | | |
|---|---|---|---|---|---|
| SURFACE | SURFACE NUMBER | | | | |
| COEFFICIENT | 7 | 8 | 9 | 10 | 11 |
| K | −3.832904 | −11.001000 | −89.176030 | −100.000000 | −13.031300 |
| α3 | 3.210471E−02 | −7.254753E−03 | −3.394850E−01 | −2.717552E−01 | −1.083800E−01 |
| α4 | −1.218261E−01 | −1.031881E−01 | 5.727648E−02 | −5.907275E−02 | 8.727701E−04 |
| α5 | 5.003462E−01 | 1.020778E−01 | 2.179903E−01 | −2.166835E−02 | −4.706439E−02 |
| α6 | −4.585604E−01 | 1.885665E−01 | −8.254569E−02 | 6.112189E−02 | 8.521842E−02 |
| α7 | −1.771676E−01 | −3.439371E−01 | −5.828771E−02 | 4.698633E−02 | −6.322718E−02 |
| α8 | 2.802425E−01 | −5.983698E−02 | 2.714480E−02 | −1.365640E−02 | 9.844054E−03 |
| α9 | 4.844266E−01 | 3.445256E−01 | 4.947630E−02 | −8.582814E−03 | 9.216297E−03 |
| α10 | −3.832647E−01 | −1.773895E−01 | −2.849486E−02 | 5.812724E−04 | −3.390525E−03 |

TABLE 1C
EXAMPLE A1: SCHEMATIC SPECIFICATION OF
IMAGING LENS WITH LENS ADAPTER

| DESIGN REFERENCE WAVELENGTH | 546.1 nm |
|---|---|
| FOCAL LENGTH | 3.73139 |
| Fno | 2.867 |

| IMAGE HEIGHT NUMBER | INCIDENT ANGLE deg |
|---|---|
| 1 | 0.000 |
| 2 | 15.653 |
| 3 | 21.914 |
| 4 | 31.306 |

TABLE 2A
EXAMPLE A2: LENS DATA

| SURFACE | | | | | |
|---|---|---|---|---|---|
| NUMBER | Ri | Di | Ndj | νdj | φ |
| OBJ | Infinity | Infinity | | | |
| 1 | Infinity | 1.000000 | 1.438750 | 94.95 | 2.200 |
| 2 | Infinity | 0.570000 | | | 2.200 |
| 3(STO) | Infinity | −0.070000 | | | 1.301 |
| 4 | 1.496937 | 0.699316 | 1.533914 | 59.00 | 1.427 |
| 5 | −11.058800 | 0.090334 | | | 1.546 |
| 6 | −3410.537000 | 0.400974 | 1.605957 | 26.90 | 1.578 |
| 7 | 2.944400 | 0.614091 | | | 1.615 |
| 8 | −14.563680 | 0.600311 | 1.533914 | 59.00 | 2.001 |
| 9 | −2.248293 | 0.439934 | | | 2.391 |
| 10 | −7936.115000 | 0.451007 | 1.533914 | 59.00 | 2.743 |
| 11 | 1.499692 | 0.200000 | | | 3.650 |
| 12(Cov) | Infinity | 0.145000 | 1.516330 | 64.14 | 4.400 |
| 13(Cov) | Infinity | 0.554574 | | | 4.400 |
| 14(Mp) | Infinity | | | | 4.362 |

REFRACTIVE INDEX AND ABBE NUMBER OF GLASS MATERIAL WITH RESPECT TO d-LINE

TABLE 2B
EXAMPLE A2: ASPHERIC SURFACE COEFFICIENT

| | |
|---|---|
| ASPHERIC | |
| SURFACE | SURFACE NUMBER |

| COEFFICIENT | 2 | 4 | 5 | 6 |
|---|---|---|---|---|
| K | 0 | −0.519140 | −100.000000 | −50.045820 |
| α3 | | −1.647619E−02 | 9.045281E−04 | −1.584768E−02 |
| α4 | 6.007156E−02 | 9.306103E−02 | −7.247797E−02 | 1.480497E−02 |
| α5 | | −1.463554E−01 | 5.011248E−02 | −8.051709E−02 |
| α6 | −3.766660E−01 | −1.189368E−01 | −7.513890E−02 | 2.642048E−01 |
| α7 | | 4.932119E−01 | 8.711940E−02 | −4.778490E−01 |
| α8 | 1.274318E+00 | −4.411616E−01 | −4.044638E−01 | −1.755639E−01 |
| α9 | | 1.384831E−01 | 6.077719E−01 | 1.290701E+00 |
| α10 | −1.966386E+00 | 1.559769E−01 | −3.280371E−01 | −7.594194E−01 |
| α11 | | −6.430340E−02 | 6.560197E−03 | |
| α12 | 1.405545E+00 | −2.295471E−01 | 1.086920E−01 | |
| α13 | | −3.678251E−01 | 2.230539E−01 | |
| α14 | −5.380957E−01 | −3.494506E−01 | 2.612986E−01 | |
| α15 | | 1.047597E−01 | 4.849794E−02 | |
| α16 | 2.466675E−01 | 1.407367E+00 | −7.288709E−01 | |

| ASPHERIC | | | | | |
|---|---|---|---|---|---|
| SURFACE | SURFACE NUMBER | | | | |
| COEFFICIENT | 7 | 8 | 9 | 10 | 11 |
| K | −3.832904 | −11.001000 | −89.176030 | −100.000000 | −1.303130E+01 |
| α3 | 3.210471E−02 | −7.254753E−03 | −3.394850E−01 | −2.717552E−01 | −1.083800E−01 |
| α4 | −1.218261E−01 | −1.031881E−01 | 5.727648E−02 | −5.907275E−02 | 8.727701E−04 |
| α5 | 5.003462E−01 | 1.020778E−01 | 2.179903E−01 | −2.166835E−02 | −4.706439E−02 |
| α6 | −4.585604E−01 | 1.885665E−01 | −8.254569E−02 | 6.112189E−02 | 8.521842E−02 |
| α7 | −1.771676E−01 | −3.439371E−01 | −5.828771E−02 | 4.698633E−02 | −6.322718E−02 |
| α8 | 2.802425E−01 | −5.983698E−02 | 2.714480E−02 | −1.365640E−02 | 9.844054E−03 |
| α9 | 4.844266E−01 | 3.445256E−01 | 4.947630E−02 | −8.582814E−03 | 9.216297E−03 |
| α10 | −3.832647E−01 | −1.773895E−01 | −2.849486E−02 | 5.812724E−04 | −3.390525E−03 |

TABLE 2C
EXAMPLE A2: SCHEMATIC SPECIFICATION OF
IMAGING LENS WITH LENS ADAPTER

| DESIGN REFERENCE WAVELENGTH | 546.1 nm |
|---|---|
| FOCAL LENGTH | 3.73139 |
| Fno | 2.867 |

| IMAGE HEIGHT NUMBER | INCIDENT ANGLE deg |
|---|---|
| 1 | 0.000 |
| 2 | 15.653 |
| 3 | 21.914 |
| 4 | 31.306 |

TABLE 3A
EXAMPLE A3: LENS DATA

| SURFACE | | | | | |
|---|---|---|---|---|---|
| NUMBER | Ri | Di | Ndj | νdj | φ |
| OBJ | Infinity | Infinity | | | |
| 1 | Infinity | 2.000000 | 1.438750 | 94.95 | 3.400 |
| 2 | Infinity | 0.570000 | | | 2.400 |
| 3(STO) | Infinity | −0.070000 | | | 1.301 |
| 4 | 1.496937 | 0.699316 | 1.533914 | 59.00 | 1.428 |
| 5 | −11.058800 | 0.090334 | | | 1.547 |
| 6 | −3410.537000 | 0.400974 | 1.605957 | 26.90 | 1.579 |
| 7 | 2.944400 | 0.614091 | | | 1.617 |
| 8 | −14.563680 | 0.600311 | 1.533914 | 59.00 | 2.003 |
| 9 | −2.248293 | 0.439934 | | | 2.394 |
| 10 | −7936.115000 | 0.451007 | 1.533914 | 59.00 | 2.749 |
| 11 | 1.499692 | 0.200000 | | | 3.650 |
| 12(Cov) | Infinity | 0.145000 | 1.516330 | 64.14 | 4.400 |
| 13(Cov) | Infinity | 0.584574 | | | 4.400 |
| 14(Mp) | Infinity | | | | 4.392 |

REFRACTIVE INDEX AND ABBE NUMBER OF GLASS MATERIAL WITH RESPECT TO d-LINE

TABLE 3B
EXAMPLE A3: ASPHERIC SURFACE COEFFICIENT

| | |
|---|---|
| ASPHERIC | |
| SURFACE | SURFACE NUMBER |

| COEFFICIENT | 2 | 4 | 5 | 6 |
|---|---|---|---|---|
| K | 0 | −0.519140 | −100.000000 | −50.045820 |
| α3 | | −1.647619E−02 | 9.045281E−04 | −1.584768E−02 |
| α4 | 8.385691E−02 | 9.306103E−02 | −7.247797E−02 | 1.480497E−02 |
| α5 | | −1.463554E−01 | 5.011248E−02 | −8.051709E−02 |
| α6 | −4.019017E−01 | −1.189368E−01 | −7.513890E−02 | 2.642048E−01 |
| α7 | | 4.932119E−01 | 8.711940E−02 | −4.778490E−01 |
| α8 | 1.223379E+00 | −4.411616E−01 | −4.044638E−01 | −1.755639E−01 |
| α9 | | 1.384831E−01 | 6.077719E−01 | 1.290701E+00 |
| α10 | −1.947172E+00 | 1.559769E−01 | −3.280371E−01 | −7.594194E−01 |
| α11 | | −6.430340E−02 | 6.560197E−03 | |
| α12 | 1.466689E+00 | −2.295471E−01 | 1.086920E−01 | |
| α13 | | −3.678251E−01 | 2.230539E−01 | |
| α14 | −3.700464E−01 | −3.494506E−01 | 2.612986E−01 | |
| α15 | | 1.047597E−01 | 4.849794E−02 | |
| α16 | | 1.407367E+00 | −7.288709E−01 | |

| ASPHERIC | | | | | |
|---|---|---|---|---|---|
| SURFACE | SURFACE NUMBER | | | | |
| COEFFICIENT | 7 | 8 | 9 | 10 | 11 |
| K | −3.832904 | −11.001000 | −89.176030 | −100.000000 | −13.031300 |
| α3 | 3.210471E−02 | −7.254753E−03 | −3.394850E−01 | −2.717552E−01 | −1.083800E−01 |
| α4 | −1.218261E−01 | −1.031881E−01 | 5.727648E−02 | −5.907275E−02 | 8.727701E−04 |
| α5 | 5.003462E−01 | 1.020778E−01 | 2.179903E−01 | −2.166835E−02 | −4.706439E−02 |
| α6 | −4.585604E−01 | 1.885665E−01 | −8.254569E−02 | 6.112189E−02 | 8.521842E−02 |
| α7 | −1.771676E−01 | −3.439371E−01 | −5.828771E−02 | 4.698633E−02 | −6.322718E−02 |
| α8 | 2.802425E−01 | −5.983698E−02 | 2.714480E−02 | −1.365640E−02 | 9.844054E−03 |
| α9 | 4.844266E−01 | 3.445256E−01 | 4.947630E−02 | −8.582814E−03 | 9.216297E−03 |
| α10 | −3.832647E−01 | −1.773895E−01 | −2.849486E−02 | 5.812724E−04 | −3.390525E−03 |

TABLE 3C
EXAMPLE A3: SCHEMATIC SPECIFICATION OF
IMAGING LENS WITH LENS ADAPTER

| DESIGN REFERENCE WAVELENGTH | 546.1 nm |
|---|---|
| FOCAL LENGTH | 3.73139 |
| Fno | 2.867 |

| IMAGE HEIGHT NUMBER | INCIDENT ANGLE deg |
|---|---|
| 1 | 0.000 |
| 2 | 15.653 |
| 3 | 21.914 |
| 4 | 31.306 |

TABLE 4A
EXAMPLE A4: LENS DATA

| SURFACE | | | | | |
|---|---|---|---|---|---|
| NUMBER | Ri | Di | Ndj | νdj | φ |
| OBJ | Infinity | Infinity | | | |
| 1 | Infinity | 1.000000 | 1.516800 | 64.16 | 2.220 |
| 2 | Infinity | 0.170000 | | | 1.493 |
| 3(STO) | Infinity | −0.070000 | | | 1.301 |
| 4 | 1.496937 | 0.699316 | 1.533914 | 59.00 | 1.429 |
| 5 | −11.058800 | 0.090334 | | | 1.549 |
| 6 | −3410.537000 | 0.400974 | 1.605957 | 26.90 | 1.582 |
| 7 | 2.944400 | 0.614091 | | | 1.620 |
| 8 | −14.563680 | 0.600311 | 1.533914 | 59.00 | 2.009 |
| 9 | −2.248293 | 0.439934 | | | 2.405 |
| 10 | −7936.115000 | 0.451007 | 1.533914 | 59.00 | 2.765 |
| 11 | 1.499692 | 0.200000 | | | 3.650 |
| 12(Cov) | Infinity | 0.145000 | 1.516330 | 64.14 | 4.400 |
| 13(Cov) | Infinity | 0.554574 | | | 4.400 |
| 14(Mp) | Infinity | | | | 4.468 |

REFRACTIVE INDEX AND ABBE NUMBER OF GLASS MATERIAL WITH RESPECT TO d-LINE

TABLE 4B
EXAMPLE A4: ASPHERIC SURFACE COEFFICIENT

| | |
|---|---|
| ASPHERIC | |
| SURFACE | SURFACE NUMBER |

| COEFFICIENT | 2 | 4 | 5 | 6 |
|---|---|---|---|---|
| K | 0 | −0.519140 | −100.000000 | −50.045820 |
| α3 | | −1.647619E−02 | 9.045281E−04 | −1.584768E−02 |
| α4 | 9.897756E−03 | 9.306103E−02 | −7.247797E−02 | 1.480497E−02 |
| α5 | | −1.463554E−01 | 5.011248E−02 | −8.051709E−02 |
| α6 | −1.775366E−01 | −1.189368E−01 | −7.513890E−02 | 2.642048E−01 |
| α7 | | 4.932119E−01 | 8.711940E−02 | −4.778490E−01 |
| α8 | 1.030730E+00 | −4.411616E−01 | −4.044638E−01 | −1.755639E−01 |
| α9 | | 1.384831E−01 | 6.077719E−01 | 1.290701E+00 |
| α10 | −1.973864E+00 | 1.559769E−01 | −3.280371E−01 | −7.594194E−01 |
| α11 | | −6.430340E−02 | 6.560197E−03 | |
| α12 | 1.400392E+00 | −2.295471E−01 | 1.086920E−01 | |
| α13 | | −3.678251E−01 | 2.230539E−01 | |
| α14 | −4.615587E−01 | −3.494506E−01 | 2.612986E−01 | |
| α15 | | 1.047597E−01 | 4.849794E−02 | |
| α16 | 5.307455E−01 | 1.407367E+00 | −7.288709E−01 | |

| ASPHERIC | | | | | |
|---|---|---|---|---|---|
| SURFACE | SURFACE NUMBER | | | | |
| COEFFICIENT | 7 | 8 | 9 | 10 | 11 |
| K | −3.832904 | −11.001000 | −89.176030 | −100.000000 | −13.031300 |
| α3 | 3.210471E−02 | −7.254753E−03 | −3.394850E−01 | −2.717552E−01 | −1.083800E−01 |
| α4 | −1.218261E−01 | −1.031881E−01 | 5.727648E−02 | −5.907275E−02 | 8.727701E−04 |
| α5 | 5.003462E−01 | 1.020778E−01 | 2.179903E−01 | −2.166835E−02 | −4.706439E−02 |
| α6 | −4.585604E−01 | 1.885665E−01 | −8.254569E−02 | 6.112189E−02 | 8.521842E−02 |
| α7 | −1.771676E−01 | −3.439371E−01 | −5.828771E−02 | 4.698633E−02 | −6.322718E−02 |
| α8 | 2.802425E−01 | −5.983698E−02 | 2.714480E−02 | −1.365640E−02 | 9.844054E−03 |
| α9 | 4.844266E−01 | 3.445256E−01 | 4.947630E−02 | −8.582814E−03 | 9.216297E−03 |
| α10 | −3.832647E−01 | −1.773895E−01 | −2.849486E−02 | 5.812724E−04 | −3.390525E−03 |

TABLE 4C
EXAMPLE A4: SCHEMATIC SPECIFICATION OF
IMAGING LENS WITH LENS ADAPTER

| DESIGN REFERENCE WAVELENGTH | 546.1 nm |
|---|---|
| FOCAL LENGTH | 3.73139 |
| Fno | 2.867 |

| IMAGE HEIGHT NUMBER | INCIDENT ANGLE deg |
|---|---|
| 1 | 0.000 |
| 2 | 15.653 |
| 3 | 21.914 |
| 4 | 31.306 |

TABLE 5A
EXAMPLE B1: LENS DATA

| SURFACE | | | | | |
|---|---|---|---|---|---|
| NUMBER | Ri | Di | Ndj | νdj | φ |
| OBJ | Infinity | Infinity | | | |
| 1 | Infinity | 1.000000 | 1.438750 | 94.95 | 2.200 |
| 2 | Infinity | 0.300000 | | | 2.200 |
| 3(STO) | Infinity | 0.000000 | | | 1.077 |
| 4 | 1.375100 | 1.200000 | 1.508690 | 56.00 | 1.200 |
| 5 | 2.186600 | 0.750000 | | | 1.600 |
| 6 | 1.903100 | 0.800000 | 1.508690 | 56.00 | 2.800 |
| 7 | 2.074600 | 1.044080 | | | 3.900 |
| 8(Cov) | Infinity | 0.300000 | BSC7 | | 4.600 |
| 9(Cov) | Infinity | 0.264380 | | | 4.600 |
| 10(Mp) | Infinity | | | | 4.808 |

REFRACTIVE INDEX AND ABBE NUMBER OF GLASS MATERIAL WITH RESPECT TO d-LINE

TABLE 5B
EXAMPLE B1: ASPHERIC SURFACE COEFFICIENT

| ASPHERIC | | | | | |
|---|---|---|---|---|---|
| SURFACE | SURFACE NUMBER | | | | |
| COEFFICIENT | 2 | 4 | 5 | 6 | 7 |
| K | 0 | −3.029550 | −10.996340 | −1.587338 | −5.583700 |
| α3 | 3.112792E−02 | | | −8.018170E−02 | −9.261790E−02 |
| α4 | 5.263567E−02 | 1.650290E−01 | 1.349840E−01 | −3.757260E−03 | 1.539430E−01 |
| α5 | −4.254135E−02 | | | −7.216600E−02 | −1.697470E−01 |
| α6 | −4.644998E−01 | −8.040580E−02 | 1.053400E−01 | 6.508290E−03 | 2.015020E−02 |
| α7 | −6.217222E−02 | | | 2.198580E−02 | 4.347310E−02 |
| α8 | 1.341270E+00 | −5.215530E−03 | −6.446380E−02 | 6.224740E−03 | −1.343930E−02 |
| α9 | 3.099197E−01 | | | −4.497080E−03 | −5.553390E−03 |
| α10 | −1.870908E+00 | 7.854100E−03 | 1.476120E−02 | −2.343060E−04 | 2.301100E−03 |
| α11 | 3.511082E−02 | | | | |
| α12 | 1.482772E+00 | | | | |
| α13 | −4.535818E−04 | | | | |
| α14 | −5.148788E−01 | | | | |
| α15 | −1.684940E−01 | | | | |
| α16 | −3.020009E−02 | | | | |

TABLE 5C
EXAMPLE B1: SCHEMATIC SPECIFICATION OF
IMAGING LENS WITH LENS ADAPTER

| DESIGN REFERENCE WAVELENGTH | 546.1 nm |
|---|---|
| FOCAL LENGTH | 3.77041 |
| Fno | 3.5 |

| IMAGE HEIGHT NUMBER | INCIDENT ANGLE deg |
|---|---|
| 1 | 0.000 |
| 2 | 15.653 |
| 3 | 21.914 |
| 4 | 31.306 |

TABLE 6A
EXAMPLE B2: LENS DATA

| SURFACE | | | | | |
|---|---|---|---|---|---|
| NUMBER | Ri | Di | Ndj | νdj | φ |
| OBJ | Infinity | Infinity | | | |
| 1 | Infinity | 1.000000 | 1.438750 | 94.95 | 2.800 |
| 2 | Infinity | 1.000000 | | | 2.700 |
| 3(STO) | Infinity | 0.000000 | | | 1.077 |
| 4 | 1.375100 | 1.200000 | 1.508690 | 56.00 | 1.200 |
| 5 | 2.186600 | 0.750000 | | | 1.600 |
| 6 | 1.903100 | 0.800000 | 1.508690 | 56.00 | 2.800 |
| 7 | 2.074600 | 1.044080 | | | 3.900 |
| 8(Cov) | Infinity | 0.300000 | BSC7 | | 4.600 |
| 9(Cov) | Infinity | 0.124380 | | | 4.600 |
| 10(Mp) | Infinity | | | | 4.901 |

REFRACTIVE INDEX AND ABBE NUMBER OF GLASS MATERIAL WITH RESPECT TO d-LINE

TABLE 6B
EXAMPLE B2: ASPHERIC SURFACE COEFFICIENT

| ASPHERIC | | | | | |
|---|---|---|---|---|---|
| SURFACE | SURFACE NUMBER | | | | |
| COEFFICIENT | 2 | 4 | 5 | 6 | 7 |
| K | 0 | −3.029550 | −10.996340 | −1.587338 | −5.583700 |
| α3 | 1.682177E−03 | | | −8.018170E−02 | −9.261790E−02 |
| α4 | −9.085629E−04 | 1.650290E−01 | 1.349840E−01 | −3.757260E−03 | 1.539430E−01 |
| α5 | −7.730201E−04 | | | −7.216600E−02 | −1.697470E−01 |
| α6 | 1.142629E−03 | −8.040580E−02 | 1.053400E−01 | 6.508290E−03 | 2.015020E−02 |
| α7 | 1.618568E−03 | | | 2.198580E−02 | 4.347310E−02 |
| α8 | 1.056799E−03 | −5.215530E−03 | −6.446380E−02 | 6.224740E−03 | −1.343930E−02 |
| α9 | −1.209824E−05 | | | −4.497080E−03 | −5.553390E−03 |
| α10 | −1.000466E−03 | 7.854100E−03 | 1.476120E−02 | −2.343060E−04 | 2.301100E−03 |
| α11 | −1.296115E−03 | | | | |
| α12 | −7.489924E−04 | | | | |
| α13 | −1.338619E−03 | | | | |
| α14 | −1.142716E−03 | | | | |
| α15 | −8.245069E−04 | | | | |
| α16 | −5.063424E−04 | | | | |

TABLE 6C
EXAMPLE B2: SCHEMATIC SPECIFICATION OF
IMAGING LENS WITH LENS ADAPTER

| DESIGN REFERENCE WAVELENGTH | 546.1 nm |
|---|---|
| FOCAL LENGTH | 3.77041 |
| Fno | 3.5 |

| IMAGE HEIGHT NUMBER | INCIDENT ANGLE deg |
|---|---|
| 1 | 0.000 |
| 2 | 15.653 |
| 3 | 21.914 |
| 4 | 31.306 |

TABLE 7A
EXAMPLE C1: LENS DATA

| SURFACE | | | | | |
|---|---|---|---|---|---|
| NUMBER | Ri | Di | Ndj | νdj | φ |
| OBJ | Infinity | Infinity | | | |
| 1 | Infinity | 1.000000 | 1.438750 | 94.95 | 2.200 |
| 2 | Infinity | 0.100000 | | | 1.800 |
| 3(STO) | Infinity | 0.000000 | | | 1.374 |
| 4 | 1.844300 | 1.000000 | 1.510070 | 56.20 | 2.000 |
| 5 | 19.419600 | 0.819000 | | | 2.000 |
| 6 | −1.875500 | 0.700000 | 1.607760 | 25.10 | 2.100 |
| 7 | −7.656600 | 0.100000 | | | 2.700 |
| 8 | 1.789400 | 1.300000 | 1.510070 | 56.20 | 3.300 |
| 9 | 2.915400 | 1.116000 | | | 4.600 |
| 10(Cov) | Infinity | 0.300000 | S-BSL7 | | 5.966 |
| 11(Cov) | Infinity | 0.316000 | | | 6.189 |
| 12(Mp) | Infinity | | | | 6.585 |

REFRACTIVE INDEX AND ABBE NUMBER OF GLASS MATERIAL WITH RESPECT TO d-LINE

TABLE 7B
EXAMPLE C1: ASPHERIC SURFACE COEFFICIENT

| ASPHERIC | | | | |
|---|---|---|---|---|
| SURFACE | SURFACE NUMBER | | | |
| COEFFICIENT | 2 | 4 | 5 | 6 |
| K | 0 | 2.084780 | 0.000000 | 1.766320 |
| α3 | | −3.741920E−02 | 3.519040E−02 | −4.014600E−02 |
| α4 | −4.681925E−03 | 1.718250E−01 | −1.498540E−01 | 1.116560E−01 |
| α5 | | −5.843590E−01 | 2.736050E−01 | −5.812010E−03 |
| α6 | −1.568299E−01 | 6.529330E−01 | −2.872640E−01 | −7.842140E−02 |
| α7 | | −7.830280E−02 | 8.767570E−02 | 3.283180E−02 |
| α8 | 1.257502E+00 | −5.652190E−01 | 7.105970E−02 | 6.560350E−02 |
| α9 | | 4.819740E−01 | −6.352080E−02 | 2.200530E−02 |
| α10 | −3.090906E+00 | −1.618770E−01 | −4.546260E−03 | −4.447070E−02 |
| α11 | | | | |
| α12 | 1.987755E+00 | | | |
| α13 | | | | |
| α14 | 3.976307E+00 | | | |
| α15 | | | | |
| α16 | −5.553149E+00 | | | |

| ASPHERIC | | | |
|---|---|---|---|
| SURFACE | SURFACE NUMBER | | |
| COEFFICIENT | 7 | 8 | 9 |
| K | −4.010260 | −20.483300 | −10.854390 |
| α3 | −2.760310E−01 | −1.396690E−01 | 5.929760E−02 |
| α4 | 6.278970E−02 | 1.715750E−03 | −1.358130E−01 |
| α5 | 7.526460E−02 | 1.947570E−02 | 6.592920E−02 |
| α6 | −9.410110E−03 | 7.475130E−03 | −5.251680E−03 |
| α7 | −1.328610E−02 | −3.233750E−03 | −6.371280E−03 |
| α8 | 1.602920E−02 | −1.271690E−03 | 5.614610E−04 |
| α9 | 1.307090E−02 | 1.178660E−03 | 8.847200E−04 |
| α10 | −1.103520E−02 | −3.107960E−04 | −2.167740E−04 |

TABLE 7C
EXAMPLE C1: SCHEMATIC SPECIFICATION OF
IMAGING LENS WITH LENS ADAPTER

| DESIGN REFERENCE WAVELENGTH | 546.1 nm |
|---|---|
| FOCAL LENGTH | 4.80797 |
| Fno | 3.5 |

| IMAGE HEIGHT NUMBER | INCIDENT ANGLE deg |
|---|---|
| 1 | 0.000 |
| 2 | 15.653 |
| 3 | 21.914 |
| 4 | 31.306 |

TABLE 8A
EXAMPLE C2: LENS DATA

| SURFACE | | | | | |
|---|---|---|---|---|---|
| NUMBER | Ri | Di | Ndj | νdj | φ |
| OBJ | Infinity | Infinity | | | |
| 1 | Infinity | 1.000000 | 1.438750 | 94.95 | 3.000 |
| 2 | Infinity | 1.000000 | | | 2.800 |
| 3(STO) | Infinity | 0.000000 | | | 1.374 |
| 4 | 1.844300 | 1.000000 | 1.510070 | 56.20 | 2.000 |
| 5 | 19.419600 | 0.819000 | | | 2.000 |
| 6 | −1.875500 | 0.700000 | 1.607760 | 25.10 | 2.100 |
| 7 | −7.656600 | 0.100000 | | | 2.700 |
| 8 | 1.789400 | 1.300000 | 1.510070 | 56.20 | 3.300 |
| 9 | 2.915400 | 1.116000 | | | 4.600 |
| 10(Cov) | Infinity | 0.300000 | S-BSL7 | | 5.473 |
| 11(Cov) | Infinity | 0.316000 | | | 5.629 |
| 12(Mp) | Infinity | | | | 5.898 |

REFRACTIVE INDEX AND ABBE NUMBER OF GLASS MATERIAL WITH RESPECT TO d-LINE

TABLE 8B
EXAMPLE C2: ASPHERIC SURFACE COEFFICIENT

| ASPHERIC | | | | |
|---|---|---|---|---|
| SURFACE | SURFACE NUMBER | | | |
| COEFFICIENT | 2 | 4 | 5 | 6 |
| K | 0 | 2.084780 | 0.000000 | 1.766320 |
| α3 | | −3.741920E−02 | 3.519040E−02 | −4.014600E−02 |
| α4 | 4.432169E−03 | 1.718250E−01 | −1.498540E−01 | 1.116560E−01 |
| α5 | | −5.843590E−01 | 2.736050E−01 | −5.812010E−03 |
| α6 | −1.330892E−02 | 6.529330E−01 | −2.872640E−01 | −7.842140E−02 |
| α7 | | −7.830280E−02 | 8.767570E−02 | 3.283180E−02 |
| α8 | 7.398605E−03 | −5.652190E−01 | 7.105970E−02 | 6.560350E−02 |
| α9 | | 4.819740E−01 | −6.352080E−02 | 2.200530E−02 |
| α10 | 1.288441E−02 | −1.618770E−01 | −4.546260E−03 | −4.447070E−02 |
| α11 | | | | |
| α12 | −1.174187E−02 | | | |
| α13 | | | | |
| α14 | −3.300425E−03 | | | |
| α15 | | | | |
| α16 | 3.796847E−03 | | | |

| ASPHERIC | | | |
|---|---|---|---|
| SURFACE | SURFACE NUMBER | | |
| COEFFICIENT | 7 | 8 | 9 |
| K | −4.010260 | −20.483300 | −10.854390 |
| α3 | −2.760310E−01 | −1.396690E−01 | 5.929760E−02 |
| α4 | 6.278970E−02 | 1.715750E−03 | −1.358130E−01 |
| α5 | 7.526460E−02 | 1.947570E−02 | 6.592920E−02 |
| α6 | −9.410110E−03 | 7.475130E−03 | −5.251680E−03 |
| α7 | −1.328610E−02 | −3.233750E−03 | −6.371280E−03 |
| α8 | 1.602920E−02 | −1.271690E−03 | 5.614610E−04 |
| α9 | 1.307090E−02 | 1.178660E−03 | 8.847200E−04 |
| α10 | −1.103520E−02 | −3.107960E−04 | −2.167740E−04 |

TABLE 8C
EXAMPLE C2: SCHEMATIC SPECIFICATION OF
IMAGING LENS WITH LENS ADAPTER

| DESIGN REFERENCE WAVELENGTH | 546.1 nm |
|---|---|
| FOCAL LENGTH | 4.80797 |
| Fno | 3.5 |

| IMAGE HEIGHT NUMBER | INCIDENT ANGLE deg |
|---|---|
| 1 | 0.000 |
| 2 | 15.653 |
| 3 | 21.914 |
| 4 | 31.306 |

TABLE 9A
EXAMPLE C3: LENS DATA

| SURFACE | | | | | |
|---|---|---|---|---|---|
| NUMBER | Ri | Di | Ndj | νdj | φ |
| OBJ | Infinity | Infinity | | | |
| 1 | Infinity | 1.000000 | 1.438750 | 94.95 | 3.000 |
| 2 | Infinity | 0.500000 | | | 3.000 |
| 3(STO) | Infinity | 0.000000 | | | 1.374 |
| 4 | 1.844300 | 1.000000 | 1.510070 | 56.20 | 2.000 |
| 5 | 19.419600 | 0.819000 | | | 2.000 |
| 6 | −1.875500 | 0.700000 | 1.607760 | 25.10 | 2.100 |
| 7 | −7.656600 | 0.100000 | | | 2.700 |
| 8 | 1.789400 | 1.300000 | 1.510070 | 56.20 | 3.300 |
| 9 | 2.915400 | 1.116000 | | | 4.600 |
| 10(Cov) | Infinity | 0.300000 | S-BSL7 | | 6.353 |
| 11(Cov) | Infinity | 0.316000 | | | 6.559 |
| 12(Mp) | Infinity | | | | 6.917 |

REFRACTIVE INDEX AND ABBE NUMBER OF GLASS MATERIAL WITH RESPECT TO d-LINE

TABLE 9B
EXAMPLE C3: ASPHERIC SURFACE COEFFICIENT

| ASPHERIC | | | | |
|---|---|---|---|---|
| SURFACE | SURFACE NUMBER | | | |
| COEFFICIENT | 2 | 4 | 5 | 6 |
| K | 0 | 2.084780 | 0.000000 | 1.766320 |
| α3 | −2.892817E−03 | −3.741920E−02 | 3.519040E−02 | −4.014600E−02 |
| α4 | 1.494877E−02 | 1.718250E−01 | −1.498540E−01 | 1.116560E−01 |
| α5 | 2.330782E−03 | −5.843590E−01 | 2.736050E−01 | −5.812010E−03 |
| α6 | −4.200911E−02 | 6.529330E−01 | −2.872640E−01 | −7.842140E−02 |
| α7 | 1.778329E−04 | −7.830280E−02 | 8.767570E−02 | 3.283180E−02 |
| α8 | 1.011993E−04 | −5.652190E−01 | 7.105970E−02 | 6.560350E−02 |
| α9 | 9.203114E−05 | 4.819740E−01 | −6.352080E−02 | 2.200530E−02 |
| α10 | −2.993065E−08 | −1.618770E−01 | −4.546260E−03 | −4.447070E−02 |
| α11 | −5.954779E−08 | | | |
| α12 | −7.861214E−08 | | | |
| α13 | −9.850830E−08 | | | |
| α14 | −1.187235E−07 | | | |
| α15 | −1.389790E−07 | | | |
| α16 | −1.607035E−07 | | | |

| ASPHERIC | | | |
|---|---|---|---|
| SURFACE | SURFACE NUMBER | | |
| COEFFICIENT | 7 | 8 | 9 |
| K | −4.010260 | −20.483300 | −10.854390 |
| α3 | −2.760310E−01 | −1.396690E−01 | 5.929760E−02 |
| α4 | 6.278970E−02 | 1.715750E−03 | −1.358130E−01 |
| α5 | 7.526460E−02 | 1.947570E−02 | 6.592920E−02 |
| α6 | −9.410110E−03 | 7.475130E−03 | −5.251680E−03 |
| α7 | −1.328610E−02 | −3.233750E−03 | −6.371280E−03 |
| α8 | 1.602920E−02 | −1.271690E−03 | 5.614610E−04 |
| α9 | 1.307090E−02 | 1.178660E−03 | 8.847200E−04 |
| α10 | −1.103520E−02 | −3.107960E−04 | −2.167740E−04 |

TABLE 9C
EXAMPLE C3: SCHEMATIC SPECIFICATION OF
IMAGING LENS WITH LENS ADAPTER

| DESIGN REFERENCE WAVELENGTH | 546.1 nm |
|---|---|
| FOCAL LENGTH | 4.80797 |
| Fno | 3.5 |

| IMAGE HEIGHT NUMBER | INCIDENT ANGLE deg |
|---|---|
| 1 | 0.000 |
| 2 | 15.653 |
| 3 | 21.914 |
| 4 | 31.306 |

TABLE 10A
EXAMPLE D: LENS DATA

| SURFACE | | | | | |
|---|---|---|---|---|---|
| NUMBER | Ri | Di | Ndj | νdj | φ |
| OBJ | Infinity | Infinity | | | |
| 1 | Infinity | 0.992000 | 1.438750 | 94.95 | 2.271 |
| 1′ | Infinity | 0.008000 | 1.527700 | 41.80 | 1.503 |
| 2 | Infinity | 0.170000 | | | 1.498 |
| 3(STO) | Infinity | −0.070000 | | | 1.301 |
| 4 | 1.496937 | 0.699316 | 1.533914 | 59.00 | 1.426 |
| 5 | −11.058800 | 0.090334 | | | 1.544 |
| 6 | −3410.537000 | 0.400974 | 1.605957 | 26.90 | 1.575 |
| 7 | 2.944400 | 0.614091 | | | 1.612 |
| 8 | −14.563680 | 0.600311 | 1.533914 | 59.00 | 1.996 |
| 9 | −2.248293 | 0.439934 | | | 2.379 |
| 10 | −7936.115000 | 0.451007 | 1.533914 | 59.00 | 2.727 |
| 11 | 1.499692 | 0.200000 | | | 3.650 |
| 12(Cov) | Infinity | 0.145000 | 1.516330 | 64.14 | 4.400 |
| 13(Cov) | Infinity | 0.554574 | | | 4.400 |
| 14(Mp) | Infinity | | | | 5.000 |

REFRACTIVE INDEX AND ABBE NUMBER OF GLASS MATERIAL WITH RESPECT TO d-LINE

TABLE 10B
EXAMPLE D: ASPHERIC SURFACE COEFFICIENT

| | |
|---|---|
| ASPHERIC | |
| SURFACE | SURFACE NUMBER |

| COEFFICIENT | 2 | 4 | 5 | 6 |
|---|---|---|---|---|
| K | 0 | −0.519140 | −100.000000 | −50.045820 |
| α3 | | −1.647619E−02 | 9.045281E−04 | −1.584768E−02 |
| α4 | 3.2858202E−02 | 9.306103E−02 | −7.247797E−02 | 1.480497E−02 |
| α5 | | −1.463554E−01 | 5.011248E−02 | −8.051709E−02 |
| α6 | −3.1741179E−01 | −1.189368E−01 | −7.513890E−02 | 2.642043E−01 |
| α7 | | 4.932119E−01 | 8.711940E−02 | −4.778490E−01 |
| α8 | 1.200951E+00 | −4.411616E−01 | −4.044638E−01 | −1.755639E−01 |
| α9 | | 1.384831E−01 | 6.077719E−01 | 1.290701E+00 |
| α10 | −2.1247158E+00 | 1.559769E−01 | −3.280371E−01 | −7.594194E−01 |
| α11 | | −6.430340E−02 | 6.560197E−03 | |
| α12 | 1.3709919E+00 | −2.295471E−01 | 1.086920E−01 | |
| α13 | | −3.678251E−01 | 2.230539E−01 | |
| α14 | −2.7963049E−01 | −3.494506E−01 | 2.612986E−01 | |
| α15 | | 1.047597E−01 | 4.849794E−02 | |
| α16 | 6.7875226E−01 | 1.407367E+00 | −7.288709E−01 | |

| ASPHERIC | | | | | |
|---|---|---|---|---|---|
| SURFACE | SURFACE NUMBER | | | | |
| COEFFICIENT | 7 | 8 | 9 | 10 | 11 |
| K | −3.832904 | −11.001000 | −89.176030 | −100.000000 | −13.031300 |
| α3 | 3.210471E−02 | −7.254753E−03 | −3.394850E−01 | −2.717552E−01 | −1.083800E−01 |
| α4 | −1.218261E−01 | −1.031881E−01 | 5.727648E−02 | −5.907275E−02 | 8.727701E−04 |
| α5 | 5.003462E−01 | 1.020778E−01 | 2.179903E−01 | −2.166835E−02 | −4.706439E−02 |
| α6 | −4.585604E−01 | 1.885665E−01 | −8.254569E−02 | 6.112189E−02 | 8.521842E−02 |
| α7 | −1.771676E−01 | −3.439371E−01 | −5.828771E−02 | 4.698633E−02 | −6.322718E−02 |
| α8 | 2.802425E−01 | −5.983698E−02 | 2.714480E−02 | −1.365640E−02 | 9.844054E−03 |
| α9 | 4.844266E−01 | 3.445256E−01 | 4.947630E−02 | −8.582814E−03 | 9.216297E−03 |
| α10 | −3.832647E−01 | −1.773895E−01 | −2.849486E−02 | 5.812724E−04 | −3.390525E−03 |

TABLE 10C
EXAMPLE D: SCHEMATIC SPECIFICATION OF
IMAGING LENS WITH LENS ADAPTER

| DESIGN REFERENCE WAVELENGTH | 546.1 nm |
|---|---|
| FOCAL LENGTH | 3.73139 |
| Fno | 2.867 |

| IMAGE HEIGHT NUMBER | INCIDENT ANGLE deg |
|---|---|
| 1 | 0.000 |
| 2 | 15.653 |
| 3 | 21.914 |
| 4 | 31.306 |

TABLE 11A
COMPARATIVE EXAMPLE A0: LENS DATA

| SURFACE | | | | | |
|---|---|---|---|---|---|
| NUMBER | Ri | Di | Ndj | νdj | φ |
| OBJ | Infinity | Infinity | | | 0 |
| | Infinity | 0.070000 | | | 1.387 |
| STO | Infinity | −0.070000 | | | 1.301 |
| 4 | 1.496937 | 0.699316 | 1.533914 | 59.00 | 1.359 |
| 5 | −11.058800 | 0.090334 | | | 1.430 |
| 6 | −3410.537000 | 0.400974 | 1.605957 | 26.90 | 1.440 |
| 7 | 2.944400 | 0.614091 | | | 1.544 |
| 8 | −14.563680 | 0.600311 | 1.533914 | 59.00 | 2.018 |
| 9 | −2.248293 | 0.439934 | | | 2.460 |
| 10 | −7936.115000 | 0.451007 | 1.533914 | 59.00 | 2.872 |
| 11 | 1.499692 | 0.200000 | | | 3.650 |
| 12(Cov) | Infinity | 0.145000 | 1.516330 | 64.14 | 4.094 |
| 13(Cov) | Infinity | 0.464574 | | | 4.166 |
| 14(Mp) | Infinity | | | | 4.544 |

REFRACTIVE INDEX AND ABBE NUMBER OF GLASS MATERIAL WITH RESPECT TO d-LINE

TABLE 11B
COMPARATIVE EXAMPLE A0: ASPHERIC SURFACE COEFFICIENT

| ASPHERIC | | | | |
|---|---|---|---|---|
| SURFACE | SURFACE NUMBER | | | |
| COEFFICIENT | 4 | 5 | 6 | 7 |
| K | −0.51914 | −100.00000 | −50.04582 | −3.83290 |
| α3 | −1.647619E−02 | 9.045281E−04 | −1.584768E−02 | 3.210471E−02 |
| α4 | 9.306103E−02 | −7.247797E−02 | 1.480497E−02 | −1.218261E−01 |
| α5 | −1.463554E−01 | 5.011248E−02 | −8.051709E−02 | 5.003462E−01 |
| α6 | −1.189368E−01 | −7.513890E−02 | 2.642048E−01 | −4.585604E−01 |
| α7 | 4.932119E−01 | 8.711940E−02 | −4.778490E−01 | −1.771676E−01 |
| α8 | −4.411616E−01 | −4.044638E−01 | −1.755639E−01 | 2.802425E−01 |
| α9 | 1.384831E−01 | 6.077719E−01 | 1.290701E+00 | 4.844266E−01 |
| α10 | 1.559769E−01 | −3.280371E−01 | −7.594194E−01 | −3.832647E−01 |
| α11 | −6.430340E−02 | 6.560197E−03 | | |
| α12 | −2.295471E−01 | 1.086920E−01 | | |
| α13 | −3.678251E−01 | 2.230539E−01 | | |
| α14 | −3.494506E−01 | 2.612986E−01 | | |
| α15 | 1.047597E−01 | 4.849794E−02 | | |
| α16 | 1.407367E+00 | −7.288709E−01 | | |
| ASPHERIC | | | | |
| SURFACE | SURFACE NUMBER | | | |
| COEFFICIENT | 8 | 9 | 10 | 11 |
| K | −11.00100 | −89.17603 | −100.00000 | −13.03130 |
| α3 | −7.254753E−03 | −3.394850E−01 | −2.717552E−01 | −1.083800E−01 |
| α4 | −1.031881E−01 | 5.727648E−02 | −5.907275E−02 | 8.727701E−04 |
| α5 | 1.020778E−01 | 2.179903E−01 | −2.166835E−02 | −4.706439E−02 |
| α6 | 1.885665E−01 | −8.254569E−02 | 6.112189E−02 | 8.521842E−02 |
| α7 | −3.439371E−01 | −5.828771E−02 | 4.698633E−02 | −6.322718E−02 |
| α8 | −5.983698E−02 | 2.714480E−02 | −1.365640E−02 | 9.844054E−03 |
| α9 | 3.445256E−01 | 4.947630E−02 | −8.582814E−03 | 9.216297E−03 |
| α10 | −1.773895E−01 | −2.849486E−02 | 5.812724E−04 | −3.390525E−03 |

TABLE 11C
COMPARATIVE EXAMPLE A0: SCHEMATIC SPECIFICATION
OF IMAGING LENS WITHOUT LENS ADAPTER

| DESIGN REFERENCE WAVELENGTH | 546.1 nm |
|---|---|
| FOCAL LENGTH | 3.73139 |
| Fno | 2.867 |

| IMAGE HEIGHT NUMBER | INCIDENT ANGLE deg |
|---|---|
| 1 | 0.000 |
| 2 | 1.134 |
| 3 | 1.588 |
| 4 | 2.268 |

TABLE 12

| | | | INTERVAL | | 15% OR | 5% OR | |
|---|---|---|---|---|---|---|---|
| | | THICKNESS | BETWEEN | MTF140⁽*¹⁾ | MORE | MORE | MTF70⁽*¹⁾ |
| | | OF LENS | LENSES | RESPONSE | DEPTH⁽*²⁾ | DEPTH⁽*³⁾ | RESPONSE |
| | EXAMPLE | | | | | | |
| 1 | [A1] | 1.0 | 0.1 | 30 | 0.050 | 0.080 | 43 |
| 2 | [A2] | 1.0 | 0.5 | 25 | 0.048 | 0.085 | 40 |
| 3 | [A3] | 2.0 | 0.5 | 14 | 0.019 | 0.113 | 33 |
| 4 | [A4] | 1.0 | 0.1 | 30 | 0.050 | 0.080 | 43 |
| 5 | [B1] | 1.0 | 0.3 | 5 | 0.000 | 0.100 | 24 |
| 6 | [B2] | 1.0 | 1.0 | 24 | 0.030 | 0.090 | 50 |
| 7 | [C1] | 1.0 | 0.1 | 20 | 0.050 | 0.075 | 33 |
| 8 | [C2] | 1.0 | 1.0 | 46 | 0.052 | 0.094 | 70 |
| 9 | [C3] | 1.0 | 0.5 | 24 | 0.059 | 0.080 | 43 |
| 10 | [D] | 1.0 | 0.1 | 28 | 0.066 | 0.095 | 43 |
| | COMPARATIVE | | | | | | |
| | EXAMPLE | | | | | | |
| 11 | [A0] | | | 62 | 0.045 | 0.083 | 81 |
| 12 | [B0] | | | 17 | 0.032 | 0.063 | 46 |
| 13 | [C0] | | | 46 | 0.042 | 0.070 | 71 |

| | | | | MTF (← LOWEST VALUE OF | |
|---|---|---|---|---|---|
| | | | | MTF AT CENTER, MTF AT 50% OF ANGLE OF | |
| | 15% OR | 5% OR | MTF | VIEW, AND MTF AT 70% OF ANGLE OF VIEW) | |
| | MORE | MORE | 120 LINES/ | 240 LINES/ | |
| | DEPTH⁽*²⁾ | DEPTH⁽*³⁾ | mm | mm | |
| 1 | 0.095 | 0.130 | 16.0 | 5.0 | |
| 2 | 0.100 | 0.150 | 20.0 | 5.0 | |
| 3 | 0.120 | 0.165 | 19.0 | 7.0 | |
| 4 | 0.095 | 0.130 | 16.0 | 5.0 | |
| 5 | 0.100 | 0.147 | 6.6 | 3.0 | |
| 6 | 0.090 | 0.150 | 20.0 | 7.0 | |
| 7 | 0.100 | 0.130 | 11.0 | 2.0 | |
| 8 | 0.100 | 0.140 | 24.0 | 4.0 | |
| 9 | 0.110 | 0.140 | 15.0 | 3.0 | |
| 10 | 0.018 | 0.130 | 32.0 | 15.0 | COMPLEX ASPHERIC SURFACE |
| 11 | 0.081 | 0.110 | 66.0 | 37.0 | 4 GROUPS/4 ELEMENTS |
| | | | | | MASTER LENS ALONE |
| 12 | 0.086 | 0.110 | 22.0 | 7.0 | 2 GROUPS/2 ELEMENTS |
| | | | | | MASTER LENS ALONE |
| 13 | 0.095 | 0.120 | 50.0 | 23.0 | 3 GROUPS/3 ELEMENTS |
| | | | | | MASTER LENS ALONE |

⁽*¹⁾LOWEST RESPONSE AT DEFOCUS POSITION ACHIEVING MAXIMUM RESPONSE (MTF)
⁽*²⁾DEPTH ACHIEVING MTF RESPONSE OF 15% OR MORE FOR IMAGE HEIGHT OF 70% OR LESS
⁽*³⁾DEPTH ACHIEVING MTF RESPONSE OF 5% OR MORE FOR IMAGE HEIGHT OF 70% OR LESS

TABLE 13

| EXAMPLE | c | K | α3 | α4 | α5 | α6 | α7 |
|---|---|---|---|---|---|---|---|
| [A1] | 0 | 0 | 0.000000E+00 | 5.570400E−02 | 0.000000E+00 | −3.702960E−01 | 0.000000E+00 |
| [A2] | 0 | 0 | 0.000000E+00 | 6.007200E−02 | 0.000000E+00 | −3.766660E−01 | 0.000000E+00 |
| [A3] | 0 | 0 | 0.000000E+00 | 8.385700E−02 | 0.000000E+00 | −4.019020E−01 | 0.000000E+00 |
| [A4] | 0 | 0 | 0.000000E+00 | 9.897756E−03 | 0.000000E+00 | −1.775366E−01 | 0.000000E+00 |
| [B1] | 0 | 0 | 3.112800E−02 | 5.263600E−02 | −4.254100E−02 | −4.645000E−01 | −6.217200E−02 |
| [B2] | 0 | 0 | 1.682177E−03 | −9.085629E−04 | −7.730201E−04 | 1.142629E−03 | 1.618567E−03 |
| [C1] | 0 | 0 | 0.000000E+00 | −4.681925E−03 | 0.000000E+00 | −1.568300E−01 | 0.000000E+00 |
| [C2] | 0 | 0 | 0.000000E+00 | 4.432169E−03 | 0.000000E+00 | −1.330892E−02 | 0.000000E+00 |
| [C3] | 0 | 0 | −6.114367E−03 | 1.858966E−02 | 7.482302E−03 | −3.702574E−02 | 4.863681E−03 |
| [D] | 0 | 0 | 0.000000E+00 | 3.285820E−02 | 0.000000E+00 | −3.174118E−01 | 0.000000E+00 |

| EXAMPLE | α8 | α9 | α10 | α11 | α12 |
|---|---|---|---|---|---|
| [A1] | 1.264178E+00 | 0.000000E+00 | −1.970307E+00 | 0.000000E+00 | 1.376747E+00 |
| [A2] | 1.274318E+00 | 0.000000E+00 | −1.966386E+00 | 0.000000E+00 | 1.405545E+00 |
| [A3] | 1.223379E+00 | 0.000000E+00 | −1.947172E+00 | 0.000000E+00 | 1.466689E+00 |
| [A4] | 1.030730E+00 | 0.000000E+00 | −1.973864E+00 | 0.000000E+00 | 1.400392E+00 |
| [B1] | 1.341270E+00 | 3.099200E−01 | −1.870908E+00 | 3.511100E−02 | 1.482772E+00 |
| [B2] | 1.056799E−03 | −1.209820E−05 | −1.000466E−03 | −1.296115E−03 | −7.489924E−04 |
| [C1] | 1.257502E+00 | 0.000000E+00 | −3.090905E+00 | 0.000000E+00 | 1.987755E+00 |
| [C2] | 7.398605E−03 | 0.000000E+00 | 1.288441E−02 | 0.000000E+00 | −1.174187E−02 |
| [C3] | 4.208159E−03 | 3.761377E−03 | 6.579041E−03 | 4.055338E−03 | 1.816706E−03 |
| [D] | 1.200951E+00 | 0.000000E+00 | −2.124716E+00 | 0.000000E+00 | 1.370992+00 |

| EXAMPLE | α13 | α14 | α15 | α16 |
|---|---|---|---|---|
| [A1] | 0.000000E+00 | −5.516670E−01 | 0.000000E+00 | 2.896870E−01 |
| [A2] | 0.000000E+00 | −5.380960E−01 | 0.000000E+00 | 2.466680E−01 |
| [A3] | 0.000000E+00 | −3.700460E−01 | 0.000000E+00 | 0.000000E+00 |
| [A4] | 0.000000E+00 | −4.615687E−01 | 0.000000E+00 | 5.307455E−01 |
| [B1] | −4.535818E−04 | −5.148790E−01 | −1.884940E−01 | −3.020000E−02 |
| [B2] | −1.338619E−03 | −1.142716E−03 | −8.246069E−04 | −5.063424E−04 |
| [C1] | 0.000000E+00 | 3.976307E+00 | 0.000000E+00 | −5.553149E+00 |
| [C2] | 0.000000E+00 | −3.300425E−03 | 0.000000E+00 | 3.796847E−03 |
| [C3] | −3.551455E−05 | −1.505077E−03 | −2.652540E−03 | −3.689029E−03 |
| [D] | 0.000000E+00 | −2.796305E−01 | 0.000000E+00 | 6.787523E−01 |

TABLE 14
EXAMPLE [A1]

| POSITION (mm) | FORM [mm] |
|---|---|
| 1 | 1.1403E−01 |
| 0.944444 | 4.3557E−02 |
| 0.888889 | 1.8798E−02 |
| 0.833333 | 1.0406E−02 |
| 0.777778 | 7.0769E−03 |
| 0.722222 | 5.1080E−03 |
| 0.666667 | 3.5952E−03 |
| 0.611111 | 2.4340E−03 |
| 0.555556 | 1.6208E−03 |
| 0.5 | 1.0947E−03 |
| 0.444444 | 7.5802E−04 |
| 0.388889 | 5.2465E−04 |
| 0.333333 | 3.4460E−04 |
| 0.277778 | 2.0195E−04 |
| 0.222222 | 9.8327E−05 |
| 0.166667 | 3.5777E−05 |
| 0.111111 | 7.8227E−06 |
| 0.055556 | 5.1986E−07 |
| −3.1E−16 | 4.8401E−64 |
| −0.05556 | 6.1986E−07 |
| −0.11111 | 7.8227E−06 |
| −0.16667 | 3.5777E−05 |
| −0.22222 | 9.8327E−05 |
| −0.27778 | 2.0195E−04 |
| −0.33333 | 3.4460E−04 |
| −0.38889 | 5.2465E−04 |
| −0.44444 | 7.5802E−04 |
| −0.5 | 1.0947E−03 |
| −0.55556 | 1.6208E−03 |
| −0.61111 | 2.4340E−03 |
| −0.66667 | 3.5952E−03 |
| −0.72222 | 5.1080E−03 |
| −0.77778 | 7.0769E−03 |
| −0.83333 | 1.0406E−02 |
| −0.88889 | 1.8798E−02 |
| −0.94444 | 4.3557E−02 |
| −1 | 1.1403E−01 |

TABLE 15
EXAMPLE [A2]

| POSITION (mm) | FORM [mm] |
|---|---|
| 1 | 1.0546E−01 |
| 0.944444444 | 4.1856E−02 |
| 0.888888889 | 1.8833E−02 |
| 0.833333333 | 1.0681E−02 |
| 0.777777778 | 7.3051E−03 |
| 0.722222222 | 5.3009E−03 |
| 0.666666667 | 3.7851E−03 |
| 0.611111111 | 2.6237E−03 |
| 0.555555556 | 1.7961E−03 |
| 0.5 | 1.2407E−03 |
| 0.444444444 | 8.6729E−04 |
| 0.388888889 | 5.9803E−04 |
| 0.333333333 | 3.8840E−04 |
| 0.277777778 | 2.2470E−04 |
| 0.222222222 | 1.0815E−04 |
| 0.166666667 | 3.9005E−05 |
| 0.111111111 | 8.4762E−06 |
| 0.055555556 | 5.6129E−07 |
| −3.05311E−16 | 5.2197E−64 |
| −0.055555556 | 5.6129E−07 |
| −0.111111111 | 8.4762E−06 |
| −0.166666667 | 3.9005E−05 |
| −0.222222222 | 1.0815E−04 |
| −0.277777778 | 2.2470E−04 |
| −0.333333333 | 3.8840E−04 |
| −0.388888889 | 5.9803E−04 |
| −0.444444444 | 8.6729E−04 |
| −0.5 | 1.2407E−03 |
| −0.555555556 | 1.7961E−03 |
| −0.611111111 | 2.6237E−03 |
| −0.666666667 | 3.7851E−03 |
| −0.722222222 | 5.3009E−03 |
| −0.777777778 | 7.3051E−03 |
| −0.833333333 | 1.0681E−02 |
| −0.888888889 | 1.8833E−02 |
| −0.944444444 | 4.1856E−02 |
| −1 | 1.0546E−01 |

TABLE 16
EXAMPLE [A3]

| POSITION (mm) | FORM [mm] |
|---|---|
| 1 | 5.4805E−02 |
| 0.944444444 | 2.8921E−02 |
| 0.888888889 | 1.7013E−02 |
| 0.833333333 | 1.1561E−02 |
| 0.777777778 | 8.7122E−03 |
| 0.722222222 | 6.8072E−03 |
| 0.666666667 | 5.2849E−03 |
| 0.611111111 | 4.0181E−03 |
| 0.555555556 | 2.9889E−03 |
| 0.5 | 2.1741E−03 |
| 0.444444444 | 1.5341E−03 |
| 0.388888889 | 1.0306E−03 |
| 0.333333333 | 6.4013E−04 |
| 0.277777778 | 3.5297E−04 |
| 0.222222222 | 1.6282E−04 |
| 0.166666667 | 5.6787E−05 |
| 0.111111111 | 1.2053E−05 |
| 0.055555556 | 7.8711E−07 |
| −3.05311E−16 | 7.2864E−64 |
| −0.055555556 | 7.8711E−07 |
| −0.111111111 | 1.2053E−05 |
| −0.166666667 | 5.6787E−05 |
| −0.222222222 | 1.6282E−04 |
| −0.277777778 | 3.5297E−04 |
| −0.333333333 | 6.4013E−04 |
| −0.388888889 | 1.0306E−03 |
| −0.444444444 | 1.5341E−03 |
| −0.5 | 2.1741E−03 |
| −0.555555556 | 2.9889E−03 |
| −0.611111111 | 4.0181E−03 |
| −0.666666667 | 5.2849E−03 |
| −0.722222222 | 6.8072E−03 |
| −0.777777778 | 8.7122E−03 |
| −0.833333333 | 1.1561E−02 |
| −0.888888889 | 1.7013E−02 |
| −0.944444444 | 2.8921E−02 |
| −1 | 5.4805E−02 |

TABLE 17
EXAMPLE [A4]

| POSITION (mm) | FORM [mm] |
|---|---|
| 1 | 3.5881E−01 |
| 0.944444 | 1.3046E−01 |
| 0.888889 | 4.5106E−02 |
| 0.833333 | 1.6062E−02 |
| 0.777778 | 6.9109E−03 |
| 0.722222 | 3.8461E−03 |
| 0.666667 | 2.3768E−03 |
| 0.611111 | 1.3763E−03 |
| 0.555556 | 6.7917E−04 |
| 0.5 | 2.6511E−04 |
| 0.444444 | 7.2487E−05 |
| 0.388889 | 1.1381E−05 |
| 0.333333 | 4.8830E−06 |
| 0.277778 | 8.7958E−06 |
| 0.222222 | 8.3270E−06 |
| 0.166667 | 4.4136E−06 |
| 0.111111 | 1.1979E−06 |
| 0.055556 | 8.9159E−08 |
| −3.1E−16 | 8.6002E−65 |
| −0.05556 | 8.9159E−08 |
| −0.11111 | 1.1979E−06 |
| −0.16667 | 4.4136E−06 |
| −0.22222 | 8.3270E−06 |
| −0.27778 | 8.7958E−06 |
| −0.33333 | 4.8830E−06 |
| −0.38889 | 1.1381E−05 |
| −0.44444 | 7.2487E−05 |
| −0.5 | 2.6511E−04 |
| −0.55556 | 6.7917E−04 |
| −0.61111 | 1.3763E−03 |
| −0.66667 | 2.3768E−03 |
| −0.72222 | 3.8461E−03 |
| −0.77778 | 6.9109E−03 |
| −0.83333 | 1.6062E−02 |
| −0.88889 | 4.5106E−02 |
| −0.94444 | 1.3046E−01 |
| −1 | 3.5881E−01 |

TABLE 18
EXAMPLE [B1]

| POSITION (mm) | FORM [mm] |
|---|---|
| 1 | 9.8689E−02 |
| 0.944444444 | 2.8921E−02 |
| 0.888888889 | 1.7013E−02 |
| 0.833333333 | 1.1561E−02 |
| 0.777777778 | 8.7122E−03 |
| 0.722222222 | 6.8072E−03 |
| 0.666666667 | 5.2849E−03 |
| 0.611111111 | 4.0181E−03 |
| 0.555555556 | 2.9889E−03 |
| 0.5 | 2.1741E−03 |
| 0.444444444 | 1.5341E−03 |
| 0.388888889 | 1.0306E−03 |
| 0.333333333 | 6.4013E−04 |
| 0.277777778 | 3.5297E−04 |
| 0.222222222 | 1.6282E−04 |
| 0.166666667 | 5.6787E−05 |
| 0.111111111 | 1.2053E−05 |
| 0.055555556 | 7.8711E−07 |
| −3.05311E−16 | 7.2864E−64 |
| −0.055555556 | 7.8711E−07 |
| −0.111111111 | 1.2053E−05 |
| −0.166666667 | 5.6787E−05 |
| −0.222222222 | 1.6282E−04 |
| −0.277777778 | 3.5297E−04 |
| −0.333333333 | 6.4013E−04 |
| −0.388888889 | 1.0306E−03 |
| −0.444444444 | 1.5341E−03 |
| −0.5 | 2.1741E−03 |
| −0.555555556 | 2.9889E−03 |
| −0.611111111 | 4.0181E−03 |
| −0.666666667 | 5.2849E−03 |
| −0.722222222 | 6.8072E−03 |
| −0.777777778 | 8.7122E−03 |
| −0.833333333 | 1.1561E−02 |
| −0.888888889 | 1.7013E−02 |
| −0.944444444 | 2.8921E−02 |
| −1 | 5.4805E−02 |

TABLE 19
EXAMPLE [B2]

| POSITION (mm) | FORM [mm] |
|---|---|
| 1 | −3.0513E−03 |
| 0.944444444 | −6.6522E−04 |
| 0.888888889 | 2.9413E−04 |
| 0.833333333 | 5.8743E−04 |
| 0.777777778 | 5.9845E−04 |
| 0.722222222 | 5.0988E−04 |
| 0.666666667 | 4.0157E−04 |
| 0.611111111 | 3.0362E−04 |
| 0.555555556 | 2.2396E−04 |
| 0.5 | 1.6187E−04 |
| 0.444444444 | 1.1420E−04 |
| 0.388888889 | 7.7821E−05 |
| 0.333333333 | 5.0346E−05 |
| 0.277777778 | 3.0132E−05 |
| 0.222222222 | 1.6012E−05 |
| 0.166666667 | 7.0183E−06 |
| 0.111111111 | 2.1585E−06 |
| 0.055555556 | 2.7941E−07 |
| −3.05311E−16 | 4.7874E−50 |
| −0.055555556 | 2.7941E−07 |
| −0.111111111 | 2.1585E−06 |
| −0.166666667 | 7.0183E−06 |
| −0.222222222 | 1.6012E−05 |
| −0.277777778 | 3.0132E−05 |
| −0.333333333 | 5.0346E−05 |
| −0.388888889 | 7.7821E−05 |
| −0.444444444 | 1.1420E−04 |
| −0.5 | 1.6187E−04 |
| −0.555555556 | 2.2396E−04 |
| −0.611111111 | 3.0362E−04 |
| −0.666666667 | 4.0157E−04 |
| −0.722222222 | 5.0988E−04 |
| −0.777777778 | 5.9845E−04 |
| −0.833333333 | 5.8743E−04 |
| −0.888888889 | 2.9413E−04 |
| −0.944444444 | −6.6522E−04 |
| −1 | −3.0513E−03 |

TABLE 20
EXAMPLE [C1]

| POSITION (mm) | FORM [mm] |
|---|---|
| 1 | −1.5840E+00 |
| 0.944444444 | −5.0201E−01 |
| 0.888888889 | −1.3744E−01 |
| 0.833333333 | −2.9241E−02 |
| 0.777777778 | −2.7239E−03 |
| 0.722222222 | 1.5869E−03 |
| 0.666666667 | 1.2584E−03 |
| 0.611111111 | 5.0564E−04 |
| 0.555555556 | 1.9152E−05 |
| 0.5 | −2.0618E−04 |
| 0.444444444 | −2.5461E−04 |
| 0.388888889 | −2.0681E−04 |
| 0.333333333 | −1.2917E−04 |
| 0.277777778 | −6.3324E−05 |
| 0.222222222 | −2.3702E−05 |
| 0.166666667 | −6.2755E−06 |
| 0.111111111 | −9.8037E−07 |
| 0.055555556 | −4.9098E−08 |
| −3.05311E−16 | −4.0681E−65 |
| −0.055555556 | −4.9098E−08 |
| −0.111111111 | −9.8037E−07 |
| −0.166666667 | −6.2755E−06 |
| −0.222222222 | −2.3702E−05 |
| −0.277777778 | −6.3324E−05 |
| −0.333333333 | −1.2917E−04 |
| −0.388888889 | −2.0681E−04 |
| −0.444444444 | −2.5461E−04 |
| −0.5 | −2.0618E−04 |
| −0.555555556 | 1.9152E−05 |
| −0.611111111 | 5.0564E−04 |
| −0.666666667 | 1.2584E−03 |
| −0.722222222 | 1.5869E−03 |
| −0.777777778 | −2.7239E−03 |
| −0.833333333 | −2.9241E−02 |
| −0.888888889 | −1.3744E−01 |
| −0.944444444 | −5.0201E−01 |
| −1 | −1.5840E+00 |

TABLE 21
EXAMPLE [C2]

| POSITION (mm) | FORM [mm] |
|---|---|
| 1 | 1.6081E−04 |
| 0.944444444 | 1.6478E−04 |
| 0.888888889 | 1.3862E−04 |
| 0.833333333 | 1.1326E−04 |
| 0.777777778 | 1.0509E−04 |
| 0.722222222 | 1.1195E−04 |
| 0.666666667 | 1.2317E−04 |
| 0.611111111 | 1.2870E−04 |
| 0.555555556 | 1.2342E−04 |
| 0.5 | 1.0753E−04 |
| 0.444444444 | 8.4771E−05 |
| 0.388888889 | 6.0081E−05 |
| 0.333333333 | 3.7785E−05 |
| 0.277777778 | 2.0569E−05 |
| 0.222222222 | 9.2534E−06 |
| 0.166666667 | 3.1392E−06 |
| 0.111111111 | 6.5066E−07 |
| 0.055555556 | 4.1830E−08 |
| −3.05311E−16 | 3.8511E−65 |
| −0.055555556 | 4.1830E−08 |
| −0.111111111 | 6.5066E−07 |
| −0.166666667 | 3.1392E−06 |
| −0.222222222 | 9.2534E−06 |
| −0.277777778 | 2.0569E−05 |
| −0.333333333 | 3.7785E−05 |
| −0.388888889 | 6.0081E−05 |
| −0.444444444 | 8.4771E−05 |
| −0.5 | 1.0753E−04 |
| −0.555555556 | 1.2342E−04 |
| −0.611111111 | 1.2870E−04 |
| −0.666666667 | 1.2317E−04 |
| −0.722222222 | 1.1195E−04 |
| −0.777777778 | 1.0509E−04 |
| −0.833333333 | 1.1326E−04 |
| −0.888888889 | 1.3862E−04 |
| −0.944444444 | 1.6478E−04 |
| −1 | 1.6081E−04 |

TABLE 22
EXAMPLE [C3]

| POSITION (mm) | FORM [mm] |
|---|---|
| 1 | 3.3420E−04 |
| 0.944444 | 6.5376E−04 |
| 0.888889 | 5.4284E−04 |
| 0.833333 | 4.1863E−04 |
| 0.777778 | 3.5615E−04 |
| 0.722222 | 3.2829E−04 |
| 0.666667 | 2.9985E−04 |
| 0.611111 | 2.5398E−04 |
| 0.555556 | 1.9161E−04 |
| 0.5 | 1.2326E−04 |
| 0.444444 | 6.1142E−05 |
| 0.388889 | 1.4228E−05 |
| 0.333333 | −1.3758E−05 |
| 0.277778 | −2.4180E−05 |
| 0.222222 | −2.2006E−05 |
| 0.166667 | −1.3774E−05 |
| 0.111111 | −5.4958E−06 |
| 0.055556 | −8.6845E−07 |
| −3.1E−16 | −1.7401E−49 |
| −0.05556 | −8.6845E−07 |
| −0.11111 | −5.4958E−06 |
| −0.16667 | −1.3774E−05 |
| −0.22222 | −2.2006E−05 |
| −0.27778 | −2.4180E−05 |
| −0.33333 | −1.3758E−05 |
| −0.38889 | 1.4228E−05 |
| −0.44444 | 6.1142E−05 |
| −0.5 | 1.2326E−04 |
| −0.55556 | 1.9161E−04 |
| −0.61111 | 2.5398E−04 |
| −0.66667 | 2.9985E−04 |
| −0.72222 | 3.2829E−04 |
| −0.77778 | 3.5615E−04 |
| −0.83333 | 4.1863E−04 |
| −0.88889 | 5.4284E−04 |
| −0.94444 | 6.5376E−04 |
| −1 | 3.3420E−04 |

TABLE 23
EXAMPLE [D]

| POSITION (mm) | FORM [mm] |
|---|---|
| 1 | 5.6180E−01 |
| 0.944444 | 1.9826E−01 |
| 0.888889 | 6.0637E−02 |
| 0.833333 | 1.4393E−02 |
| 0.777778 | 1.5302E−03 |
| 0.722222 | −8.5142E−04 |
| 0.666667 | −7.1993E−04 |
| 0.611111 | −3.3115E−04 |
| 0.555556 | −8.8649E−05 |
| 0.5 | 3.8380E−05 |
| 0.444444 | 1.0482E−04 |
| 0.388889 | 1.2983E−04 |
| 0.333333 | 1.1985E−04 |
| 0.277778 | 8.6857E−05 |
| 0.222222 | 4.8443E−05 |
| 0.166667 | 1.9231E−05 |
| 0.111111 | 4.4381E−06 |
| 0.055556 | 3.0378E−07 |
| −3.1E−16 | 2.8551E−64 |
| −0.05556 | 3.0378E−07 |
| −0.11111 | 4.4381E−06 |
| −0.16667 | 1.9231E−05 |
| −0.22222 | 4.8443E−05 |
| −0.27778 | 8.6857E−05 |
| −0.33333 | 1.1985E−04 |
| −0.38889 | 1.2983E−04 |
| −0.44444 | 1.0482E−04 |
| −0.5 | 3.8380E−05 |
| −0.55556 | −8.8649E−05 |
| −0.61111 | −3.3115E−04 |
| −0.66667 | −7.1993E−04 |
| −0.72222 | −8.5142E−04 |
| −0.77778 | 1.5302E−03 |
| −0.83333 | 1.4393E−02 |
| −0.88889 | 6.0637E−02 |
| −0.94444 | 1.9826E−01 |
| −1 | 5.6180E−01 |

What is claimed is:

1. A phase correction plate to be mounted on an imaging lens, wherein the maximum phase difference of light that has passed a middle region of the phase correction plate is lower than the maximum phase difference of light that has passed a peripheral region of the phase correction plate, and wherein in the peripheral region, the phase difference of light that has passed through the phase correction plate increases from the middle-region side of the peripheral region toward the periphery side of the peripheral region.

2. A phase correction plate to be mounted on an imaging lens, wherein a change in the diameter of each spot formed at each position on an imaging plane by light that has passed through the imaging lens with the phase correction plate mounted thereon during defocusing is less than a change in the diameter of a spot formed, in such a manner to correspond to each of the positions on the imaging plane, by light that has passed through the imaging lens alone without the phase correction plate during defocusing.

3. A phase correction plate, as defined in claim 1, wherein the phase difference of light that passes the middle region is less than ½ wavelength.

4. A phase correction plate, as defined in claim 1, wherein the phase difference of light that passes the peripheral region is greater than or equal to ½ wavelength.

5. A phase correction plate, as defined in claim 1, wherein the phase correction plate has rotationally symmetric form.

6. A phase correction plate, as defined in claim 1, wherein the phase correction plate satisfies the following formula:
5/100<A/(A+B)<100/100, where A is the area of the middle region, B is the area of the peripheral region, and A+B is the area of an effective region that is obtained by adding the area of the peripheral region to the area of the middle region.

7. An imaging system comprising:
an imaging means that obtains an optical image of a subject projected through an imaging lens with a phase correction plate, as defined in claim 1, mounted thereon; and
a signal processing means that performs restoration processing on image data representing the subject, which was obtained by the imaging means.

8. An imaging apparatus comprising an imaging system, as defined in claim 7.

9. A lens unit comprising:
1. correction plate as defined in claim 1; and
at least one lens.

10. A phase correction plate, as defined in claim 1, wherein the phase of light that has passed through the phase correction plate advances from the middle-region side of the phase correction plate toward the periphery side of the phase correction plate with respect to a center-side position of light that passes the peripheral region of the phase correction plate, the center-side position being closest to the center of the phase correction plate.

11. A phase correction plate, as defined in claim 1, wherein the phase of light that has passed through the phase correction plate delays from the middle-region side of the phase correction plate toward the periphery side of the phase correction plate with respect to a center-side position of light that passes the peripheral region of the phase correction plate, the center-side position being closest to the center of the phase correction plate.

12. A phase correction plate, as defined in claim 2, wherein the phase difference of light that passes the middle region is less than ½ wavelength.

13. A phase correction plate, as defined in claim 2, wherein the phase difference of light that passes the peripheral region is greater than or equal to ½ wavelength.

14. A phase correction plate, as defined in claim 2, wherein the phase correction plate has rotationally symmetric form.

15. A phase correction plate, as defined in claim 2, wherein the phase correction plate satisfies the following formula:
5/100<A/(A+B)<100/100, where A is the area of the middle region, B is the area of the peripheral region, and A+B is the area of an effective region that is obtained by adding the area of the peripheral region to the area of the middle region.

16. An imaging system comprising:
an imaging means that obtains an optical image of a subject projected through an imaging lens with a phase correction plate, as defined in claim 2, mounted thereon; and
a signal processing means that performs restoration processing on image data representing the subject, which was obtained by the imaging means.

17. An imaging apparatus comprising an imaging system, as defined in claim 16.

18. A lens unit comprising:
a phase correction plate as defined in claim 2; and
at least one lens.

19. A phase correction plate, as defined in claim 2, wherein the phase of light that has passed through the phase correction plate advances from the middle-region side of the phase correction plate toward the periphery side of the phase correction plate with respect to a center-side position of light that passes a peripheral region of the phase correction plate, the center-side position being closest to the center of the phase correction plate.

20. A phase correction plate, as defined in claim 2, wherein the phase of light that has passed through the phase correction plate delays from the middle-region side of the phase correction plate toward the periphery side of the phase correction plate with respect to a center-side position of light that passes a peripheral region of the phase correction plate, the center-side position being closest to the center of the phase correction plate.
